(19) United States
(12) Patent Application Publication
(10) Pub. No.: US 2008/0003516 A1
(43) Pub. Date: Jan. 3, 2008

(54) Liquid Developer and Image Forming Device

(75) Inventors: Koji AKIOKA, Matsumoto-shi (JP); Takashi TESHIMA, Shiojiri-shi (JP); Satoru MIURA, Matsumoto-shi (JP); Shunichiro YAMANAKA, Komaki-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/766,691

(22) Filed: Jun. 21, 2007

(30) Foreign Application Priority Data
Jun. 29, 2006 (JP) 2006-180455
Jun. 29, 2006 (JP) 2006-180456
Jul. 4, 2006 (JP) 2006-184970
Feb. 16, 2007 (JP) 2007-037193

(51) Int. Cl. G03G 9/12; G03G 15/10

(52) U.S. Cl. 430/113; 399/237

(57) ABSTRACT

1. A liquid developer is disclosed. The liquid developer includes an insulating liquid; and toner particles composed mainly of a resin material that are dispersed in the insulating liquid, wherein the insulating liquid contains a fatty acid monoester, and the resin material has a glass transition temperature Tg of 15 to 70° C. and a softening temperature Tf of 80 to 140° C.

### BACKGROUND

1. Technical Field

The entire disclosure of Japanese Patent Application Nos: 2006-180455 filed Jun. 29, 2006 and 2006-180456 filed Jun. 29, 2006 and 2006-184970, filed Jul. 4, 2006 and 2007-37193, filed Feb. 16, 2007 are expressly incorporated by reference herein.

The present invention relates to a liquid developer and an image forming device.

2. Related Art

For a developer used to develop electrostatic latent images formed on latent image carriers, there are available a method of using a dry toner, in which method a toner composed of a colorant such as pigment and the like and a material including a binding resin is used in a dry state; and a method of using a liquid developer in which a toner is dispersed in an electrically insulating carrier liquid (insulating liquid) (see, for example, JP-A-7-152256).

The method of using a dry toner involves dealing with a toner in the solid state, thus being advantageous in handling; however, the method has problems such as the concern about adverse effects of fine toner particles on human bodies, as well as contamination due to the scattering of toner particles, insufficient homogeneity in toner dispersion, and the like. Furthermore, a dry toner has such problems as that aggregation of particles is likely to occur, it is difficult to sufficiently reduce the size of toner particles, and it is difficult to form toner images with high resolution. Also, when the size of toner particles is made relatively small, the problems caused by fine toner particles as described above become even more significant.

Meanwhile, with regard to the method of using a liquid developer, since aggregation of toner particles in the liquid developer is effectively prevented, it is possible to use fine toner particles. As a result, the method of using a liquid developer has features such as good reproducibility of images with fine lines, good reproducibility of image tone, and excellent reproducibility of colors. Furthermore, the method has an excellent feature that image formation is achieved at high speeds, compared to the method of using a dry toner.

However, since the insulating liquid that has been traditionally used in the liquid developer is mainly based on petroleum-based hydrocarbons, there is concern about adverse effects on environment in the case where there is a leakage of the insulating liquid from an image forming device or the like.

In addition, liquid developers usually leave the insulating liquid adhered on the surface of toner particles upon fixation. Typical liquid developers also have a problem that this insulating liquid adhered on the surface of the toner particles decreases the intensity of fixation.

It is conceivable to fix toner particles by heating at a relatively high temperature for a long time so as to improve the intensity of fixation of the toner, but it is still difficult to fulfill the recent needs for further increases in the speed of image formation and energy saving.

### SUMMARY

An advantage of some aspects of the present invention is to provide a liquid developer which is environmentally friendly, is capable of fixing toner particles on a recording medium at a low temperature and at a high speed, and at the same time, which is capable of firmly fixing the toner particles on the recording medium. Another advantage of the invention is to provide an image forming device using such liquid developer.

According to a first aspect of the invention, there is provided a liquid developer including an insulating liquid and toner particles which are mainly composed of a resin material and are dispersed in the insulating liquid, wherein the insulating liquid contains a fatty acid monoester, and the resin material having a glass transition temperature Tg of 15 to 70° C. and a softening temperature Tf of 80 to 140° C.

According to the aspect of the invention, it is preferable that the fatty acid monoester of the liquid developer contains an unsaturated fatty acid as the fatty acid component.

According to the aspect of the invention, it is preferable that the fatty acid monoester contains a monoester of an unsaturated fatty acid having 16 to 22 carbon atoms, and an alcohol having 1 to 4 carbon atoms.

According to the aspect of the invention, it is preferable that the fatty acid monoester contains a saturated fatty acid as the fatty acid component.

According to the aspect of the invention, it is preferable that the fatty acid monoester contains a monoester of a saturated fatty acid having 8 to 16 carbon atoms, and an alcohol having 1 to 4 carbon atoms.

According to the aspect of the invention, it is preferable that the resin material of the liquid developer is a polyester resin.

According to the aspect of the invention, it is preferable that the liquid developer has a viscosity of 50 to 1000 mPa·s, as measured at 25° C. using an oscillating viscometer according to JIS Z8809.

According to the aspect of the invention, it is preferable that the insulating liquid of the liquid developer contains a fatty acid triglyceride, and contains an unsaturated fatty acid as the fatty acid component.

According to the aspect of the invention, it is preferable that the liquid developer satisfies the relationship: 0.01≦X/Y≦1.0, wherein X [wt %] represents the content of the fatty acid monoester in the insulating liquid, and Y [wt %] represents the content of the fatty acid triglyceride.

According to the aspect of the invention, it is preferable that the fatty acid monoester is produced by a transesterification reaction between the fatty acid triglyceride and a monoalcohol having 1 to 4 carbon atoms.

According to the aspect of the invention, it is preferable that the insulating liquid of the liquid developer contains silicone oil and/or an aliphatic hydrocarbon.

According to the aspect of the invention, it is preferable that the liquid developer satisfies the relationship: 0.1≦X/Z≦1.0, wherein X [wt %] represents the content of the fatty acid monoester in the insulating liquid, and Z [wt %] represents the sum of the content of the aliphatic hydrocarbon and the content of the silicone oil.

According to another aspect of the invention, there is provided an image forming device including a liquid developer storing unit that stores a liquid developer; a developing unit that develops an image using the liquid developer supplied from the liquid developer storing unit; a transferring unit that transfers an image formed at the developing unit onto a recording medium to form a transferred image; and a fixing unit that fixes the transferred image formed on the recording medium onto the recording medium, wherein the liquid developer has toner particles which are mainly composed of a resin material and are dispersed in an insulating liquid, the insulating liquid containing a fatty acid monoester, and the resin material having a glass transition temperature Tg of 15 to 70° C. and a softening temperature Tf of 80 to 140° C.

From the constitution as described in the above, a liquid developer which is environmentally friendly, is capable of fixing toner particles on a recording medium at a low temperature and at a high speed, and at the same time, which is capable of firmly fixing the toner particles onto the recording medium, can be provided. An image forming device using such liquid developer can be also provided.

### BRIEF DESCRIPTION OF THE DRAWINGS

The invention will be described with reference to the accompanying drawings, wherein like numbers reference like elements.

FIG. 1 is a vertical cross-sectional view schematically illustrating an example of a kneading machine and cooler for preparing a kneading product that is used in the preparation of an aqueous emulsion.

FIG. 2 is a vertical cross-sectional view schematically illustrating a preferred embodiment of a dry microparticle producing apparatus (toner particle producing apparatus) that is used in the preparation of the liquid developer according to an embodiment of the present invention.

FIG. 3 is a magnified cross-sectional view of the vicinity of the head unit of the dry microparticle producing apparatus shown in FIG. 2.

FIG. 4 is a cross-sectional view illustrating an example of a contact-type image forming device to which a liquid developer according to an embodiment of the invention is applied.

FIG. 5 is a cross-sectional view illustrating an example of a non-contact type image forming device to which a liquid developer according to an embodiment of the invention is applied.

FIG. 6 is a cross-sectional view illustrating an example of a fixing device to which a liquid developer according to an embodiment of the invention is applied.

FIG. 7 is a diagram schematically illustrating another example of the structure of the vicinity of the head unit of a dry microparticle producing apparatus.

FIG. 8 is a diagram schematically illustrating another example of the structure of the vicinity of the head unit of a dry microparticle producing apparatus.

FIG. 9 is a diagram schematically illustrating another example of the structure of the vicinity of the head unit of a dry microparticle producing apparatus.

FIG. 10 is a diagram schematically illustrating another example of the structure of the vicinity of the head unit of a dry microparticle producing apparatus.

### DESCRIPTION OF EXEMPLARY EMBODIMENTS

Hereinafter, preferred embodiments of the present invention will be described in detail.

### Liquid Developer

The liquid developer according to an embodiment of the invention is a dispersion of toner particles in an insulating liquid.

### Toner Particles

First, the toner particles will be discussed.

### Compositional Materials of Toner Particles

The toner particles (toner) which constitute the liquid developer according to the embodiment of the invention contain at least a binding resin (resin material) and a colorant.

### 1. Resin Material

The toner particles which constitute the liquid developer are composed of a material including a resin material as the main component.

According to an embodiment of the invention, a resin material having a glass transition temperature of 15 to 70° C., and a softening temperature of 80 to 140° C. is used as the resin material composing the toner particles.

However, in general, when toner particles composed of a resin having a low glass transition temperature and a low softening temperature are used, it is possible to fix the toner particles at a relatively low temperature, but it is difficult to obtain a sufficient intensity of fixation. Furthermore, since toner particles composed of such resin material are likely to undergo aggregation, it is difficult to form images having satisfactory image quality.

Nevertheless, when the toner particles are used in combination with an insulating liquid as will be described later, it is possible to fix the toner particles at a low temperature, and at the same time, it is possible to firmly fix the toner particles onto a recording medium, while forming images of high quality.

Moreover, according to an embodiment of the invention, the glass transition temperature of the resin material composing the toner particles is 15 to 70° C., preferably 20 to 55° C., and more preferably 25 to 50° C. Therefore, the effect of the invention becomes more remarkable.

Furthermore, according to another embodiment of the invention, the softening temperature of the resin material composing the toner particles is 80 to 140° C., preferably 85 to 130° C., and more preferably 90 to 120° C. Therefore, the effect of the invention becomes more remarkable.

Additionally, the term softening temperature in the present specification refers to a temperature for initiation of softening, as measured using a Koka flow tester (Shimadzu Corp.) under the measuring conditions of: a rate of temperature increase of 5° C./min and a die hole diameter of 1.0 mm.

According to an embodiment of the invention, the resin (binder resin) is not particularly limited so long as the resin has properties as described above, and examples thereof include styrene-based resins, including homopolymers or copolymers containing styrene or styrene substituents, such as polystyrene, poly-α-methylstyrene, chloropolystyrene, styrene-chlorostyrene copolymers, styrene-propylene copolymers, styrene-butadiene copolymers, styrene-vinyl chloride copolymers, styrene-vinyl acetate copolymers, styrene-maleic acid copolymers, styrene-acrylic acid ester copolymers, styrene-methacrylic acid ester copolymers, styrene-acrylic acid ester-methacrylic acid ester copolymers, styrene-methyl α-chloroacrylate copolymers, styrene-acrylonitrile-acrylic acid ester copolymers, styrene-vinyl methyl ether copolymers and the like; polyester resins, epoxy resins, urethane-modified epoxy resins, silicone-modified epoxy resins, vinyl chloride resins, rosin-modified maleic acid resins, phenyl resins, polyethylene-based resins, polypropylene, ionomer resins, polyurethane resins, silicone resins, ketone resins, ethylene-ethyl acrylate copolymers, xylene resins, polyvinylbutyral resins, terpene resins, phenolic resins, aliphatic or alicyclic hydrocarbon resins, and the like. Among these, one or a combination of two or more species can be used. Among those described above, when a polyester resin is used, a liquid developer having particularly excellent dispersibility for toner particles can be obtained. This is believed to be attributable to the similarity in the chemical structures of the polyester resin and of the insulating liquid to be described later.

### 2. Colorant

The toner also contains a colorant. Examples of the colorant that can be used include pigments, dyes and the like. Examples of such pigments and dyes include carbon black, spirit black, lamp black (C.I. No. 77266), magnetite, titanium black, chrome yellow, cadmium yellow, mineral fast yellow, navel orange yellow, Naphthol Yellow S, Hanza Yellow G, Permanent Yellow NCG, chrome yellow, Benzidine Yellow, quinoline yellow, Tartrazine Lake, chrome orange, molybdenum orange, Permanent Orange GTR, Pyrazolone Orange, Benzidine Orange G, cadmium red, Permanent Red 4R, Watching Red calcium salt, eosine lake, Brilliant Carmine 3B, manganese violet, Fast Violet B, Methyl Violet Lake, prussian blue, cobalt blue, Alkali Blue Lake, Victoria Blue Lake, Fast Sky Blue, Indanthrene Blue BC, ultramarine blue, aniline blue, Phthalocyanine Blue, Calco Oil Blue, chrome green, chromium oxide, Pigment Green B, Malachite Green Lake, Phthalocyanine Green, Final Yellow Green G, Rhodamine 6G, quinacridone, Rose Bengal (C.I. No. 45432), C.I. Direct Red 1, C.I. Direct Red 4, C.I. Acid Red 1, C.I. Basic Red 1, C.I. Mordant Red 30, C.I. Pigment Red 48:1, C.I. Pigment Red 57:1, C.I. Pigment Red 122, C.I. Pigment Red 184, C.I. Direct Blue 1, C.I. Direct Blue 2, C.I. Acid Blue 9, C.I. Acid Blue 15, C.I. Basic Blue 3, C.I. Basic Blue 5, C.I. Mordant Blue 7, C.I. Pigment Blue 15:1, C.I. Pigment Blue 15:3, C.I. Pigment Blue 5:1, C.I. Direct Green 6, C.I. Basic Green 4, C.I. Basic Green 6, C.I. Pigment Yellow 17, C.I. Pigment Yellow 93, C.I. Pigment Yellow 97, C.I. Pigment Yellow 12, C.I. Pigment Yellow 180, C.I. Pigment Yellow 162, Nigrosine dye (C.I. No. 50415B); metal complex dyes, silica, aluminum oxide, magnetite, maghemite, various ferrites; metal oxides such as cupric oxide, nickel oxide, zinc oxide, zirconium oxide, titanium oxide, magnesium oxide and the like; magnetic materials including magnetic metals such as Fe, Co and Ni; and the like. Among these, one or a combination of two or more species can be used.

### 3. Other Components

The toner may also contain components other than the above-described components. Examples of such components include waxes, antistatic agents, magnetic powders and the like.

Examples of the wax include hydrocarbon-based waxes such as ozokerite, ceresin, paraffin waxes, microwaxes, microcrystalline waxes, petrolatum, Fisher-Tropsch wax and the like; ester-based waxes such as carnauba wax, rice wax, methyl laurate, methyl myristate, methyl palmitate, methyl stearate, butyl stearate, candelilla wax, cotton wax, wood wax, beeswax, lanolin, montan wax, fatty acid esters and the like; olefin-based waxes such as polyethylene wax, polypropylene wax, oxidized polyethylene wax, oxidized polypropylene wax and the like; amide-based waxes such as 12-hydroxystearic acid amide, stearic acid amide, anhydrous phthalic acid imide and the like; ketone-based waxes such as laurone, stearone and the like; ether-based waxes; and the like. Among these, one or a combination of two or more species can be used.

Examples of the antistatic agent include metal salts of benzoic acid, metal salts of salicylic acid, metal salts of alkylsalicylic acid, metal salts of catecholic acid, metal-containing bisazo dyes, Nigrosine dyes, tetraphenyl borate derivatives, quaternary ammonium salts, alkylpyridinium salts, chlorinated polyesters, nitrofunic acid, and the like.

Examples of the magnetic powder include magnetite, maghemite, various ferrites; metal oxides such as cupric oxide, nickel oxide, zinc oxide, zirconium oxide, titanium oxide, magnesium oxide and the like; materials composed of magnetic materials containing magnetic metals such as Fe, Co and Ni; and the like.

For the compositional material (component) of the kneading product, in addition to the above-described materials, zinc stearate, zinc oxide, cerium oxide, silica, titanium oxide, iron oxide, fatty acids, fatty acid metal salts, and the like may be also used.

### Shape of Toner Particles

The average particle size of the toner particles composed of the materials as described above is preferably 0.1 to 5 μm, more preferably 0.1 to 4 μm, and even more preferably 0.5 to 3 μm. If the average particle size of the toner particles falls within the described range, the resolution of the images formed by the liquid developer (toner) can be sufficiently increased, while particularly reducing differences in the properties of the individual toner particles, and particularly increasing the reliability of the liquid developer as a whole.

The standard deviation of the toner particles constituting the liquid developer is preferably 1.0 μm or less, more preferably 0.1 to 1.0 μm, and even more preferably 0.1 to 0.8 μm. Then, differences in the properties of the individual toner particles can be particularly decreased, and the reliability of the liquid developer as a whole is further improved.

The average value of the degree of circularity R (average degree of circularity) of the toner particles constituting the liquid developer, as represented by the following formula (I), is preferably 0.85 or greater, more preferably 0.90 to 0.99, and even more preferably 0.92 to 0.99.

R=L₀/L₁ (I)

where L₁ [μm] represents the perimeter of a projected image of toner particles of a subject of measurement; and L₀ [μm] represents the perimeter of a perfect circle having the same area as the area of a projected image of toner particles of the subject of measurement.

Then, a particularly excellent transfer efficiency and mechanical strength of the toner particles can be obtained, while keeping the particle size of the toner particles sufficiently small.

The standard deviation of the average degree of circularity among the toner particles that constitute the liquid developer is preferably 0.15 or less, more preferably 0.001 to 0.10, and even more preferably 0.001 to 0.05. Then, the differences in the properties among individual toner particles, such as antistatic property, fixing property and the like, are particularly reduced, and the reliability of the liquid developer as a whole is further improved.

### Insulating Liquid

Next, the insulating liquid will be discussed.

According to an embodiment of the invention, the insulating liquid contains a fatty acid monoester.

### Fatty Acid Monoester

According to an embodiment of the invention, the fatty acid monoester in the insulating liquid is a monoester of a fatty acid and an alcohol.

With regard to liquid developers of the related art, there are concerns for the effect of the insulating liquid on the environment, caused by leakage of the insulating liquid to the outside of an image forming device upon use (for example, volatilization of the insulating liquid during fixing, etc.), or by disposal of a used liquid developer. Also, developers of the related art have a problem that the presence of the insulating liquid adhered on the surface of toner particles causes deteriorated fixability of the toner particles onto a recording medium (lowered intensity of fixation).

In this regard, the fatty acid monoester that is used as the insulating liquid of the invention is an environmentally friendly component. Therefore, the environmental stress posed by the insulating liquid through the leakage of the insulating liquid to the outside of an image forming device, disposal of a used liquid developer, or the like, can be decreased. Consequently, an environmentally friendly liquid developer can be provided.

With regard to the resin materials that are favorably used for the invention, such as polyesters, styrene-acrylic copolymers and the like, when a fatty acid monoester, a fatty acid triglyceride or the like is used as the insulating liquid, the fatty acid component constituting them penetrates into the resin particles during the fixing process, and manifests a plasticizing effect. This plasticizing effect allows, for example, in the case of using paper as the recording medium, the toner particles to easily penetrate into the interstices of paper fibers, and thus the fixing property between the paper and the toner particles is improved. Among the insulating liquids composed of such fatty acid component, in particular, insulating liquids containing fatty acid monoesters have excellent fixing properties. It is believed that this is because fatty acid monoesters in general have low molecular weights and are easily incorporated in between resin particles during the fixing process, compared to other liquids having a plasticizing effect, such as fatty acid triglycerides and the like, thus it being easier for the fatty acid monoesters to manifest the plasticizing effect. Therefore, when image formation is performed using a liquid developer containing a fatty acid monoester, the toner particles can favorably penetrate into the recording medium and solidify in that penetrated state during the fixing process, thereby being entangled with the fibers or the like of the recording medium and fixed. This allows the toner particles to be firmly fixed onto the recording medium, even though the resin composing the toner particles has such softening point and glass transition point as described above.

Furthermore, when a polyester resin is used as the resin material compositing the toner particles, the resin has particularly good affinity for the insulating liquid containing a fatty acid monoester as described above, and thus the dispersibility of the toner particles in the liquid developer can be made excellent, while making the fixing property of the toner particles to the recording medium particularly excellent.

As such, when the insulating liquid contains a fatty acid monoester, the penetration of the liquid developer into a recording medium becomes favorable, and can be appropriately adapted to image formation at a low temperature at a high speed. Also, the intensity of fixation of the resulting toner image becomes excellent.

The fatty acid monoester may contain a saturated fatty acid as the fatty acid component. In the case where the fatty acid monoester contains a saturated fatty acid component as such, the storage property and long-term stability of the insulating liquid can be further improved. Examples of such saturated fatty acid include butyric acid, caproic acid, caprylic acid, capric acid, lauric acid, myristic acid, palmitic acid, stearic acid, arachidic acid, behenic acid, lignoceric acid, and the like.

Among these, it is preferable for the fatty acid monoester to contain a fatty acid having 8 to 16 carbon atoms as the saturated fatty acid component. Then, the fixing property can be made excellent, while obtaining particularly excellent storage property and long-term stability of the liquid developer. In particular, when lauric acid, caprylic acid, caproic acid or myristic acid is used as the saturated fatty acid component, the above-described effect becomes more remarkable.

The fatty acid monoester may also contain an unsaturated fatty acid as the fatty acid component. The unsaturated fatty acid component contained in the fatty acid monoester is a component which can contribute to the improvement of fixability of toner particles to a recording medium. To be more specific, the unsaturated fatty acid component is a component having a function of undergoing a polymerization reaction by being oxidized (being oxidized upon fixation), and curing by itself, thereby improving the fixability of toner particles.

Because of this, the toner particles can be fixed onto a recording medium at a low temperature, and at the same time, the toner particles can be firmly fixed onto the recording medium. In other words, since the toner particles are composed of a resin material having a low glass transition temperature and a low softening temperature as described above, fixation can be performed at a relative low fixation temperature. Also, the insulating liquid (unsaturated fatty acid component) transferred together with the toner particles onto the recording medium undergoes oxidative polymerization and curing upon heating during the fixing process, thereby covering the surfaces of the fixed toner particles. Thus, even the particles of a toner composed of a resin material having a low glass transition temperature and a low softening temperature as described above, can be firmly fixed onto a recording medium. In addition, as the unsaturated fatty acid component cures, overwriting with a rollerball pen on a fixed toner image can be easily and securely performed.

Such fatty acid monoester preferably contains an unsaturated fatty acid having 16 to 22 carbon atoms as the unsaturated fatty acid component. Then, the penetration of the liquid developer into a recording medium will become favorable, and the liquid developer cures more favorably by the oxidative polymerization reaction, thus the fixing property of the toner particles onto the recording medium becoming more excellent. Examples of the unsaturated fatty acid which satisfies the above-described conditions include oleic acid, palmitoleic acid, linolic acid, α-linoleic acid, γ-linoleic acid, arachidonic acid, docosahexaenoic acid (DHA), eicosapentaenoic acid (EPA), conjugated unsaturated fatty acids thereof, and the like.

Even though the fatty acid monoester is a monoester between a fatty acid and an alcohol, this alcohol is preferably an alkylalcohol having 1 to 4 carbon atoms. Then, the chemical stability of the liquid developer becomes excellent, and the storage property and long-term stability of the liquid developer become more excellent. Furthermore, such alcohol also adjusts the viscosity of the insulating liquid appropriate, so that the penetration of the liquid developer into the recording medium can be rendered more favorable. Examples of such alcohol include methanol, ethanol, propanol, butanol, isobutanol, and the like.

The insulating liquid according to embodiments of the invention contains a fatty acid monoester which is one or a combination of two or more selected from those generated by transesterification of the above-mentioned fatty acids and alcohols.

The content of the fatty acid monoester in the insulating liquid is preferably 1.0 to 50% by weight, more preferably 10 to 50% by weight, and even more preferably 20 to 50% by weight. If the content of the fatty acid monoester in the insulating liquid is less than the lower limit of the above range, plasticization of toner particles by the fatty acid monoester may not sufficiently take place during fixation. Also, it may become difficult to appropriately adjust the viscosity of the liquid developer, the penetration of the liquid developer (insulating liquid) into the recording medium may be insufficient, and at the same time, it may also become difficult to appropriately carry out the oxidative polymerization reaction of the unsaturated fatty acid component contained in the insulating liquid. As a result, the fixing property of the toner particles onto the recording medium may become unsatisfactory. On the other hand, if the content exceeds the upper limit of the above range, it may be difficult in an image forming device that will be described later, to pour the liquid developer from the developer vessel onto the coating roller, and therefore, the toner particles may not be fixed uniformly on the recording medium, making the resulting images uneven. Moreover, depending on the compositional material of the members of the device, any members that is brought into contact with the liquid developer within the image forming device may swell, thus possibly causing significantly decreased life span of the image forming device.

According to another embodiment of the invention, the insulating liquid may contain a fatty acid triglyceride containing an unsaturated fatty acid, as the fatty acid component. Hereinafter, the fatty acid triglyceride will be discussed.

### Fatty Acid Triglyceride

According to embodiments of the invention, the fatty acid triglyceride in the insulating liquid is a triester (triglyceride) between a fatty acid and glycerin, and contains an unsaturated fatty acid as the fatty acid component.

The fatty acid triglyceride is an environmentally friendly component. Thus, the environmental stress of the insulating liquid caused by leakage of the insulating liquid to the outside of the image forming device, disposal of a used liquid developer, or the like can be reduced. Consequently, an environmentally friendly liquid developer can be provided.

Furthermore, the unsaturated fatty acid component contained in the fatty acid triglyceride is a component which can contribute to an improvement in the fixability of toner particles onto a recording medium. To be more specific, the unsaturated fatty acid component is a component having a function of undergoing a polymerization reaction by being oxidized (being oxidized upon fixation), and curing by itself, thereby improving the fixability of toner particles. Therefore, even the particles of a toner composed of a resin material having a low glass transition temperature and a low softening temperature as described above, can be firmly fixed onto a recording medium. In other words, since the toner particles are composed of a resin material having a low glass transition temperature and a low softening temperature, the toner particles can be fixed at a relatively low fixing temperature. Also, the insulating liquid (unsaturated fatty acid component) transferred together with the toner particles onto the recording medium undergoes oxidative polymerization and curing upon heating during the fixing process, thereby covering the surface of the fixed toner particles. Thus, even the particles of a toner composed of a resin material having a low glass transition temperature and a low softening temperature as described above, can be firmly fixed onto a recording medium. In addition, as the unsaturated fatty acid component cures, overwriting with a rollerball pen on a fixed toner image can be easily and securely performed.

In particular, when an insulating liquid containing a fatty acid monoester and a fatty acid triglyceride is used, toner particles can be fixed onto a recording medium at a low temperature, and at the same time, a particularly excellent intensity of fixation can be obtained. This can be explained as follows. In general, between fatty acid monoester and fatty acid triglycerides, the fatty acid monoesters have lower viscosities. Furthermore, the fatty acid monoester and the fatty acid triglycerides can be used to appropriately adjust the viscosities of the insulating liquid and the liquid developer by adjusting the proportions of the fatty acid monoester and the fatty acid triglyceride contained in the insulating liquid, and thus the penetration of the liquid developer into the recording medium can favorably take place. Moreover, since oxidation of the unsaturated fatty acid component in the insulating liquid results in curing of the insulating liquid while containing toner particles, even the particles of a toner composed of a resin material having a low glass transition temperature and a low softening temperature as described above can be firmly fixed onto the recording medium, owing to the anchoring effect of the cured liquid developer to the recording medium.

The fatty acid triglyceride is a triester composed of one glycerin molecule and three fatty acid molecules. Typically, the polymerization product obtained from a mixture of a fatty acid monoester and a fatty acid triglyceride is likely to have a larger molecular weight, compared to the polymerization product produced by oxidative polymerization of a fatty acid monoester only. Thus, since an insulating liquid containing a fatty acid triglyceride tends to have a polymerization product with a larger molecular weight, the anchoring effect of the cured liquid developer to the recording medium is enhanced, and the intensity of fixation of the toner particles to the recording medium becomes excellent. Also, the polymerization product of a mixture of a fatty acid monoester and a fatty acid triglyceride takes a shorter time to cure. Thus, an insulating liquid containing a fatty acid triglyceride takes a shorter time to be converted from the liquid state to the solid state (to cure), compared to an insulating liquid composed only of a fatty acid monoester as the fatty acid ester, and the liquid developer can be favorably applied to high speed image formation. To the contrast, in the case of an insulating liquid composed only of a fatty acid triglyceride as the fatty acid ester, without containing a fatty acid monoester, the molecular weight of the polymerization product may be increased, but penetration of the liquid developer into a recording medium occurs insufficiently, thus it being unable to obtain an excellent intensity of fixation of the toner particles onto the recording medium as described above. Further, it is difficult to apply the liquid developer to high speed image formation.

In addition, since an insulating liquid containing a fatty acid monoester and a fatty acid triglyceride has increased mechanical strength of the polymerization product produced after the polymerization reaction, an excellent intensity of fixation of the toner particles onto the recording medium is obtained. It is believed that this is because the fatty acid triglyceride contains a plurality of fatty acid components, and is susceptible to entanglement with the fatty acid components of the fatty acid monoester, and the fatty acid components of other fatty acid triglycerides during the oxidative polymerization process.

Furthermore, when an insulating liquid containing a fatty acid monoester and a fatty acid triglyceride is used, the dispersibility of the toner particles can be particularly increased, and the storage property and long-term stability of the liquid developer can be rendered excellent. This can be explained as follows. The fatty acid monoester and the fatty acid triglyceride have excellent affinity for the resin material which is the main component of the toner particles. In particular, since the fatty acid triglyceride, which is a triester, has a high viscosity and has a structure comprising a plurality of fatty acid components, its adsorbability to the surface of toner particles is excellent. Thus, the fatty acid triglyceride is thought to have properties as a dispersion medium for the toner particles, as well as an effect as a dispersant. Thus, it is conceived that the mentioned effect can be obtained because a part of the fatty acid triglyceride exists in the insulating liquid containing a fatty acid monoester and a fatty acid triglyceride, in a state of being adsorbed onto the surface of the toner particles, thus effectively preventing aggregation (blocking) of the toner particles.

Moreover, the insulating liquids composed of petroleum-based hydrocarbons (mainly isoparaffin-based solvents) or the like, which have been traditionally used as liquid developers, cause deterioration of the fixing properties of the toner particles onto the recording medium, if not excluded during fixation, whereas an insulating liquid containing a fatty acid monoester and a fatty acid triglyceride induces excellent fixing properties of the toner particles onto the recording medium, via curing of the insulating liquid itself upon fixation.

In addition, with regard to the resin material that is used according to embodiments of the invention, such as polyesters, styrene-acrylic copolymers and the like, if a plant oil is used as the insulating liquid, the fatty acid component composing the plant oil (mainly fatty acid triglyceride) penetrates into the resin particles during the fixing process, and manifests a plasticizing effect. This plasticizing effect allows, for example, in the case of using paper as the recording medium, the toner particles to easily penetrate into the interstices of paper fibers, and thus the fixing property between the paper and the toner particles is improved. Among the insulating liquids composed of such fatty acid component, in particular, insulating liquids containing fatty acid monoesters have excellent fixing properties. It is believed that this is because fatty acid monoesters in general have low molecular weights and are easily incorporated in between resin particles during the fixing process, compared to fatty acid triglycerides, thus it being easier for the fatty acid monoesters to manifest the plasticizing effect.

In the case of using a polyester resin as the resin material composing the toner particles, the resin has particularly good affinity for an insulating liquid containing a fatty acid monoester and a fatty acid triglyceride as described above, and thus allows excellent dispersibility of the toner particles in the liquid developer, while making the fixing properties of the toner particles onto the recording medium particularly excellent.

As discussed in the above, when the insulating liquid contains a fatty acid triglyceride, the fixing properties of the toner particles onto the recording medium become excellent. Also, when an insulating liquid containing a fatty acid triglyceride and the above-described fatty acid monoester is used, particularly excellent fixing properties of the toner particles onto the recording medium can be obtained, and a liquid developer which is favorable for high speed image formation can be provided.

The fatty acid triglyceride in the insulating liquid preferably contains an unsaturated fatty acid component having 16 to 22 carbon atoms. In an insulating liquid containing a fatty acid triglyceride, which satisfies the condition, when the fatty acid monoester mentioned above and the fatty acid triglyceride satisfying the above condition are contained at a predetermined ratio, a liquid developer having an appropriate viscosity can be obtained, thus it being possible to obtain a liquid developer having excellent fixability onto a recording medium, as well as a liquid developer which can be appropriately used in high speed image formation. Examples of the unsaturated fatty acid satisfying the above-described condition include oleic acid, palmitoleic acid, linolic acid, α-linoleic acid, γ-linoleic acid, arachidonic acid, docosahexaenoic acid (DHA), eicosapentanoic acid (EPA) conjugated unsaturated fatty acids thereof, and the like.

The fatty acid triglyceride containing the unsaturated fatty acid component as described above has high affinity for the resin material described above (in particular, polyester resins), and for fatty acid monoesters (in particular, unsaturated fatty acid monoesters). Therefore, the insulating liquid containing a fatty acid triglyceride containing an unsaturated fatty acid component attains an appropriate viscosity, and the penetration of the liquid developer into the recording medium becomes more favorable. Then, the fixing properties of the toner particles onto the recording medium become excellent, and such liquid developer can be favorably applied to high speed image formation.

If the fatty acid triglyceride partly contains a fatty acid triglyceride having even at least one molecule of a saturated fatty acid as the fatty acid component, the chemical stability or electrical insulating property of the liquid developer can be maintained high. Therefore, any chemical changes of the liquid developer can be prevented, and the electrical resistance can be maintained high, thus it being possible to enhance the storage property and long-term stability of the liquid developer. Examples of such saturated fatty acid include butyric acid, caproic acid, caprylic acid, capric acid, lauric acid, myristic acid, palmitic acid, stearic acid, arachidic acid, behenic acid, lignoceric acid, and the like.

Such fatty acid triglyceride can be efficiently obtained from, for example, naturally-occurring oils and fats, including plant-derived oils and fats, such as rapeseed oil, soybean oil, safflower oil, sunflower oil, linseed oil, cotton seed oil, dehydrated castor oil and the like; animal-derived oils and fats, such as herring oil, sardine oil and the like; and the like.

If the insulating liquid contains a fatty acid triglyceride, the content of the fatty acid triglyceride in the insulating liquid is preferably 51 to 80% by weight, more preferably 51 to 75% by weight, and even more preferably 51 to 70% by weight. The liquid developer containing the insulating liquid which satisfies the above-mentioned condition has particularly excellent fixing properties of the toner particles onto a recording medium, as well as excellent storage property, and thus can be favorably adapted to high speed image formation.

Also, if the insulating liquid contains a fatty acid triglyceride, the ratio of the fatty acid monoester to the fatty acid triglyceride in the insulating liquid is not particularly limited, but it is preferable that the ratio satisfies a relationship as follows. That is, when the content of the fatty acid monoester in the insulating liquid is referred to as X [wt %], and the content of the fatty acid triglyceride is referred to as Y [wt %], the relationship of 0.01≦X/Y≦1.0 is satisfied; it is more preferable that the relationship of 0.1≦X/Y≦1.0 is satisfied; and it is even more preferable that the relationship of 0.25≦X/Y≦1.0 is satisfied. When such relationships are satisfied, an appropriate viscosity of the insulating liquid is obtained. As a result, the penetrability of the insulating liquid into a recording medium is enhanced, and the anchoring effect of the insulating liquid (unsaturated fatty acid component) due to curing, as described above, is exhibited more significantly, thereby it being possible to more firmly fix the toner particles to the recording medium.

Furthermore, according to another embodiment of the invention, the insulating liquid may contain an aliphatic hydrocarbon and/or a silicone oil. As such, the insulating liquid attains excellent fixing properties when it contains an aliphatic hydrocarbon and/or a silicone oil in addition to the fatty acid monoester. Hereinafter, the aliphatic hydrocarbon and/or silicone oil will be discussed.

### Aliphatic Hydrocarbon

An aliphatic hydrocarbon is generally a chemically stable liquid having high electrical resistance. Thus, a liquid developer employing an aliphatic hydrocarbon has excellent developability and transferability, and the resulting toner images become clear with fewer defects. Furthermore, when a liquid developer contains an aliphatic hydrocarbon as the insulating liquid, in addition to the fatty acid monoester, high speed and low temperature fixation is enabled, and an excellent intensity of fixation of the resulting toner images can be obtained. Also, excellent color reproducibility of the toner images is attained. This is conceived to be due to the following reasons. Aliphatic hydrocarbons have high affinity for fatty acid monoesters and easily penetrate into recording media such as paper and the like. Therefore, an insulating liquid containing an aliphatic hydrocarbon and a fatty acid monoester can rapidly penetrate into a recording medium upon fixation, and thus the amount of the insulating liquid present between toner particles can be reduced. In particular, the resin material composing the toner particles in the liquid developer according to embodiments of the invention has a softening point and a glass transition temperature as described above. Thus, it is believed that in the case of using such a liquid developer, even if fixation is implemented at a high speed and at a low temperature, the toner particles can still easily come into contact, melt and firmly bind to each other upon fixation. Also, an aliphatic hydrocarbon-based liquid is a liquid which is less hygroscopic during storage. Therefore, if an insulating liquid contains an aliphatic hydrocarbon, the insulating liquid can be suitably prevented from absorbing moisture during storage, and the insulating liquid can be appropriately prevented from deterioration. That is, as an aliphatic hydrocarbon having low hygroscopic property and high affinity for fatty acid monoesters encloses a fatty acid monoester, it can be certainly prevented that the fatty acid monoester contacts with moisture, and the fatty acid component dissociates therefrom. Also, as described above, because aliphatic hydrocarbons are chemically stable and deteriorate less during storage, the liquid developer can attain particularly excellent storage properties.

The aliphatic hydrocarbon that can be used for the insulating liquid is not particularly limited, but examples thereof include Isopar E, Isopar G, Isopar H, Isopar L (EXXON Mobile Corp.), Cosmo White P-60, Cosmo White P-70, Cosmo White P-120 (Cosmo Oil Lubricants Co., Ltd.), Dyna Freshia W-8, Daphne Oil CP, Daphne Oil KP, Transformer Oil H, Transformer Oil G, Transformer Oil A, Transformer Oil B, Transformer Oil S (Idemitsu Kosan Co., Ltd.), Shellsol 70, Shellsol 71 (Shell Oil Company, Ltd.), Amsco OMS, Amsco 460 solvent (American Mineral Spirits Company, Ltd.), low-viscosity/high-viscosity liquid paraffins (Waco Pure Chemical Industries, Ltd.), octane, isooctane, decane, isodecane, decalin, nonane, dodecane, isodecane, cyclohexane, cyclooctane, cyclodecane, and the like. Among these, one or a combination of two or more species can be used.

The aliphatic hydrocarbon also preferably has a branched chain of a hydrocarbon group in the molecule. Then, the aliphatic hydrocarbon becomes chemically stable, and a liquid developer employing such aliphatic hydrocarbon attains particularly excellent storage property. It is believed that this is because the structure of the aliphatic hydrocarbon is increased in volume, and becomes a structure difficult to undergo chemical reactions.

The aliphatic hydrocarbon is also preferably a saturated aliphatic hydrocarbon. Then, the liquid developer can attain particularly high electrical resistance, and particularly excellent storage property of the liquid developer can also be attained.

### Silicone Oil

Silicone oils are organic compounds having a skeleton composed of siloxane bonds. Silicone oils in general have high electrical resistance. Therefore, when a silicone oil is used as the insulating liquid, the liquid developer attains particularly high electrical resistance, and the toner images obtain excellent transferability and developability. Furthermore, when a liquid developer contains a silicone oil as the insulating liquid, in addition to the fatty acid monoester, high speed and low temperature fixation is enabled, and an excellent intensity of fixation of the resulting toner images can be obtained. This is believed to be due to the following reasons. Although a silicone oil is compatible with fatty acid monoesters, it has low affinity for the resin composing toner particles. Therefore, in a liquid developer containing a silicone oil and a fatty acid monoester, the fatty acid monoester having high affinity for the resin material selectively penetrates in the vicinity of the surface of the toner particles, and particularly favorably manifests a plasticizing effect upon fixation. Thus, it is conceived that even when fixation is performed at a relatively low temperature at a high speed, the toner images can be firmly fixed on the recording medium. Since the silicone oils have various viscosities depending on the type, appropriate selection of the silicone oil can result in a particularly appropriate viscosity of the liquid developer. Also, the silicone oil is a material which is chemically stable and has less impact on human bodies. Therefore, the liquid developer can be appropriately prevented from suffering from deterioration of the insulating liquid during storage, thereby having excellent storage properties. Even in the case where the insulating liquid leaks to the outside of an image forming device, the liquid developer can be safe.

Examples of the silicone oil that can be used for the insulating liquid include KF96, KF-4701, KF-965, KS-602A, KS-603, KS-604, KF-41, KF-54, FA-630 (Shin-Etsu Silicones, Inc.), TSF410, TFS433, TFS434, TFS451, TSF437 (Momentive Performance Materials Japan, LLC.), SH200 (Toray Industries, Inc.), and the like. Among these, one or a combination of two or more species can be used.

The ratio of the fatty acid monoester to the aliphatic hydrocarbon and/or silicone oil in the insulating liquid is not particularly limited, but it is preferable that the ratio satisfies the following relationship. That is, when the content of the fatty acid monoester in the insulating liquid is referred to as X [wt %], and the sum of the contents of the aliphatic hydrocarbon and silicone oil is referred to as Z [wt %], it is preferable that the relationship of 0.1≦X/Z≦1.0 is satisfied; and it is more preferable that the relationship of 0.25≦X/Z≦1.0 is satisfied. When these relationships are satisfied, even in the case of fixing at a high speed and a low temperature, the toner particles can be more firmly fixed to the recording medium. The viscosity of the liquid developer can also be suitably adjusted.

The insulating liquid may also contain components other than those described above. Examples of such components include benzene, toluene, xylene, mesitylene, and the like.

The insulating liquid may also contain the components as described below. For such components, for example, the fatty acids composing the fatty acid monoester and the fatty acid triglyceride in the insulating liquid may be present independently. The components may also include a diester (diglyceride) of a diol, which is represented by ethylene glycol, propylene glycol or the like, and a fatty acid. Moreover, the components may also include a diester (diglyceride) composed of one glycerin molecule and two fatty acid molecules, or a monoester (monoglyceride) composed of one glycerin molecule and one fatty acid molecule. If an insulating liquid contains such components, the fixing properties of the toner particles to a recording medium can become excellent, and a liquid developer excelling in high speed image formation can be provided.

The liquid developer (insulating liquid) may also contain an antioxidant which has a function of preventing/suppressing oxidation of the unsaturated fatty acid components contained in the fatty acid monoester and the fatty acid triglyceride. Then, involuntary oxidation of the unsaturated fatty acid components in the liquid developer can be prevented. As a result, deterioration over time of the liquid developer (insulating liquid) can be prevented, and thus, the dispersibility, fixability to a recording medium, and the like of the toner particles over a long time can be made particularly excellent. That is, a liquid developer having particularly excellent long stability (storage stability) can be obtained.

Examples of such antioxidant as described above include vitamin E such as tocopherol, d-tocopherol, dl-α-tocopherol, α-tocopherol acetate, dl-α-tocopherol acetate, tocopherol acetate, α-tocopherol and the like; dibutylhydroxytoluene; butylhydroxyanisole; vitamin C such as ascorbic acid, ascorbic acid salts, ascorbic acid stearic acid esters and the like; green tea extracts, green coffee bean extracts, sesamol, sesaminol and the like. Among these, one or a combination of two or more species can be used.

Among those described above, when vitamin E is used, the following effects are obtained. That is, since vitamin E is an environmentally friendly component, and also the oxidation products thereof have less influence on the liquid developer, the liquid developer can be made more environmentally friendly. Also, since vitamin E is highly dispersible in the above-described fatty acid monoesters and fatty acid triglycerides, it can be favorably used as an antioxidant. When vitamin E is used in combination with the above-described fatty acid monoesters and fatty acid triglycerides, the affinity of the insulating liquid for toner particles can be further improved. As a result, the storage property of the liquid developer, the fixability of the toner particles to recording media, and the like can become particularly excellent.

Among those described above, when vitamin C is used, the following effects can be obtained. That is, in a manner similar to that of vitamin E described above, vitamin C is an environmentally friendly component, and the oxidation products thereof have less influence on the liquid developer, thus it being able to make the liquid developer more environmentally friendly. Furthermore, since vitamin C has a relatively smaller molecular weight compared to other antioxidants, and has higher dispersibility in fatty acid monoesters and fatty acid triglycerides, it can be favorably used as an antioxidant. In addition, since vitamin C has a relatively low thermal decomposition temperature, during storage and the like of the liquid developer (including the idling time of image forming devices), vitamin C can sufficiently manifest the function as an antioxidant, while upon fixation, can promote the oxidative polymerization reaction of unsaturated fatty acid components by deteriorating the function as an antioxidant.

The thermal decomposition temperature of the antioxidant is preferably lower than or equal to the fixation temperature during the fixing process. Then, during the storage of the liquid developer or the like, deterioration of the insulating liquid can be effectively prevented, while during fixation, the antioxidant in the insulating liquid adhered on the surface of toner particles can be thermally decomposed to effectively cure the unsaturated fatty acid components (oxidative polymerization), thus sufficiently excellent fixability of the toner particles to recording media being obtained.

Specifically, the thermal decomposition temperature of the antioxidant is preferably 200° C. or lower, and more preferably 180° C. or lower. Then, the intensity of fixation of toner particles can be more effectively improved, while sufficiently maintaining the function as an antioxidant.

The content of the antioxidant in the insulating liquid is preferably 0.01 to 15 parts by weight, more preferably 0.1 to 7 parts by weight, and even more preferably 1 to 7 parts by weight, relative to 100 parts by weight of the insulating liquid. Then, the deterioration of the unsaturated fatty acid components due to oxidation can be more assuredly prevented upon storage or the like of the liquid developer, and when necessary (upon fixation), curing of the unsaturated fatty acid components (oxidative polymerization reaction) can be efficiently implemented.

The liquid developer may also contain an oxidative polymerization accelerator (curing accelerator) which accelerates the oxidative polymerization reaction (curing reaction) of the unsaturated fatty acid components contained in the above-described fatty acid monoesters and fatty acid triglycerides. Then, when necessary (upon fixation), the unsaturated fatty acid components can be effectively oxidizingly polymerized (cured). Consequently, the intensity of fixation of the toner particles to recording media can be made particularly excellent.

When the liquid developer contains the oxidative polymerization accelerator, the oxidative polymerization accelerator is not particularly limited, but those which do not substantially contribute to the oxidative polymerization reaction of the unsaturated fatty acid components during storage or the like (including the idling time of image forming devices and the like), but contribute to the oxidation polymerization (curing) reaction of the unsaturated fatty acid components when necessary (upon fixation) are preferred. Then, a liquid developer having excellent storage properties (long-term stability) can be obtained, and a particularly excellent intensity of fixation of the toner particles to recording media can be attained.

For such oxidative polymerization accelerator, for example, a material which has a function of accelerating the oxidative polymerization reaction (curing reaction) of the unsaturated fatty acid component under heating conditions, and does not have a function of substantially accelerating the oxidative polymerization reaction (curing reaction) of the unsaturated fatty acid component near room temperature, that is, a material having relatively high activation energy in the oxidative polymerization reaction (curing reaction) of the unsaturated fatty acid component.

Examples of such material (oxidative polymerization accelerator) include various fatty acid metal salts and the like, and among them, one or a combination of two or more species can be used. When such material (oxidative polymerization accelerator) is used, the oxidative polymerization of the unsaturated fatty acid component can be effectively performed upon fixation, while maintaining the stability of the liquid developer during storage or the like. In particular, since fatty acid metal salts can accelerate the oxidative polymerization reaction of the unsaturated fatty acid component by supplying oxygen during fixation, the salts can effectively accelerate the oxidative polymerization reaction during heating upon fixation or the like. Accordingly, while more certainly preventing the occurrence of the oxidative polymerization reaction during storage or the like, the oxidative polymerization reaction can be more effectively accelerated during fixation or the like. Furthermore, since fatty acid metal salts have high dispersibility in fatty acid monoesters and fatty acid triglycerides, the salts can be uniformly dispersed in the insulating liquid, and as a result, the oxidative polymerization reaction can be integrally and efficiently carried out upon fixation.

Examples of such fatty acid metal salt include resin acid metal salts (for example, cobalt salts, manganese salts, lead salts, etc.), linolenic acid metal salts (for example, cobalt salts, manganese salts, lead salts, etc.), octylic acid metal salts (for example, cobalt salts, manganese salts, lead salts, zinc salts, calcium salts, etc.), naphthenic acid metal salts (for example, zinc salts, calcium salts, etc.), and the like, and among these, one or a combination of two or more species can be used.

The oxidative polymerization accelerator may be contained in the insulating liquid in an encapsulated state. Then, in a manner similar to the above, the oxidative polymerization accelerator can be made to substantially not contribute to the oxidative polymerization reaction of the unsaturated fatty acid component during storage or the like (including the idling time of image forming devices, and the like), but to contribute to the oxidative polymerization (curing) reaction of the unsaturated fatty acid component contained in fatty acid monoesters and fatty acid triglycerides when necessary. That is, the oxidative polymerization reaction can be more assuredly prevented during the storage or the like of the liquid developer; but during fixation, the encapsulation is disintegrated by the pressure of fixation or the like, and the oxidative polymerization accelerator comes into contact with the unsaturated fatty acid component to assuredly allow the oxidative polymerization reaction of the unsaturated component to proceed. With such constitution, there is available a wide range of selection for the material of the oxidative polymerization accelerator. In other words, even an oxidative polymerization accelerator with high reactivity (an oxidative polymerization accelerator contributing to the oxidative polymerization reaction of the unsaturated fatty acid component at a relatively low temperature) can be favorably used, and the intensity of fixation of toner particles onto a recording medium can be made particularly excellent.

The content of the oxidative polymerization accelerator in the insulating liquid is preferably 0.01 to 15 parts by weight, more preferably 0.05 to 7 parts by weight, and even more preferably 0.1 to 5 parts by weight, relative to 100 parts by weight of the insulating liquid. Then, the oxidative polymerization reaction of the unsaturated fatty acid component upon fixation can be more certainly performed, while sufficiently preventing the oxidative polymerization reaction during the storage or the like of the liquid developer.

In addition, the insulating liquid that can be used for the invention has an iodine value of preferably 80 to 220, more preferably 90 to 200, and even more preferably 100 to 190.

As such, when the iodine value which is an index indicating the amount of unsaturated bonds contained in an insulating liquid is noted, and an allowable range of the iodine value of the insulating liquid is stipulated, toner particles can be fixed to a recording medium at a low temperature, and at the same time, the toner particles can be firmly fixed to the recording medium. In other words, since the toner particles are composed of a resin material having a low glass transition temperature and a low softening temperature as described above, they can be fixed at a relatively low fixation temperature. Furthermore, because the insulating liquid (unsaturated fatty acid component) transferred together with the toner particles onto the recording medium is made to undergo an oxidative polymerization reaction and to cure by the heating during fixation, and covers the surface of the fixed toner particles, even the particles of a toner composed of a resin material having a low glass transition temperature and a low softening temperature as described above can be particularly firmly fixed onto the recording medium. Also, as the unsaturated fatty acid component cures, overwriting with a rollerball pen on a fixed toner image can be easily and securely performed.

The electrical resistance of the above-described insulating liquid at room temperature (20° C.) is preferably 1×10⁹ Ωcm or greater, more preferably 1×10¹¹ Ωcm, and even more preferably 1×10¹³ Ωcm.

The dielectric constant of the insulating liquid is preferably 3.5 or less.

In addition, the viscosity (viscosity measured at 25° C. using an oscillating viscometer according to JIS Z8809) of a liquid developer composed of the respective components described above (liquid developer according to embodiments of the invention) is preferably 50 to 1000 mPa·s, more preferably 100 to 900 mPa·s, and even more preferably 150 to 800 mPa·s. Then, the penetration of the liquid developer into a recording medium becomes more favorable, and thus, more excellent fixing properties of the toner particles onto the recording medium can be obtained, the resulting images on the recording medium become clear without being uneven, while a liquid developer which is particularly favorable for adapting to high speed image formation is obtained. However, in the case of not containing a fatty acid monoester, the viscosity of the insulating liquid would be excessively increased, and a large amount of the insulating liquid would be fixed onto the recording medium while being adhered onto the surface of toner particles. When a large quantity of the insulating liquid is present on the surface of toner particles as such, it is difficult for the insulating liquid with high viscosity to penetrate into the recording medium, and thus the fixing properties of the toner particles onto the recording medium are deteriorated, thereby possibly making high speed image formation difficult.

### First Embodiment of Method of Preparing Liquid Developer

Hereinafter, the first embodiment of the method of preparing a liquid developer of the invention will be described in detail with reference to the attached drawings. In addition, according to the present embodiment, an example of the insulating liquid containing a fatty acid monoester and a fatty acid triglyceride will be described.

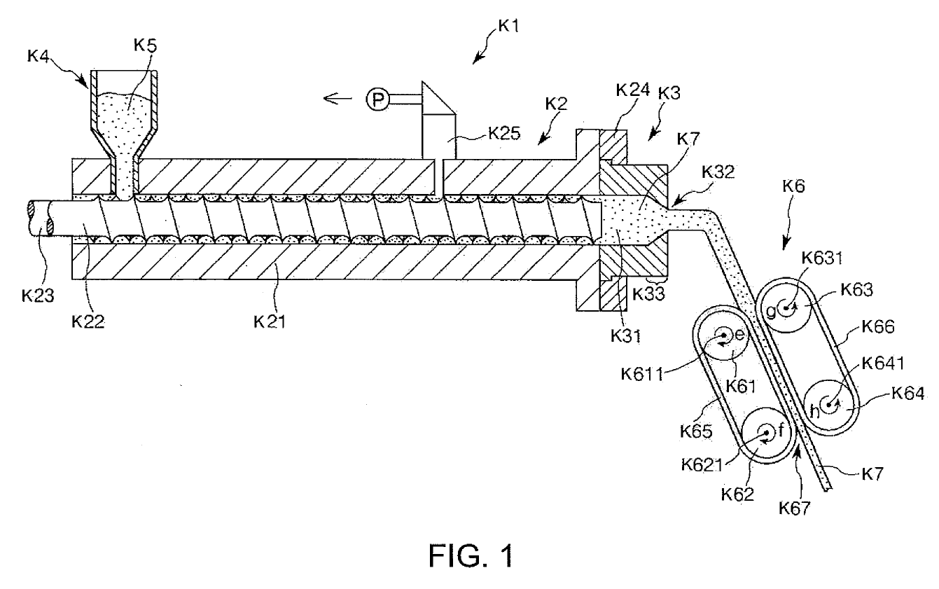

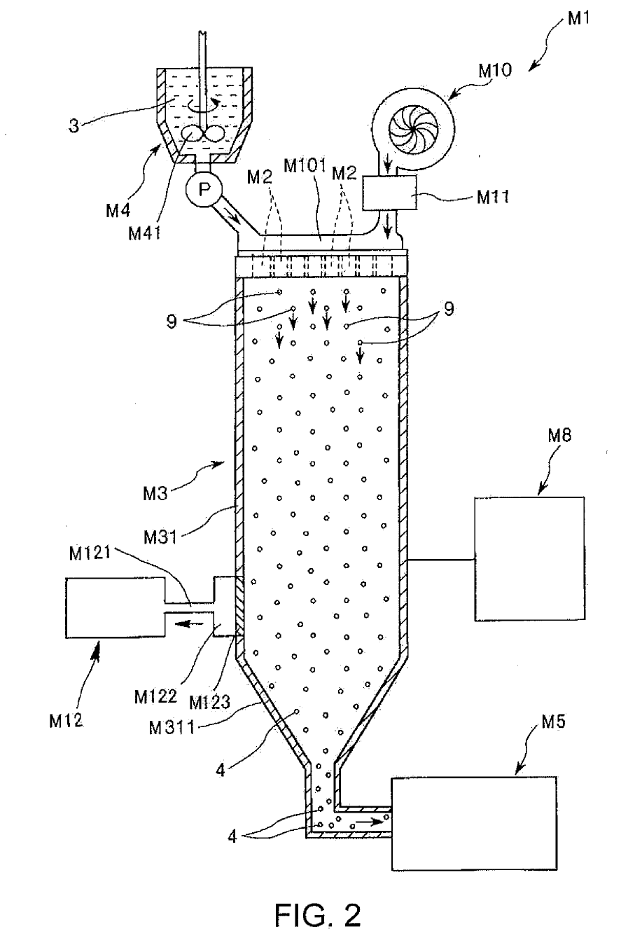

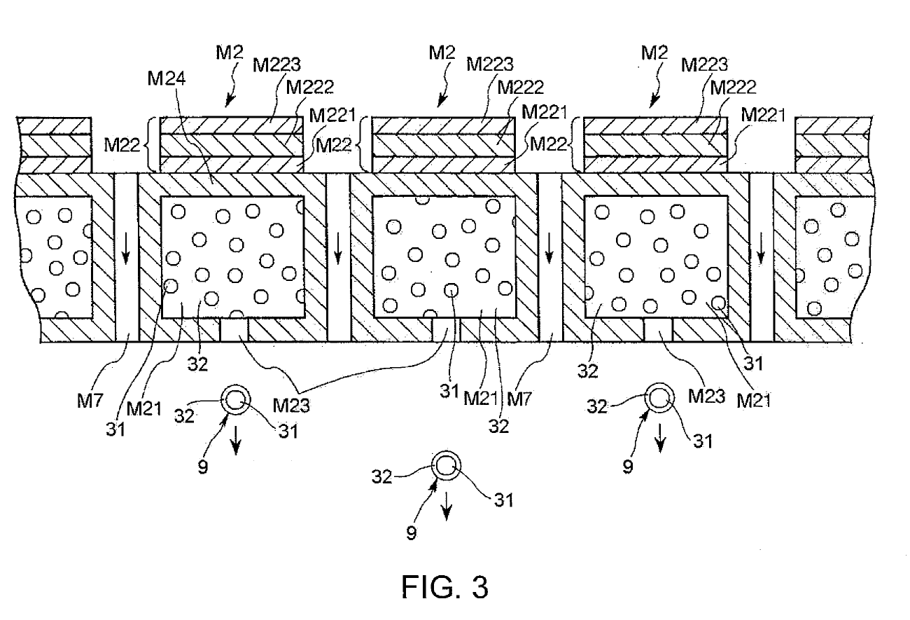

FIG. 1 is a vertical cross-sectional view schematically illustrating an example of the configuration of a kneading machine and cooler for preparing a kneading product that is used in the preparation of an aqueous emulsion, FIG. 2 is a vertical cross-sectional view schematically illustrating a preferred embodiment of a dry microparticle producing apparatus that is used in the preparation of a liquid developer according to an embodiment of the invention, and FIG. 3 is a magnified cross-sectional view of the vicinity of the head unit of the dry microparticle producing apparatus shown in FIG. 2. Hereinafter, with regard to FIG. 1, the left hand side will be referred to as “rear edge”, and the right hand side as “front edge”.

The liquid developer according to embodiments of the invention may be prepared using any method, but the method of preparing a liquid developer related to the present embodiment comprises a dispersion preparation process of obtaining a dispersion in which a dispersoid composed of the toner material as described above is dispersed in a dispersion medium, a dispersion medium removal process of removing the dispersion medium to obtain dry microparticles, and a dispersion process of dispersing the dry microparticles in an insulating liquid.

According to the present embodiment, the case of using, as the dispersion, an aqueous dispersion in which the dispersoid is dispersed in an aqueous dispersion medium composed of an aqueous liquid will be described. By using an aqueous dispersion, a liquid developer can be provided by an environmentally friendly method.

The aqueous dispersion may be prepared by any method, but according to the present embodiment, one prepared using a kneading product containing a colorant and a resin material is used.

Additionally, the constituent materials (components) of the kneading product may include, in addition to the materials composing toner as described above, for example, those materials that can be used as solvents, such as inorganic solvents, organic solvents and the like. Then, for example, the efficiency of kneading can be improved, and a kneading product having the respective components more uniformly intermixed can be easily obtained.

### Kneading Product

Next, an exemplary method of obtaining a kneading product K7 by kneading a raw material K5 containing the toner material as described above will be discussed.

The kneading product K7 can be prepared using, for example, an apparatus as shown in FIG. 1.

### Kneading Process

The raw material K5 provided for kneading contains the toner material as described above. In particular, as the raw material K5 contains a colorant, the air contained in the raw material K5 (particularly, the air entrained by the colorant) can be efficiently removed in the current process, and thus incorporation (remaining) of air bubbles inside toner particles can be effectively prevented. The raw material K5 provided for kneading preferably has each of such components preliminarily mixed.

In the present embodiment, a configuration of using a twin screw kneading extruder as the kneading machine will be described.

A kneading machine K1 has a processing unit K2 which kneads the raw material K5 while conveying; a head unit K3 which molds the kneaded raw material (kneading product K7) into a predetermined cross-sectional shape and extrudes; and a feeder K4 which supplies the raw material K5 into the processing unit K2.

The processing unit K2 has a barrel K21, a screw K22 and screw K23 inserted in the barrel K21, and a fitting member K24 to fit the head unit K3 at the front edge of the barrel K21.

In the processing unit K2, as the screw K22 and screw K23 rotate, shear force is exerted to the raw material K5 that has been supplied from the feeder K4, and a uniform kneading product K7 is obtained.

The full length of the processing unit K2 is preferably 50 to 300 cm, and more preferably 100 to 250 cm. If the full length of the processing unit K2 is less than the lower limit, it may be difficult to sufficiently and uniformly mix the respective components in the raw material K5. On the other hand, if the full length of the processing unit K2 exceeds the upper limit, deterioration of the raw material K5 due to heat is likely to occur, depending on the temperature inside the processing unit K2, the speed of rotation of the screw K22 and screw K23, and the like, and it may be difficult to sufficiently control the properties of the finally obtained liquid developer (toner).

The temperature of the raw material during kneading may vary with the composition of the raw material K5 or the like, but the temperature is preferably 80 to 260° C., and more preferably 90 to 230° C. Moreover, the raw material temperature inside the processing unit K2 may be either uniform, or different along different sites. For example, the processing unit K2 is installed in a first region where the set temperature is relatively low, on the rear edge side of the first region, and a second region where the set temperature is higher than the first region may be included.

The residence time (time required for passage) of the raw material K5 in the processing unit K2 is preferably 0.5 to 12 minutes, and more preferably 1 to 7 minutes. If the residence time in the processing unit K2 is less than the lower limit, it may be difficult to sufficiently and uniformly mix the respective components in the raw material K5. On the other hand, if the residence time in the processing unit K2 exceeds the upper limit, the production efficiency is lowered, and deterioration of the raw material KS due to heat is likely to occur depending on the temperature inside the processing unit K2, the speed of rotation of the screw K22 and screw K23, and the like, thus it being possibly difficult to sufficiently control the properties of the finally obtained liquid developer (toner).

The speed of rotation of the screw K22 and screw K23 may vary with the composition of the binder resin, or the like, but is preferably 50 to 600 rpm. If the speed of rotation of the screw K22 and screw K23 is less than the lower limit, it may be difficult to sufficiently and uniformly mix the respective components of the raw material K5. On the other hand, if the speed of rotation of the screw K22 and screw K23 exceeds the upper limit, the molecular chains of the resin may be cleaved by shear force to deteriorate the properties of the resin.

Also, in the kneading machine K1 that is used according to the present embodiment, the interior of the processing unit K2 is connected to a pump P via a deaerating vent K25. This allows the interior of the processing unit K2 to be deaerated, so that increases of the pressure inside the processing unit K2 caused by the raw material K5 (kneading product K7) being heated or generating heat, or the like can be prevented. As a result, the kneading process can be performed safely and efficiently. Furthermore, when the interior of the processing unit K2 is connected to the pump P via the deaerating vent K25, air bubbles (particularly, relatively large air bubbles) can be effectively prevented from being contained in the resulting kneading product K7, and thus the properties of the finally obtained liquid developer (toner) can be more excellent.

### Extruding Process

The kneading product K7 which has been kneaded in the processing unit K2 is extruded out through the head unit K3 to the outside of the kneading machine K1, by the rotation of the screw K22 and screw K23.

The head unit K3 has an internal space K31 to which the kneading product K7 is transported from the processing unit K2, and an extrusion orifice K32 through which the kneading product K7 is extruded.

The temperature of the kneading product K7 in the internal space K31 (temperature in at least the vicinity of the extrusion orifice K32) is not particularly limited, but is preferably a temperature greater than or equal to the softening temperature of the resin material contained in the raw material K5. Then, the toner particles can be obtained in a state that the respective constituents are more uniformly mixed, and the differences in the properties (antistatic property, fixability, etc.) between individual toner particles can be made particularly small.

The specific temperature of the kneading product K7 in the internal space K31 (temperature in at least the vicinity of the extrusion orifice K32) is not particularly limited, but is preferably 80 to 150° C., and more preferably 90 to 140° C. When the temperature of the kneading product K7 in the internal space k31 has a value within the above-mentioned range, the kneading product K7 does not solidify inside the internal space K31 and can be easily extruded through the extrusion orifice K32.

In the illustrated configuration, the internal space K31 has a transverse cross-sectional area tapering portion K33, in which the transverse cross-sectional area tapers toward the direction of the extrusion orifice K32. The presence of such transverse cross-sectional area tapering portion K33 allows that the amount of extrusion of the kneading product K7 extruded from the extrusion orifice K32 is stabilized, and the cooling rate of the kneading product K7 in the cooling process that will be described later is stabilized. As a result, a toner prepared using this has small differences in the properties between individual toner particles, and attains excellent properties as a whole.

### Cooling Process

The kneading product K7 which has been extruded through the extrusion orifice K32 of the head unit K3 and is in a softened state, is cooled by a cooler K6 and solidifies.

The cooler K6 has rollers K61, K62, K63 and K64, and belts K65 and K66.

The belt K65 is wound around the roller K61 and the roller K62. Likewise, the belt K66 is wound around the roller K63 and the roller K64.

The rollers K61, K62, K63 and K64 rotate respectively in the directions indicated by symbols e, f, g and h in the drawing, around the axes of rotation K611, K621, K631 and K641. Thus, the kneading product K7 extruded through the extrusion orifice K32 in the kneading machine K1 is introduced between the belt K65 and the belt K66. The kneading product K7 introduced between the belt K65 and the belt K66 is cooled while being molded to have a plate shape with a virtually uniform thickness. The cooled kneading product K7 is discharged through a discharge portion K67. The belts K65 and K66 are cooled by, for example, methods of water cooling, air cooling and the like. When such a belt-type cooler is used, the time of contact between the kneading product extruded from the kneading machine and the cooling body (belt) can be lengthened, and thereby the cooling efficiency of the kneading product can be made particularly excellent.

However, during the kneading process, phase separation (particularly, macro-phase separation) or the like is sufficiently prevented because shear force is exerted to the raw material K5, but the kneading product K7 after the kneading process is no longer subject to shear force, and therefore, depending on the compositional materials, the kneading product may possibly undergo phase separation (macro-phase separation) or the like again, if left still for a long time. Thus, it is preferable to cool the kneading product obtained as described above, as fast as possible. Specifically, the cooling rate of the kneading product K7 (for example, cooling rate for the kneading product K7 to be cooled to about 60° C.) is preferably 3° C./sec or larger, and more preferably 5 to 100° C./sec. Also, the time required from the completion of the kneading process (time point at which no more shear force is exerted) to the completion of the cooling process (for example, time required to cool the temperature of the kneading product K7 to 60° C. or lower) is preferably 20 seconds or less, and more preferably 3 to 12 seconds.

In the present embodiment, a configuration of using a continuous twin screw kneading extruder as the kneading machine has been described, but the kneading machine that can be used in the kneading of raw material is not limited thereto. For the kneading of raw material, for example, various kneading machines such as a kneader, batch type triaxial rollers, continuous biaxial rollers, a wheel mixer, a blade type mixer, and the like can be used.

Also, in the illustrated configuration, a kneading machine configured to have two screws has been described, but the number of screw may be one, or three or more. The kneading apparatus may also have a disk (kneading disk) unit.

In the present embodiment, a configuration of using one kneading machine has been described, but kneading may be performed using two kneading machines as well. In this case, there may exist differences in the heating temperature for the raw material, speed of rotation of the screws, and the like between one kneading machine and the other kneading machine.

Furthermore, in the present embodiment, a configuration of using a belt type cooler has been described, but for example, a roller type (cooling roller type) cooler may also be used. Cooling of the kneading product extruded through the extrusion orifice K32 of the kneading machine is not restricted to the use of a cooler as discussed above, but may be performed by means of, for example, air cooling or the like.

### Pulverizing Process

Next, the kneading product K7 which has undergone the cooling process as described above is pulverized. By pulverizing the kneading product K7 as such, the aqueous emulsion that will be described later can be obtained relatively easily, in a state that finer dispersoid is dispersed. Consequently, for the finally obtained liquid developer, the size of the toner particles can be further reduced, and the liquid developer can be favorably used for high resolution image formation.

The method of pulverizing is not particularly limited, and can be performed by means of, for example, various pulverizing apparatuses and crushing apparatuses such as ball mill, vibrating mill, jet mill, pin mill and the like.

The pulverizing process may be carried out in a number of steps (for example, two steps of coarse pulverization process and fine pulverization process). Also, after such pulverizing process, if necessary, treatments such as sorting treatment and the like may be performed. For the sorting treatment, for example, a traditional air-drift type sorting machine or the like can be used.

As the raw material K5 is subjected to kneading as described above, the air contained in the raw material K5 can be effectively removed. In other words, the kneading product K7 obtained by kneading as described above virtually does not contain any air (air bubbles) therewithin. Thus, generation of deformed particles (hollow particle, incomplete particle, fused particle, etc.) during the process for removing aqueous dispersion medium as will be described later, can be effectively prevented. Consequently, for the finally obtained liquid developer, problems such as deteriorated transferability, cleanability and the like caused by deformed toner particles can be effectively prevented.

### Process for Preparing Aqueous Dispersion

Next, an aqueous dispersion in which a dispersoid composed of a toner material is dispersed in an aqueous dispersion medium composed of an aqueous liquid is prepared using the kneading product K7 as described above.

The method of preparing the aqueous dispersion may employ any method. For example, one in which the kneading product K7 is added and dispersed in an intact form in an aqueous liquid is acceptable; an aqueous emulsion prepared by dissolving the kneading product K7 in a solvent which can dissolve at least a portion of the kneading product, and then dispersing the resultant in an aqueous liquid, is also acceptable; and an aqueous suspension obtained by removing the solvent which constitutes the dispersoid of the emulsion, from the resulting aqueous emulsion, is also acceptable. Even if the aqueous dispersion is prepared by any arbitrary method, the aggregation of the toner material is appropriately prevented, and the images obtained from the finally produced liquid developer are clear and exhibit high resolution. In addition, with regard to the subject matter described in the above, the term “aqueous liquid” refers to a liquid containing at least water (H₂O), and preferably to a liquid mainly composed of water. The content of water contained in the aqueous liquid is preferably 50% by weight or greater, more preferably 80% by weight or greater, and even more preferably 90% by weight or greater. Also, the term “aqueous emulsion” means a dispersion in which a liquid-phase dispersoid (dispersed particles) is dispersed in an aqueous dispersion medium composed of an aqueous liquid, while the term “aqueous suspension” means a dispersion (including suspension colloid) in which a solid-phase (solid) dispersoid is dispersed in an aqueous dispersion medium composed of an aqueous liquid.

Even though the aqueous dispersion is produced using any arbitrary preparation method, the images obtained from the finally produced liquid developer are clear and exhibit high resolution. In particular, in the case of preparing an aqueous suspension as the aqueous dispersion of the kneading product K7, aggregation of the kneading product K7 is particularly suppressed. On the other hand, since the organic solvent contained in the dispersoid can be efficiently removed and recovered in the present process, the environmental stress can also be reduced. In the following discussion, an example of using an aqueous suspension 3 prepared from the kneading product K7 will be described.

### Process for Removing Aqueous Dispersion Medium

Next, dry microparticles which correspond to the dispersoid of the aqueous dispersion are obtained by removing the aqueous dispersion medium from the aqueous dispersion (process for removing aqueous dispersion medium). The dry microparticles thus obtained correspond to the toner particles of the liquid developer.

Removal of the aqueous dispersion medium may be performed by any method, but it is preferable to perform by intermittently discharging liquid droplets of the dispersion in which the dispersoid is dispersed in an aqueous dispersion medium (aqueous dispersion). Then, the removal of the aqueous dispersion medium can be more efficiently performed while effectively preventing aggregation of the dispersoid or the like, and thus the productivity for the liquid developer is improved. Also, if the removal of the aqueous dispersion medium is performed by intermittently discharging liquid droplets of the aqueous dispersion, upon preparation of the above-described aqueous suspension, even when some solvent remains behind, the residual solvent can be efficiently removed together with the aqueous dispersion medium.

In particular, according to the present embodiment, the removal of the aqueous dispersion medium is performed using the dry microparticle producing apparatus (toner particle producing apparatus) as shown in FIG. 2 and FIG. 3.

### Dry Microparticle Producing Apparatus

As shown in FIG. 2, the dry microparticle producing apparatus (toner particle producing apparatus) M1 has a head unit M2 which intermittently discharges the aqueous suspension (aqueous dispersion) 3 as described above in the form of liquid droplets 9; an aqueous suspension supplying unit (aqueous dispersion supplying unit) M4 which supplies the aqueous suspension 3 to the head unit M2; a dispersion medium removing unit M3 which removes the dispersion medium 32 while transporting the aqueous suspension 3 (liquid droplets 9) in the form of liquid droplets (microparticulate form) discharged from the head unit M2, to produce dry microparticles (toner particles) 4; and a recovering unit M5 which recovers the produced dry microparticles (toner particles) 4.

The aqueous suspension supplying unit M4 may have a function of supplying the aqueous suspension 3 to the head unit M2, or alternatively, may have an agitator M41 which agitates the aqueous suspension 3 as shown in the drawing. Then, for example, even if the dispersoid 31 is difficult to be dispersed in the dispersion medium (aqueous dispersion medium) 32, the aqueous suspension 3 can be supplied to the head unit M2 in a state that the dispersoid 31 is sufficiently uniformly dispersed.

The head unit M2 has a function of discharging the aqueous suspension 3 in the form of fine liquid droplets (microparticles) 9.

The head unit M2 has a dispersion storing unit M21, a piezoelectric element M22, and a discharging unit M23.

The dispersion storing unit M21 stores the aqueous suspension 3.

The aqueous suspension 3 stored in the dispersion storing unit M21 is discharged from the discharging unit M23 to the dispersion medium removing unit M3, in the form of liquid droplets 9, by the pressure pulse (piezoelectric pulse) of the piezoelectric element M22.

The shape of the discharging unit M23 is not particularly limited, but an approximately circular shape is preferred. Then, the sphericity of the discharged aqueous suspension 3 or of the dry microparticles 4 formed in the dispersion medium removing unit M3 can be increased.

In the case where the discharging unit M23 has an approximately circular shape, the diameter (nozzle diameter) is, for example, preferably 5 to 500 μm, and more preferably 10 to 200 μm. If the diameter of the discharging unit M23 is less than the lower limit, loading is likely to occur, and the size of the discharged liquid droplets 9 may become irregular. On the other hand, if the diameter of the discharging unit M23 exceeds the upper limit, there is a possibility that depending on the force balance between the negative pressure of the dispersion storing unit M21 and the surface tension at the nozzle, the discharged aqueous suspension 3 (liquid droplets 9) may entrain air bubbles.

Furthermore, it is preferable that the vicinity of the discharging unit M23 of the head unit M2 (in particular, inside of the orifice of the discharging unit M23, or the plane on the side where the discharging unit M23 of the head unit M2 is installed (the lower plane in the drawing)) is liquid repellent (water repellency) with respect to the aqueous suspension 3. Then, adherence of the aqueous suspension 3 to the vicinity of the discharging unit can be effectively prevented. As a result, so-called a liquid runout state or discharge defect of the aqueous suspension 3 can be effectively prevented. Also, as the adherence of the aqueous suspension 3 to the vicinity of the discharging unit is effectively prevented, the stability of the shape of the discharged liquid droplets is improved (differences in the shape and size between individual liquid droplets being reduced), and the irregularity in the shape and size of the finally obtained toner particles is also reduced.

The material having such liquid repellency may be exemplified by fluorinated resins such as polytetrafluoroethylene (PTFE) and the like, silicone-based materials, or the like.

As illustrated in FIG. 3, the piezoelectric element M22 consists of a lower electrode (first electrode) M221, a piezoelectric body M222, and an upper electrode (second electrode) M223, which are laminated in this order. In other words, the piezoelectric element M22 has a configuration in which the piezoelectric body M222 is interposed between the upper electrode M223 and the lower electrode M221.

This piezoelectric element M22 functions as a source of vibration, and a vibrating plate M24 has a function of vibrating along with the vibration of the piezoelectric element (source of vibration) M22 to instantaneously increasing the internal pressure of the dispersion storing unit M21.

In the head unit M2, there is no deformation in the piezoelectric body M222 in a situation that a predetermined discharging signal is not inputted from a piezoelectric element driving circuit (not shown), that is, in a situation that no voltage is applied between the lower electrode M221 and the upper electrode M223 of the piezoelectric element M22. Thus, there is no deformation in the vibrating plate M24, and there is no change in the volume of the dispersion storing unit M21. Accordingly, the aqueous suspension 3 is not discharged from the discharging unit M23.

On the other hand, in a situation that a predetermined discharging signal has been inputted from the piezoelectric element driving circuit, that is, in a situation that a predetermined voltage is applied between the lower electrode M221 and the upper electrode M223 of the piezoelectric element M22, the piezoelectric body M222 undergoes deformation. Then, the vibrating plate M24 greatly bends (bends downward in FIG. 3), and there occurs a decrease (change) in the volume of the dispersion storing unit M21. At this time, the pressure inside the dispersion storing unit M21 is instantaneously increased, and the aqueous suspension 3 is discharged in a particulate form from the discharging unit M23.

When one term of discharge of the aqueous suspension 3 is completed, the piezoelectric element driving circuit stops the application of voltage between the lower electrode M221 and the upper electrode M223. Then, the piezoelectric element M22 returns to almost its original shape, and the volume of the dispersion storing unit M21 is increased. At this time, the aqueous suspension 3 is subject to a pressure in the direction from the aqueous suspension supplying unit M4 to the discharging unit M23 (pressure in the positive direction). Because of this, air is prevented from intruding into the dispersion storing unit M21 from the discharging unit M23, and the aqueous suspension 3 is supplied in an amount appropriate for the amount of discharge of the aqueous suspension 3, from the aqueous suspension supplying unit M4 to the dispersion storing unit M21.

As the application of voltage as described above is periodically implemented, the piezoelectric element M22 vibrates, and the aqueous suspension 3 in the particulate form is repeatedly discharged.

As such, when the discharge (jetting) of the aqueous suspension 3 is performed by means of pressure pulse induced by vibration of the piezoelectric body M222, the aqueous suspension 3 can be intermittently discharged drop by drop, and the shape of the liquid droplets 9 of the discharged aqueous suspension 3 is stabilized. As a result, the differences in the shape and size between individual toner particles can be made particularly small, and at the same time, increasing the sphericity (a shape approximating to a geometrically perfect sphere) of the produced toner particles can be relatively easily done.

Also, by using the vibration of the piezoelectric body in the discharge of dispersion, the dispersion can be discharged more certainly at a predetermined interval. Thus, collision and aggregation between the discharged liquid droplets 9 can be effectively prevented, and formation of abnormally shaped dry microparticles 4 can be more effectively prevented.

The initial speed of the aqueous suspension 3 (liquid droplets 9) discharged from the head unit M2 to the dispersion medium removing unit M3 is, for example, preferably 0.1 to 10 m/sec, and more preferably 2 to 8 m/sec. If the initial speed of the aqueous suspension 3 is less than the lower limit, the productivity for the toner is decreased. On the other hand, if the initial speed of the aqueous suspension 3 exceeds the upper limit, the sphericity of the finally obtained toner particles tends to be decreased.

The viscosity of the aqueous suspension 3 discharged from the head unit M2 is not particularly limited, but for example, it is preferably 0.5 to 200 [mPa·s], and more preferably 1 to 25 [mPa·s]. If the viscosity of the aqueous suspension 3 is less than the lower limit, it is difficult to satisfactorily control the size of the discharged aqueous suspension 3, and the finally obtained toner particles may become irregular. On the other hand, if the viscosity of the aqueous suspension 3 exceeds the upper limit, the diameter of the particles formed is increased, and thus the rate of discharge of the aqueous suspension 3 is reduced, while the amount of energy required to discharge the aqueous suspension 3 tends to increase. Also, in the case where the viscosity of the aqueous suspension 3 is particularly large, the aqueous suspension 3 cannot be discharged in the form of liquid droplets.

The aqueous suspension 3 discharged from the head unit M2 may be cooled in advance. By cooling the aqueous suspension 3 as such, for example, involuntary evaporation (volatilization) of the dispersion medium 32 from the aqueous suspension 3 in the vicinity of the discharging unit M23 can be effectively prevented. Consequently, changes in the amount discharged of the aqueous suspension 3 that are caused by the decrease in the orifice area of the discharging unit over time are effectively prevented, and thus a toner having particularly small differences in the size and shape between individual particles can be obtained.

The amount discharged in one droplet of the aqueous suspension 3 may slightly vary depending on the proportion of the dispersoid 31 contained in the aqueous suspension 3 or the like, but is preferably 0.05 to 500 pl, and more preferably 0.5 to 50 pl. When the amount discharged in one droplet of the aqueous suspension 3 is set to a value within such range, the formed dry microparticles 4 can have an appropriate particle size.

The average particle size of the liquid droplets 9 discharged from the head unit M2 may slightly vary depending on the proportion of the dispersoid 31 contained in the aqueous suspension 3 or the like, but is preferably 1.0 to 100 μm, and more preferably 5 to 50 μm. When the particle size of the liquid droplet 9 is set to a value within such range, the formed dry microparticles 4 can have an appropriate particle size.

The number of vibration of the piezoelectric element M22 (frequency of piezoelectric pulse) is not particularly limited, but is preferably 1 kHz to 500 MHz, and more preferably 5 kHz to 200 MHz. If the number of vibration of the piezoelectric element M22 is less than the lower limit, the productivity for the toner is decreased. On the other hand, if the number of vibration of the piezoelectric element M22 exceeds the upper limit, the discharge of the particulate aqueous suspension 3 cannot be traced, and the size of one droplet of the aqueous suspension 3 becomes irregular, consequently there being a possibility that the size of the formed dry microparticles (toner particles) 4 becomes irregular.

The dry microparticle producing apparatus M1 having the illustrated configuration has a plurality of the head units M2. Then, from each of these head units M2, the particulate aqueous suspension 3 (liquid droplets 9) is discharged to the dispersion medium removing unit M3.

Each of the head units M2 may discharge the aqueous suspension 3 (liquid droplets 9) almost simultaneously, but it is preferable that the timing for discharge of the aqueous suspension 3 (liquid droplets 9) is controlled to be different in at least two adjacent head units. Then, involuntary aggregation occurring when the liquid droplets 9 collide with each other before the dry microparticles 4 are formed from the liquid droplets 9 discharged from the adjacent head units M2, can be more effectively prevented.

Furthermore, as shown in FIG. 2, the dry microparticle producing apparatus M1 has a gas flow feeder M10, so that the gas supplied from this gas flow feeder M10 is jetted out at an almost uniform pressure through each of gas jet orifices M7 installed between one head unit M2 and another head unit M2, via a duct M101. Then, the intervals of the liquid droplets 9 discharged intermittently from the discharging unit M23 are maintained to form the dry microparticles 4 while effectively preventing collision of the liquid droplets 9. Consequently, the differences in the size and shape of the formed dry microparticles 4 can be further reduced.

It is also possible to form a gas stream virtually flowing in one direction (downward in the drawing) in the dispersion medium removing unit M3, by jetting out the gas supplied from the gas flow feeder M10 through the gas jet orifices M7. When such gas stream is formed, the dry microparticles 4 formed inside the dispersion medium removing unit M3 can be transported more efficiently. Then, the recovery efficiency for the dry microparticles 4 is improved, and the productivity for the liquid developer is improved.

When gas is jetted out through the gas jet orifices M7, a gas flow curtain is formed between the liquid droplets 9 discharged from each of the head units M2, and thus, for example, collision and aggregation between the liquid droplets discharged from adjacent head units can be more effectively prevented.

The gas flow feeder M10 is equipped with a heat exchanger M11. Therefore, the temperature of the gas jetted out from the gas jet orifices M7 can be set to a desired value, and thus the dispersion medium 32 can be efficiently removed from the particulate aqueous suspension 3 discharged to the dispersion medium removing unit M3.

Furthermore, by having such gas flow feeder M10, the rate of removing the dispersion medium 32 from the aqueous suspension 3 discharged from the discharging unit M23, and the like can be easily controlled through adjustment of the supply amount of the gas stream, or the like.

The temperature of the gas jetted out from the gas jet orifices M7 may vary depending on the compositions of the dispersoid 31 and dispersion medium 32 contained in the aqueous suspension 3, and the like, but typically, the temperature is preferably 0 to 70° C., and more preferably 15 to 60° C. When the temperature of the gas jetted out from the gas jet orifices M7 has a value within such range, the dispersion medium 32 contained in the liquid droplets 9 can be efficiently removed, while maintaining the uniformity in shape and stability of the resulting dry microparticles 4 sufficiently high.

The humidity of the gas jetted out from the gas jet orifices M7 is, for example, preferably 50% RH or less, and more preferably 30% RH or less. If the humidity of the gas jetted out from the gas jet orifices M7 is 50% RH or less, it is possible to efficiently remove the dispersion medium 32 contained in the aqueous suspension 3 in the dispersion medium removing unit M3 that will be described later, and thus the productivity for the dry microparticles 4 is further improved.

The dispersion medium removing unit M3 consists of a cylindrically shaped housing M31. For the purpose of maintaining the temperature inside the dispersion medium removing unit M3 within a predetermined range, for example, a heat source or cooling source may be installed inside or outside the housing M31, or alternatively, the housing M31 may be designed as a jacket in which a flow channel for a heating medium or a cooling medium is formed.

In the configuration shown in the drawing, the pressure inside the housing M31 is configured to be adjusted by a pressure adjuster M12. As such, by adjusting the pressure inside the housing M31, the dry microparticles 4 can be formed more efficiently, and consequently, the productivity for the liquid developer is improved. Additionally, in the illustrated configuration, the pressure adjuster M12 is connected to the housing M31 at a connecting tube M121. Also, in the vicinity of the terminal connecting the connecting tube M121 and the housing M31, a diameter expanding portion M122 in which the internal diameter is expanded is formed, and a filter M123 for preventing suction of the dry microparticles 4 or the like is also installed.

The pressure inside the housing M31 is not particularly limited, but is preferably 150 kPa or less, more preferably 100 to 120 kPa, and even more preferably 100 to 110 kPa. When the pressure inside the housing M31 has a value within the above range, for example, sudden removal of the dispersion medium 32 from the liquid droplets 9 (boiling phenomenon) and the like can be effectively prevented, and thus the dry microparticles 4 can be more efficiently produced, while sufficiently preventing generation of deformed dry microparticles 4, or the like. In addition, the pressure inside the housing M31 may be almost uniform at different sites, or may be different at different sites.

The housing M31 is also connected with a voltage applicator M8 to apply a voltage. When a voltage of the same polarity as that of the dry microparticles 4 (liquid droplets 9) is applied to the inner wall of the housing M31 by the voltage applicator M8, the following effects are obtained.

The dry microparticles 4 and the like are usually charged positively or negatively. Therefore, when there is a charged object having a charge different from that of the dry microparticles 4, there occurs a phenomenon that the dry microparticles 4 are electrostatically attracted to adhere to the charged object. On the other hand, when there is a charged object having the same polarity as that of the dry microparticles 4, the charged object and the dry microparticles 4 repel each other, and the phenomenon that the dry microparticles 4 are adhered to the surface of the charged object can be effectively prevented. Accordingly, as a voltage of the same polarity as that of the particulate dry microparticles 4 is applied to the inside of the housing M31, adhesion of the dry microparticles 4 to the inner wall of the housing M31 can be effectively prevented. Then, generation of deformed dry microparticles 4 can be more effectively prevented, and at the same time, the recovery efficiency for the dry microparticles 4 is also improved.

The housing M31 has a diameter contracting portion M311 where the inner diameter is decreased to the downward direction in FIG. 2, in the vicinity of the recovering unit M5. With such diameter contracting portion M311 being formed, the dry microparticles 4 can be efficiently recovered.

The dry microparticles 4 formed as described above are recovered at the recovering unit M5.

The dry microparticles 4 obtained as described above usually have a size and a shape corresponding to those of each dispersoid 31. Thus, the finally obtained liquid developer is made to contain toner particles which have a relatively small particle diameter, a high degree of circularity (sphericity), and small differences in the shape and size between individual particles.

Furthermore, the dry microparticles 4 obtained as described above may be a particulate object which is obtained by removing the dispersion medium 32 of the aqueous suspension 3, and for example, may have some of the dispersion medium remaining therewithin.

The obtained dry microparticles 4 may be supplied as received to the dispersing process that will be described later, or may be subjected to various treatments such as heat treatment and the like. Then, the mechanical strength (shape stability) of the dry microparticles (toner particles) can be made more excellent, or the water content in the dry microparticles can be decreased. Furthermore, the water content can be decreased likewise, also by subjecting the obtained dry microparticles 4 to a treatment such as aeration or the like, or by leaving the dry microparticles 4 in an atmosphere of reduced pressure, or the like.

The dry microparticles 4 as described above may be subjected to various treatments such as sorting treatment, surface treatment and the like as necessary.

### Preparation of Insulating Liquid

The insulating liquid as described in the above can be prepared, for example, as follows. In addition, in the following description, the preparation of an insulating liquid containing an encapsulated oxidative polymerization accelerator will be described.

Encapsulation of the oxidative polymerization accelerator can be performed, for example, as follows.

First, the oxidative polymerization accelerator is provided.

Next, the oxidative polymerization accelerator is dissolved in a solvent.

Such solvent is not particularly limited as long as it dissolves the oxidative polymerization accelerator, and examples thereof include inorganic solvents such as carbon disulfide, carbon tetrachloride and the like; organic solvents including ketone-based solvents such as methyl ethyl ketone (MEK), methyl isopropyl ketone (MIPK), 2-heptanone and the like; alcohol-based solvents such as pentanol, n-hexanol, 1-octanol, 2-octanol and the like; ether-based solvents such as diethyl ether, anisole and the like; aliphatic hydrocarbon-based solvents such as hexane, pentane, heptane, cyclohexane, octane, isoprene and the like; aromatic hydrocarbon-based solvents such as toluene, xylene, benzene, ethylbenzene, naphthalene and the like; aromatic heterocyclic compound-based solvents such as furan, thiophene and the like; halogenated compound-based solvents such as chloroform and the like; ester-based solvents such as ethyl acetate, isopropyl acetate, isobutyl acetate, ethyl acrylate and the like; nitrile-based solvents such as acrylonitrile and the like; nitro-based solvents such as nitromethane, nitroethane and the like; and the like. One or a mixture of two or more species selected from these can be used.

Next, a porous body such as hydrophilic silica, hydrophilic alumina, hydrophilic titanium oxide or the like is added to the resulting solution to allow the porous body to adsorb the solution.

Next, the porous body having the solution adsorbed is mixed with a polyether such as polyethylene glycol, polypropylene glycol or the like while heating.

The mixing ratio by weight of the porous body to the polyether is preferably about 1:0.5 to 1:10, and more preferably about 1:1 to 1:5.

The temperature upon mixing the porous body and the polyether is preferably 5 to 80° C., and more preferably 20 to 80° C.

Next, the resulting mixture is sufficiently dispersed in a petroleum-based hydrocarbon and cooled to deposit the polyether on the surface of the porous body. Then, a film of polyether is formed on the surface of the porous body.

Thereafter, by removing the petroleum-based hydrocarbon through filtration, an encapsulated oxidative polymerization accelerator is obtained.

The oxidative polymerization accelerator thus encapsulated has higher dispersibility in the insulating liquid.

When the encapsulated oxidative polymerization accelerator thus obtained is dispersed in a liquid containing a fatty acid monoester and a fatty acid triglyceride, the insulating liquid is obtained.

Additionally, in the case of preparing a liquid developer containing an antioxidant, the antioxidant may be allowed to be contained in the liquid containing a fatty acid monoester and a fatty acid triglyceride, for example, prior to dispersing the oxidative polymerization accelerator, or may be added to the liquid containing a fatty acid monoester and a fatty acid triglyceride after dispersing the oxidative polymerization accelerator, or may be added to the liquid containing a fatty acid monoester and a fatty acid triglyceride during dispersing the oxidative polymerization accelerator.

### Dispersing Process

Next, the dry microparticles 4 obtained as described above are dispersed in the insulating liquid as described above (dispersing process). Then, a liquid developer in which the toner particles as the dry microparticles 4 are dispersed in an insulating liquid (carrier liquid) is obtained.

Dispersion of the dry microparticles 4 in the insulating liquid may be performed by any method, but it is preferable to perform by adding the dry microparticles 4 to the insulating liquid which has been agitated. Then, involuntary aggregation of the dry microparticles 4 during the preparation of the liquid developer is prevented, and for the resulting liquid developer, a well dispersed state of the toner particles can be stably maintained for a long time. Also, when the final composition of the liquid developer is attained, the liquid developer may be prepared by any method in any order. For example, the liquid developer may be prepared by mixing a portion of the insulating liquid and the dry microparticles 4, and then mixing this mixture with the remaining of the insulating liquid. Here, the composition of the portion of the liquid developer that is mixed with the dry microparticles 4 at the beginning, and the composition of the remaining portion of the liquid developer that is added later may be the same, or may be different. As an example in which the components of the liquid developer that is initially added (component 1) are different from the components of the liquid developer that are added later (component 2), the following may be described.

First, a method of mixing a fatty acid monoester and the dry microparticles 4, and then mixing the other constituents of the insulating liquid, including a fatty acid triglyceride, may be mentioned. In this case, if the fatty acid monoester is allowed to actively penetrate into the inside of the dry microparticles 4 and to undergo an oxidative polymerization reaction, the intensity of fixation of toner particles to a recording medium can be made more excellent by the resin material constituting the toner particles, and the cured insulating liquid. With regard to such effect, even in the case of using a mixture of a fatty acid monoester and a fatty acid triglyceride, in which mixture the content ratio of the fatty acid monoester is larger, instead of the fatty acid monoester as the component to be mixed initially, the same effect as that obtained by using a fatty acid monoester as the component 1 is obtained. Also, in contrast to the above-described method, a method of mixing the fatty acid triglyceride and the dry microparticles 4, and then mixing the other constituents of the insulating liquid, including the fatty acid monoester, may be mentioned. In this case, penetration of the fatty acid triglyceride into the inside of the dry microparticles 4 is suppressed, thus covering their surface, and then the particle size of the dry microparticles 4 can be maintained uniform. Thus, the images obtained by a liquid developing apparatus can be made clearer. With regard to this effect, even in the case of using a mixture of a fatty acid triglyceride and a fatty acid monoester, in which the content ratio of the fatty acid triglyceride is larger, instead of the fatty acid triglyceride as the component mixed initially, the same effect as that of using a fatty acid triglyceride as the component 1 is obtained. Furthermore, the prepared liquid developer may be used as received, but may also be subjected to a deforming treatment by means of a defoaming machine. Then, the air entrained into the liquid developer during an agitating process can be efficiently removed, and thus oxidation can be more effectively prevented, rather than suppressing oxidation reactions only with antioxidants. Also, an impact distributing treatment by an impact distributor may be performed on the resulting liquid developer. Then, the dispersibility of the toner particles in the liquid developer can be made more excellent, and a well dispersed state of the toner particles can be stably maintained for a long time.

The liquid developer thus obtained has small differences in the shape and size of the toner particles. Therefore, such liquid developer allows easy migration of the toner particles within the insulating liquid (within the liquid developer), and is also advantageous in high speed developing. Also, the differences in the shape and size of the toner particles are small, and since an insulating liquid as described above is used, the dispersibility of the toner particles is excellent, thereby effectively preventing settlement or floating of the toner particles within the liquid developer. Therefore, such liquid developer has particularly excellent storage properties.

Moreover, in the above description, discussion was provided on the case where the insulating liquid contained a fatty acid monoester and a fatty acid triglyceride. However, the method of preparation according to the present embodiment is not limited thereto, but may also be applied to the case where the insulating liquid contains a fatty acid monoester and a silicone oil and/or an aliphatic hydrocarbon.

### Second Embodiment of Method of Preparing Liquid Developer

Next, the second embodiment of the method of preparing the liquid developer of the invention will be discussed. In addition, in the following description, an example of the insulating liquid containing a fatty acid monoester and a silicone oil and/or an aliphatic hydrocarbon will be described.

The insulating liquid can be prepared by, for example, mixing an aliphatic hydrocarbon-based liquid and/or a silicone oil as described above and a fatty acid monoester. The liquid developer can be prepared by mixing such an insulating liquid and toner particles, but the following method may also be used in the preparation.

The method of preparing a liquid developer according to the present embodiment comprises a process for associated particle formation, in which associated particles are obtained by allowing resin microparticles mainly composed of a resin material to associate, and a process for obtaining toner particles by disintegrating the associated particles in the insulating liquid.

### Preparation of Associated Particles

First, an exemplary method of preparing associated particles in which resin microparticles mainly composed of a resin material are in an associated state will be described.

The associated particles may be prepared by any method, but according to the present embodiment, the associated particles are obtained by obtaining an aqueous dispersion in which a dispersoid (microparticles) mainly composed of a resin material (toner material) is dispersed in an aqueous dispersion medium composed of an aqueous liquid, and allowing the dispersoid in the aqueous emulsion to associate.

### Preparation of Aqueous Dispersion

Hereinafter, the preparation of an aqueous dispersion will be described.

The aqueous dispersion may be prepared by any method, but according to the present embodiment, first, an aqueous emulsion in which a dispersoid (liquid-phase dispersoid) containing the toner material is dispersed is obtained by providing a toner material solution having the above-described toner material dissolved in a solvent, and mixing the toner material solution with an aqueous dispersion medium composed of an aqueous liquid. Subsequently, at least a portion of the solvent contained in the aqueous emulsion is removed to yield the aqueous dispersion.

The aqueous emulsion can be prepared, for example, as follows (process for preparing aqueous emulsion).

First, an aqueous dispersion medium is provided.

The aqueous dispersion medium is composed of an aqueous liquid.

According to embodiments of the invention, the term “aqueous liquid” means a liquid composed of water and/or a liquid having excellent compatibility with water (for example, a liquid having a solubility of 30 g or more in 100 g of water at 25° C.). Although the aqueous liquid is composed of water and/or a liquid having excellent compatibility with water as such, the aqueous liquid is preferably one composed mainly of water, and more preferably one having a water content of 70% by weight or greater, and even more preferably one having a water content of 90% by weight or greater. By using such a liquid, for example, the dispersibility of the dispersoid in the aqueous dispersion medium can be increased, and it is possible to have a dispersoid which has a relatively smaller particle size and small differences in the size of particles, in the aqueous emulsion. As a result, the toner particles in finally obtained liquid developer have small differences in the size and shape of the particles, and have a large degree of circularity.

Examples of the aqueous liquid include water, alcohol-based solvents, ether-based solvents, aromatic heterocyclic compound-based solvents, amide-based solvents, nitrile-based solvents, aldehyde-based solvents, and the like.

The aqueous dispersion medium may contain an emulsifying dispersant, if necessary. When an emulsifying dispersant is added, aqueous emulsions can be prepared more easily.

The emulsifying dispersant is not particularly limited, and for example, known emulsifying dispersants can be used.

Meanwhile, the toner material as described above is dissolved in a solvent to prepare a toner material solution.

The solvent may be of any type as long as it dissolves at least a part of the toner material, but it is preferable to use one having a lower boiling point than the aqueous liquid mentioned above. Then, the solvent can be easily removed.

It is also preferable that the solvent has low compatibility with the aqueous dispersion medium (aqueous liquid) (for example, one having a solubility of 30 g or less in 100 g of the aqueous dispersion medium at 25° C.). Then, the toner material can be microdispersed in a stable state in the aqueous emulsion.

The composition of the solvent can be appropriately selected in accordance with, for example, the compositions of the resin and colorant as described above, the composition of the aqueous dispersion medium, or the like.

Such solvent is not particularly limited, but examples thereof include ketone-based solvents such as methyl ethyl ketone and the like, aromatic hydrocarbon-based solvents such as toluene and the like, ester-based solvents such as ethyl acetate and the like, and the like.

Furthermore, for the preparation of the toner material solution, for example, a kneading product obtained by kneading materials for toner, such as a resin material, a colorant and the like may also be used. When such a kneading product is used, even in the case where the compositional materials for toner include components that are difficult to be dispersed or compatibilized with each other, those components can be sufficiently compatibilized or microdispersed in the kneading product obtained by subjecting the components to kneading. In particular, in the case where a pigment (colorant) having relatively low dispersibility in a solvent as described above is used, if the pigment is treated with kneading in advance before being dispersed in the solvent, the peripheries of the pigment particles are effectively coated with a resin component or the like, thereby the dispersibility of the pigment in the solvent being improved (particularly, microdispersion in the solvent is made possible), and the chromogenicity of the finally obtained toner being good. From this, even in the case where a component having poor dispersibility in the aqueous dispersion medium of the aqueous emulsion described above, or a component having poor solubility in the solvent contained in the dispersion medium of the aqueous emulsion is included in the toner constituent materials, the dispersibility of the dispersoid in the aqueous emulsion can be made particularly excellent.

Next, as the toner material solution is slowly added dropwise into the aqueous dispersion medium in an agitated state, an aqueous emulsion in which the dispersoid containing the toner material is dispersed in an aqueous dispersion medium is obtained. In addition, when dropwise addition of the toner material solution is performed, the aqueous dispersion medium and/or toner material solution may be preliminarily heated.

Thereafter, at least a part of the solvent contained in the dispersoid is removed by heating the resulting aqueous emulsion or leaving the aqueous emulsion in an atmosphere of reduced pressure, thus to obtain an aqueous dispersion in which the dispersoid (microparticles) composed of the toner material is dispersed.

The content of the dispersoid in the aqueous dispersion is not particularly limited, but is preferably 5 to 55% by weight, and more preferably 10 to 50% by weight. Then, involuntary aggregation of the dispersoid in the aqueous dispersion can be more assuredly prevented, and particularly excellent productivity for the toner particles (liquid developer) can be obtained.

The average particle size of the dispersoid in the aqueous dispersion is not particularly limited, but is preferably 0.01 to 3 μm, and more preferably 0.1 to 2 μm. Then, the size of the finally obtained toner particles can be optimized. In addition, the term “average particle size” as used in the present specification is intended to mean the average particle size based on volume.

### Process for Associated Particle Formation

Next, an electrolyte is added to the aqueous dispersion thus obtained to allow the dispersoid to associate to form associated particles (process for associated particle formation).

Examples of the electrolyte to be added include acidic substances such as hydrochloric acid, sulfuric acid, phosphoric acid, acetic acid, oxalic acid and the like; organic and inorganic water-soluble salts such as sodium sulfate, ammonium sulfate, potassium sulfate, magnesium sulfate, sodium phosphate, sodium dihydrogen phosphate, sodium chloride, potassium chloride, ammonium chloride, calcium chloride, sodium acetate and the like; and the like. Among these, one or a combination of two or more species can be used. Among them, a sulfuric acid salt of a monovalent cation, such as sodium sulfate, ammonium sulfate or the like can be favorably used in inducing uniform association.

Moreover, before adding the electrolyte or the like, an inorganic dispersion stabilizer such as hydroxyapatite or the like, or an ionic or nonionic surfactant may be added as a dispersion stabilizer. When an electrolyte is added in the presence of a dispersion stabilizer (emulsifier), non-uniform association can be prevented.

Examples of such dispersion stabilizer include nonionic surfactants such as polyoxyethylene nonyl phenyl ether, polyoxyethylene octyl phenyl ether, polyoxyethylene dodecyl phenyl ether, polyoxyethylene alkyl ether, polyoxyethylene fatty acid ester, sorbitan fatty acid ester, polyoxyethylene sorbitan fatty acid ester, various Pluronics, and the like; anionic surfactants of alkylsulfuric acid ester salt type; cationic surfactants of quaternary ammonium salt type; and the like. Among them, the anionic and nonionic surfactants are effective in dispersion stability even if a small amount is added, and thus can be favorably used. The clouding point of the nonionic surfactant is preferably 40° C. or higher.

The amount of the electrolyte to be added is preferably 0.5 to 15 parts by weight, more preferably 1 to 12 parts by weight, and even more preferably 1 to 10 parts by weight, relative to 100 parts by weight of the solid components in the aqueous dispersion. If the amount of added electrolyte is less than the lower limit, association of the dispersoid may not sufficiently occur. If the amount of added electrolyte exceeds the upper limit, association of the dispersoid occurs non-uniformly so that coarse large particles may be possibly generated, and there is a possibility that differences may occur in the size of the finally obtained toner particles.

Then, after the association, filtration, washing, drying and the like are performed to yield the associated particles.

The average particle size of the resulting associated particles is preferably 0.1 to 7 μm, and more preferably 0.5 to 3 μm. Then, an appropriate particle size can be obtained for the finally obtained toner particles.

### Disintegrating Process

Next, the associated particles thus obtained are disintegrated in the insulating liquid containing a fatty acid monoester and a fatty acid aliphatic hydrocarbon-based liquid and/or a silicone oil (disintegrating process). Thus, a liquid developer having toner particles dispersed in an insulating liquid is obtained.

With such method, the resulting toner particles attain irregularities derived from microparticles (dispersoid) on the surface, and thus the fatty acid monoester can be certainly maintained in these irregularities.

Furthermore, since the particles are disintegrated in the insulating liquid, generation of toner particles which have been coarsened by aggregation or the like can be prevented.

According to the present embodiment, since toner particles are obtained by disintegrating associated particles, generation of fine powder (particles extremely smaller than the particles of the desired size) can be effectively prevented, as compared to the pulverization method or wet pulverization method of the related art. As a result, deterioration of the antistatic property of the liquid developer due to fine powder can be effectively prevented.

Since the insulating liquid has a relatively low viscosity, the insulating liquid can easily penetrate between the microparticles (dispersoid) constituting the associated particles, and the insulating liquid can favorably disintegrate the associated particles.

Disintegration may also be carried out using a portion of the insulating liquid. In this case, after the disintegration, the same liquid as the liquid used in the disintegration may be added as the insulating liquid, or alternatively, after the disintegration, a liquid different from the liquid used in the disintegration may be added as the insulating liquid. In the latter case, the properties such as viscosity and the like of the finally obtained liquid developer can be easily adjusted.

Also, in the above description, discussion was made on the case where the insulating liquid contained a fatty acid monoester and a silicone oil and/or an aliphatic hydrocarbon. But, the method of preparation is not limited thereto, and may also be applied to the case where the insulating liquid contains a fatty acid monoester and a fatty acid triglyceride.

Next, a preferred embodiment of the image forming device to which the liquid developer according to embodiments of the invention as described is applied, will be described.

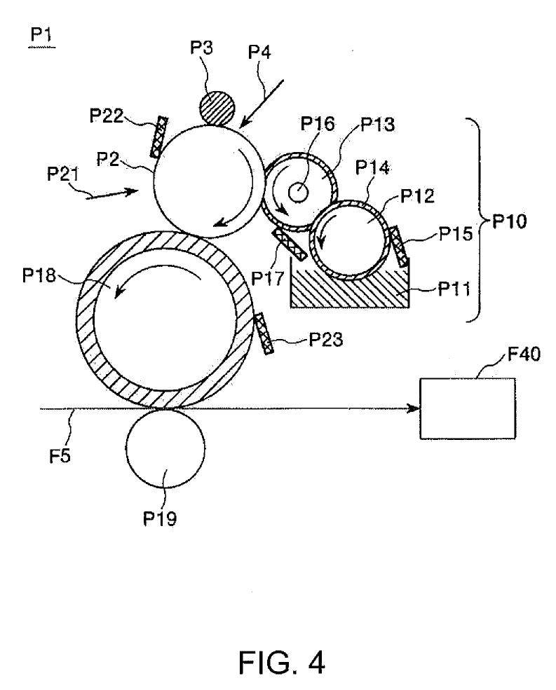

FIG. 4 is a diagram illustrating an exemplary contact type image forming device to which the liquid developer according to embodiments of the invention is applied.

The image forming device P1 has a developer vessel (liquid developer storing unit) P11 which stores a liquid developer; a cylindrical photosensitizer (developing unit) P2 which develops images (toner images); a developing machine P10 which supplies the liquid developer from the developer vessel P11 to the photosensitizer P2; an intermediate transferring roller (transferring unit) P18 which transfers an image developed on a recording medium using the photosensitizer P2; and a fixing apparatus (fixing unit) F40 to be described later.

The photosensitizer P2 is coated on the surface with a material such as amorphous silicon or the like. Then, deterioration of the member caused by the insulating liquid in the liquid developer can be suppressed to the minimum, and thus the life span of the photosensitizer P2 can be further lengthened, while accuracy in developing on the recording medium can be maintained high for a longer time.

This photosensitizer P2 is uniformly charged on the surface by a electric charger P3, and then exposure P4 corresponding to the information to be recorded is performed by means of a laser diode or the like, thereby an electrostatic latent image being formed.

The developing machine P10 has a coating roller P12 and a developing roller P13, which have their parts immersed in the developer vessel P11.

The coating roller P12 is, for example, a gravure roller made of stainless steel, brass or the like. With this, deterioration of the member caused by the insulating liquid in the liquid developer can be suppressed to the minimum, and thus the life span of the coating roller P12 can be further lengthened. Also, the accuracy of developing on the recording medium can be maintained high for a longer time.

The coating roller P12 rotates facing the developing roller P13.

The coating roller P12 also has a liquid developer coating layer P14 formed on the surface, and the thickness is maintained constant by a metering blade P15.

The liquid developer is transferred from the coating roller P12 to the developing roller P13.

The developing roller P13 consists of a low-hardness silicone rubber layer on a roller core P16 made of metal such as stainless steel or the like, and a fluororesin layer composed of electroconductive PFA (polytetrafluoroethylene-perfluorovinyl ether copolymer) or the like is formed on the outermost layer. When the developing roller has a layer composed of such material on the outermost layer, deterioration of the member caused by the insulating liquid in the liquid developer can be suppressed to the minimum, and thus the life span of the developing roller P13 can be further lengthened. Also, the accuracy of developing on the recording medium can be maintained high for a longer time.

The developing roller P13 rotates at the same speed as that of the photosensitizer P2 to transfer the liquid developer to a latent image portion.

The liquid developer remaining on the developing roller P13 after the transfer to the photosensitizer P2 is removed by a developing roller cleaning blade P17 and recovered into the developer vessel P11.

Also, after the transfer of a toner image from the photosensitizer P2 to the intermediate transfer roller P18, the photosensitizer P2 is removed of charge by a charge removing light P21, and at the same time, the after-transfer toner remaining on the photosensitizer P2 is removed by a cleaning blade P22 composed of urethane rubber or the like.

Likewise, after the transfer from the intermediate transfer roller P18 (transferring unit) to a recording medium F5, the after-transfer toner remaining on the intermediate transfer roller P18 is removed by a cleaning blade P23 composed of urethane rubber or the like.

The toner image formed on the photosensitizer P2 is first transferred to the intermediate transfer roller P18, and then a transfer current is allowed to flow through a secondary transfer roller P19 so that the image is transferred onto the recording medium F5, which may be a sheet of paper passing between the two.

Thereafter, the toner image (transferred image) transferred onto the recording medium F5 such as paper is transported to a fixing apparatus (fixing unit) F40 which will be described later, to be fixed.

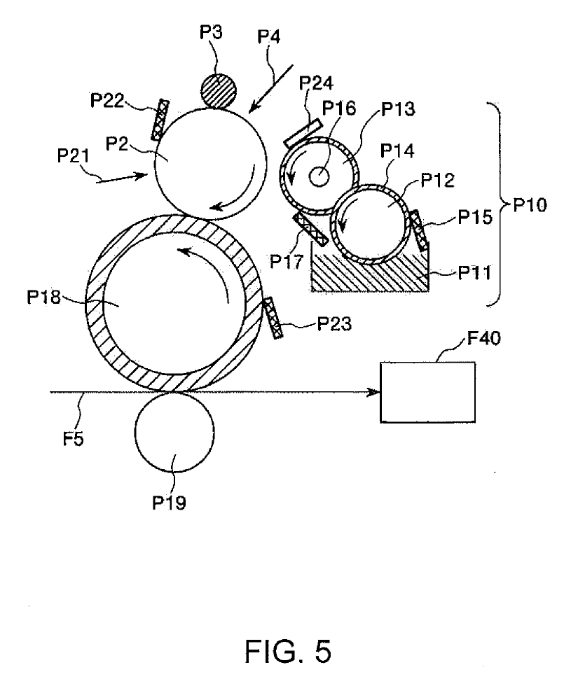

FIG. 5 is a diagram illustrating an exemplary non-contact type image forming device.

In the non-contact mode, a charging blade P24 constituted of a phosphor-bronze plate is mounted on the developing roller P13.

The charging blade p24 has a function of charging by friction by contacting with the liquid developer layer. At the same time, since the coating roller P12 is a gravure roller, and a developer layer corresponding to the irregularities of the gravure roller surface is formed on the developing roller P13, the charging blade P24 is to accomplish a function of averaging the irregularities uniformly. Thus, the charging blade may be arranged in a counter direction to the rotating direction of the developing roller, or in a trailing direction, and may have a roller shape instead of a blade shape.

Also, it is preferable that an interval of 200 μm to 800 μm is disposed between the developing roller P13 and the photosensitizer P2, and at the same time, an alternating voltage of 500 to 3000 Vpp, which corresponds to a direct voltage of 200 to 800 V, having a frequency of 50 to 3000 Hz is applied between the developing roller P13 and the photosensitizer P2. Other than these, the image forming device is the same as that described with reference to FIG. 4.

In addition, although both FIG. 4 and FIG. 5 illustrate image formation by means of a unicolor liquid developer, in the case of forming an image using a multi-colored color toner, images of the respective colors can be formed using developing machines of multiple colors to form a colored image.

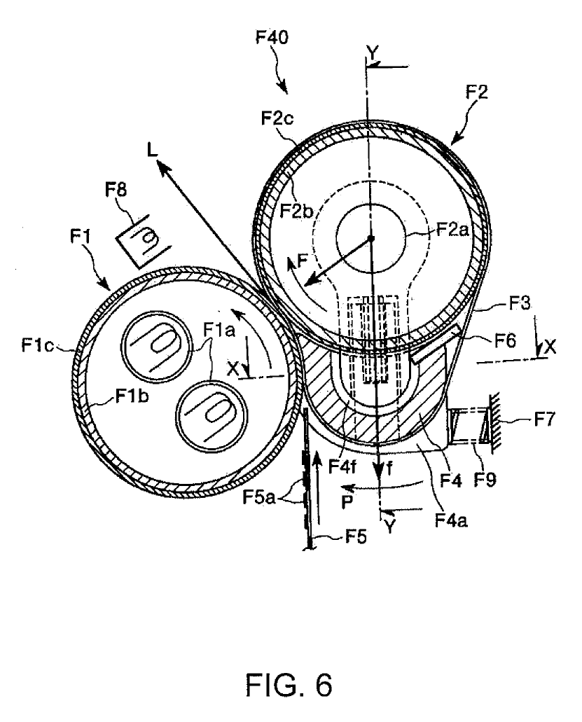

FIG. 6 is a diagram illustrating an example of the fixing apparatus.

The fixing apparatus (fixing unit) F40 is to fix an unfixed toner image F5a which has been formed on the above-described developing unit P2, transferring unit P18 or the like, onto the recording medium F5.

The fixing apparatus F40 has, as described in FIG. 6, a heat fixing roller F1, a pressurizing roller F2, a heat-resistant belt F3, a belt stretching member F4, a cleaning member F6, a frame F7, an ultraviolet irradiator F8, and a spring F9.

The heat fixing roller (fixing roller) F1 has a roller substrate F1b composed of a pipe material, an elastic body coating the outer periphery, and a cylindrically shaped halogen lamp F1a inside the roller base F1b as a heating source, and the heat fixing roller can rotate in the counterclockwise direction as indicated with an arrow in the drawing.

The pressure roller F2 has a roller base F2b composed of a pipe material, and an elastic body F2c coating the outer periphery, and can rotate in the clockwise direction as indicated with an arrow in the drawing.

A PFA layer is disposed on the surface layer of the elastic body F1c of the heat fixing roller F1. Thus, although the respective thicknesses of the elastic bodies F1c and F2c are different, the two elastic bodies F1c and F2c undergo approximately uniform elastic deformation, and a so-called horizontal nip is formed. Also, since there is no difference in the transport speed of the heat-resistant belt F3 which will be described later, or of the recording medium F5, with respect to the circumferential velocity of the heat fixing roller F1, extremely stable image fixation is made possible.

There are two cylindrical halogen lamps F1a and F1a which constitute a heat source built in the inside of the heat fixing roller F1, and the heat generating elements of these cylindrical halogen lamps F1a and F1a are disposed at different sites. As each of the cylindrical halogen lamps F1a and F1a is selectively turned on, it is set up such that the temperature controller is easily operated under the condition in which the fixing nip site where the heat resistant belt F3 to be described later is wound around the heat fixing roller F1 is different from the site where the belt stretching member F4 to be described later is in contact with the heat fixing roller F1, that will be described later, or under the condition in which a wide recording medium and a narrow recording medium are different, or the like.

The pressurizing roller F2 is disposed to face the heat fixing roller F1, and is constituted to apply pressure to the recording medium F5 where an unfixed toner image has been formed, via the heat resistant belt F3 to be described later. By applying pressure, the insulating liquid as described above can be more efficiently penetrated into the recording medium F5. As a result, the unsaturated fatty acid contained in the insulating liquid can be more assuredly cured inside the recording medium F5 by heat, ultraviolet irradiation that will be described, or the like, and thus the toner image F5a can be more firmly fixed onto the recording medium F5 by the anchoring effect.

The pressurizing roller F2 has a roller substrate F2b composed of a pipe material, and an elastic body F2c coating the outer periphery, and can rotate in the clockwise direction as indicated with an arrow in the drawing.

The elastic body F1c of the heat fixing roller F1 and the elastic body F2c of the pressurizing roller F2 described above undergo approximately uniform elastic deformation, and thus form a so-called horizontal nip. Also, since there is no difference in the transport speed of the heat-resistant belt F3 which will be described later, or of the recording medium F5, with respect to the circumferential velocity of the heat fixing roller F1, extremely stable image fixation is made possible.

The heat resistant belt F3 is a belt having a shape of endless circle which is pressed between the heat fixing roller F1 and the pressurizing roller F2, and is enabled to move while being lined along the outer peripheries of the pressurizing roller F2 and the belt stretching member F2.

This heat resistant belt F3 has a thickness of 0.03 mm or larger, and is formed into a seamless tube consisting of two layers, such as its surface (the surface of the side contacting with the recording medium F5) formed of PFA, and the opposite side (the surface of the side contacting with the pressurizing roller F2 and the belt stretching member F4) formed of polyimide. In addition, the heat resistant belt F3 is not limited thereto, and may also be formed of other materials, such as into a metal tube such as a stainless steel tube, an electroformed nickel tube or the like, a heat resistant resin tube such as a silicone tube or the like.

The belt stretching member F4 is disposed upstream to the fixing nip portion of the heat fixing roller F1 and the pressurizing roller F2 in the recording medium F5 transporting direction, and at the same time, is disposed to be able to oscillate about the rotating axis F2a of the pressurizing roller F2 in the direction of the arrow P.

The belt stretching member F4 is constituted to stretch the heat resistant F3 in the tangential direction of the heat fixing roller F1, in a state where the recording medium F5 does not pass through the fixing nip portion. If the fixing pressure is large at the initial position where the recording medium F5 enters the fixing nip portion, the entry is not made smoothly, and in some cases, the recording medium F5 may be fixed with its front end being folded. However, with the configuration of stretching the heat resistant belt F3 in the tangential direction of the heat fixing roller F1 as such, a feed port portion for the recording medium F5 where the entry of the recording medium F5 is made smooth can be formed, thereby it being possible to make stable entry of the recording medium F5 into the fixing nip portion.

The belt stretching member F4 is an approximately half-moon shaped belt sliding member (the heat resistant belt F3 slides on the belt stretching member F4) which is inserted to fit with the inner periphery of the heat resistant belt F3 and cooperates with the pressurizing roller F2 to impart tension f to the heat resistant belt F3. This belt stretching member F4 is disposed at a position where the heat resistant belt F3 is wound around the heat fixing roller F1 from the tangential line L of the pressing portion between the heat fixing roller F1 and the pressurizing roller F2 to form a nip. A protruding wall F4a is protruded from at one edge or at both edges in the axial direction of the belt stretching member F4, and this protruding wall F4a is to prevent swaying of the heat resistant belt F3 to a side by allowing this heat resistant belt F3 to come into contact with this protruding wall F4a, when the heat resistant belt F3 is swayed to one side of the axial direction edges. A spring F9 is built in between the edge portion of the protruding wall F4a on the side opposite to the heat fixing roller F1 and the frame, so that the protruding wall F4a of the belt stretching member F4 lightly presses against the heat fixing roller F1, and the belt stretching member F4 is in sliding contact with the heat fixing roller F1 to be positioned.

The position at which the belt stretching member F4 is slightly pressed against the heat fixing roller F1 is considered as the nip initial position, and the position where the pressurizing roller F2 is pressed against the heat fixing roller F1 is considered as the nip end position.

In the fixing apparatus F40, the recording medium F5 on which an unfixed toner image F5a has been formed enters the fixing nip portion at the nip initial position, passes through between the heat resistant belt F3 and the heat fixing roller F1, and leaves through the nip end position, so that the unfixed toner image F5a formed on the recording medium F5 is thermally fixed, and then the recording medium F5 is discharged in the tangential direction L of the pressing portion of the pressurizing roller F2 against the heat fixing roller F1.

The ultraviolet irradiator F8 has a function of irradiating ultraviolet radiation to the surface of the recording medium F5 thus discharged, where the toner image F5a is formed. With such configuration, the unsaturated fatty acid component contained in the fatty acid monoester and the fatty acid triglyceride can be more firmly solidified by heat and ultraviolet irradiation, and as a result, the toner particles can be more firmly fixed onto the recording medium. Also, since the ultraviolet irradiation allows firm fixation of the toner particles onto the recording medium even without heating to a particularly high temperature by the heat fixing roller F1, the toner particles can be fixed to the recording medium at a lower temperature and at a higher speed by a synergistic effect with the effect of using the liquid developer according to embodiments of the invention, and the toner particles can be more firmly fixed to the recording medium as well. Moreover, since large amounts of heat energy are not needed for the fixing process, even if the time for passing through the fixing nip portion is relatively short, the toner particles can be satisfactorily fixed onto the recording medium by the ultraviolet irradiation. That is, because fixation is not time-consuming, further enhancement of printing speed can be attempted. Moreover, since fixation does not require large amounts of heat energy, energy saving can be attempted. As a result, an environmentally friendly fixing apparatus can be provided.

The cleaning member F6 is disposed between the pressurizing roller F2 and the belt stretching member F4.

This cleaning member F6 is in sliding contact with the inner circumferential surface of the heat resistant belt F3 to clean any foreign materials, abrasion powder or the like on the inner circumferential surface of the heat resistant belt F3. By cleaning the foreign materials, abrasion powder or the like as such, the heat resistant belt F3 is refreshed so that a factor for the instability of friction coefficient as described above. Also, a depressed portion F4f is disposed on the belt stretching member F4, and is configured to accept the foreign materials, abrasion powder or the like removed from the heat resistant belt F3.

In addition, in order to stably drive the heat resistant belt F3 with the pressurizing roller F2 by stretching using the pressurizing roller F2 and the belt stretching member F4, it is preferable to set the friction coefficient between the pressurizing roller F2 and the heat resistant belt F3 to be larger than the friction coefficient between the belt stretching member F4 and the heat resistant belt F3. However, the friction coefficient may become unstable because of intrusion of any foreign material between the heat resistant belt F3 and the pressurizing roller F2 or between the heat resistant belt F3 and the belt stretching member F4, or because of abrasion of the portion of the heat resistant belt F3 contacting with the pressurizing roller F2 and the belt stretching member F4, or the like.

There, it is set up such that the contact angle between the belt stretching member F4 and the heat resistant belt F3 is smaller than the contact angle between the pressurizing roller F2 and the heat resistant belt F3, and such that the diameter of the belt stretching member F4 is smaller than the diameter of the pressurizing roller F2. Then, the length of the heat resistant belt F3 sliding on the belt stretching member F4 is shortened, thus making it possible to avoid the destabilizing factors with respect to changes over time, disturbances or the like, and the heat resistant belt F3 can be stably driven by the pressurizing roller F2.

The time required by the toner particles to pass through the fixing nip portion (nip time) is preferably 0.02 to 0.2 seconds, and more preferably 0.03 to 0.1 seconds. Even though the time required by the toner particles to pass through the fixing nip portion is as short as such, fixation can be performed sufficiently by using the liquid developer according to embodiments of the invention as described above, and further enhancement of printing speed can be attempted.

The heat to be added by the heat fixing roller F1 (fixing temperature) is specifically preferably 80 to 200° C., and more preferably 100 to 180° C. If this fixing temperature has a value within the above-mentioned range, the fatty acid monoester can favorably plasticize the toner particles. Also, in the case where an unsaturated fatty acid component is contained in the insulating liquid, the oxidative polymerization reaction (curing reaction) of the unsaturated fatty acid component can proceed more effectively. Furthermore, in the case where those as described above are contained as the antioxidant, decomposition of the antioxidant becomes easier, and the intensity of fixation of the toner particles can be more effectively improved. In the case where an oxidative polymerization promoter is contained in the liquid developer, this tendency is more notably manifested.

As such, the invention was explained on the basis of preferred embodiments, but the invention is not intended to be limited thereto.

For instance, the liquid developer of the invention is not limited to those prepared by the methods as described above, but may be prepared by any method. For example, the liquid developer may be prepared by thermally melting a pulverization product as described above, dispersing the molten product in the insulating liquid, and cooling the resultant. In this case, if an antioxidant is contained in the insulating liquid, deterioration of the unsaturated fatty acid component due to oxidation can be prevented during the preparation process. Also in this case, if necessary, an antioxidant may be further added after cooling.

Each of the units constituting the dry microparticle preparing apparatus may be replaced by any unit having the same function, or may be added with additional constitutions.

The liquid developer of the invention is not limitedly applied to an image forming device as described above.

Furthermore, although it has been described in the above-described embodiments that the dry microparticles obtained by the aqueous dispersion medium removing process were first recovered and then supplied to the dispersing process, the dry microparticles may be supplied directly to the dispersing process without recovering as powder. For example, a dry microparticle producing apparatus as illustrated may have a dispersing unit which stores the insulating liquid and supplying produced dry microparticles. Thus, it is possible to more efficiently prepare the liquid developer, as well as to more effectively prevent any involuntary aggregation between dry microparticles or the like.

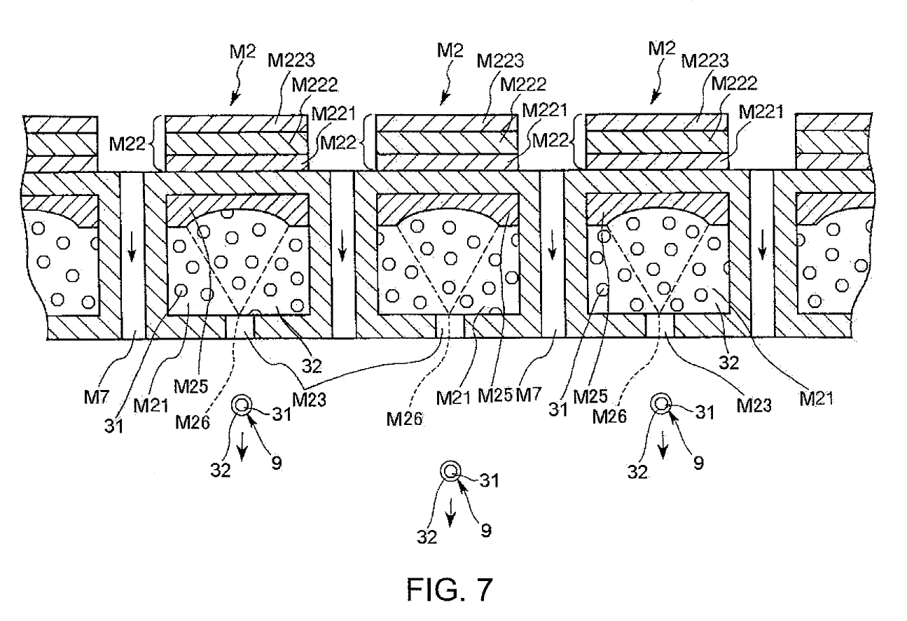

Also, as shown in FIG. 7, an acoustic lens (concave lens) M25 may be installed in the head unit M2. If such acoustic lens M25 is installed, for example, the pressure pulse (vibrational energy) generated by the piezoelectric element M22 can be converged at a pressure pulse converging unit M26 in the vicinity of the discharging unit M23. As a result, the vibrational energy generated by the piezoelectric element M22 can be efficiently utilized as the energy to discharge the aqueous dispersion 3. Accordingly, even if the aqueous suspension 3 stored in the dispersion storing unit M21 is of relatively high viscosity, the aqueous suspension can be definitely discharged from the discharging unit M23. Also, even if the aqueous suspension 3 stored in the dispersion storing unit M21 has relatively large cohesive force (surface tension), it is possible to discharge the aqueous dispersion as fine liquid droplets, and therefore, it is possible to easily and certainly control the particle size of the dry microparticles (toner particles) 9 to a relatively small value.

As such, by having a configuration as illustrated, even in the case of using a material having a higher viscosity or a material having large cohesive force as the aqueous suspension 3, it is possible to control the dry microparticles 4 to a desired shape and size. Thus, the range of selection of the material becomes particularly wide, and a toner having the desired characteristics can be more easily obtained.

Furthermore, in the case of having a configuration as illustrated, since the aqueous suspension 3 is discharged by the converged pressure pulse, even if the area (passage area) of the discharging unit M23 is relatively large, the size of the aqueous suspension 3 to be discharged can be made relatively small. That is, even when it is desired to make the particle size of the dry microparticles 4 relatively small, the area of the discharging unit M23 can be enlarged. Thus, even with an aqueous suspension 3 of a relatively high viscosity, occurrence of clogging or the like in the discharging unit M23 can be more effectively prevented.

The acoustic lens is not limited to a concave lens, and for example, a Fresnel screen, an electron scanning lens or the like may also be used.

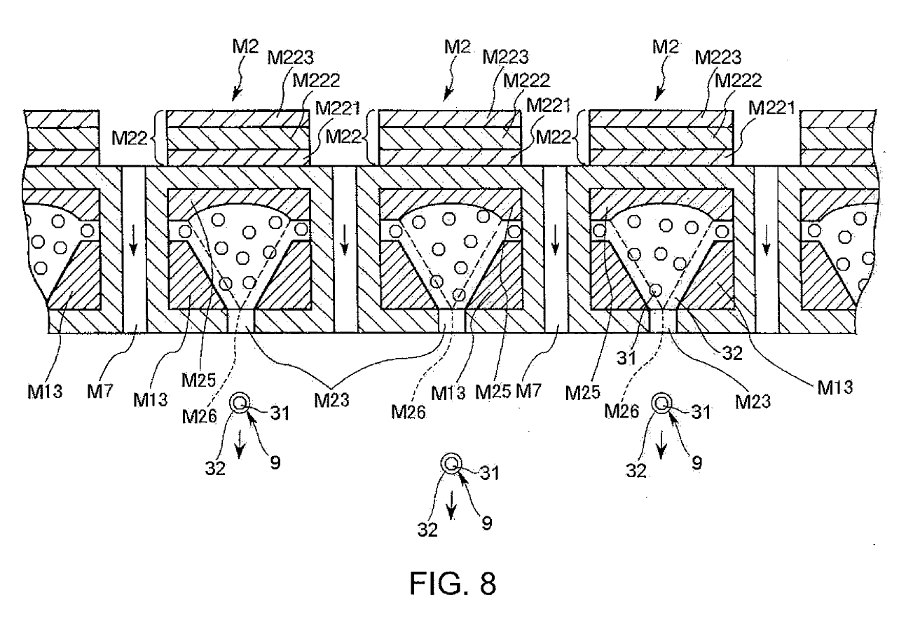

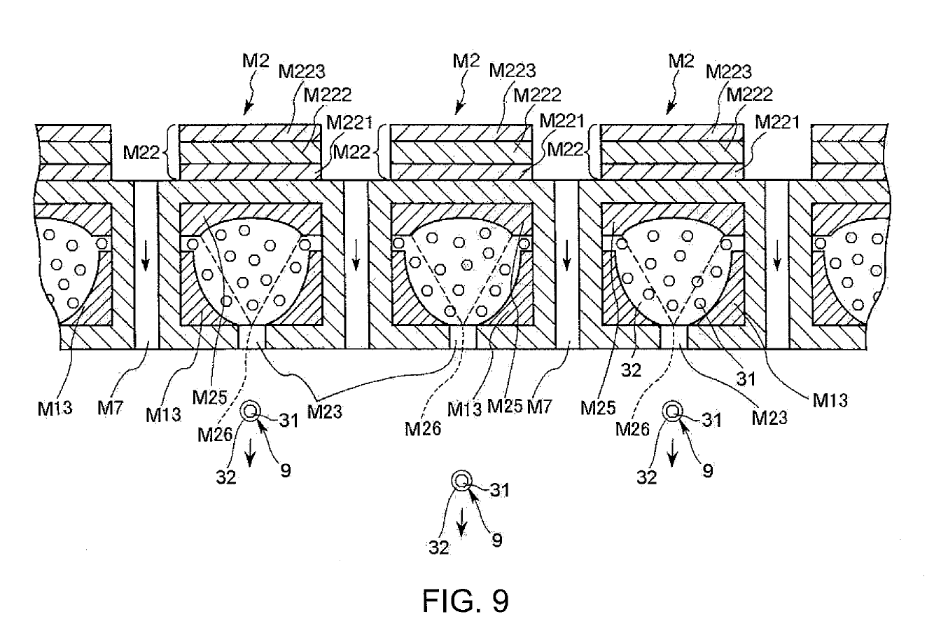

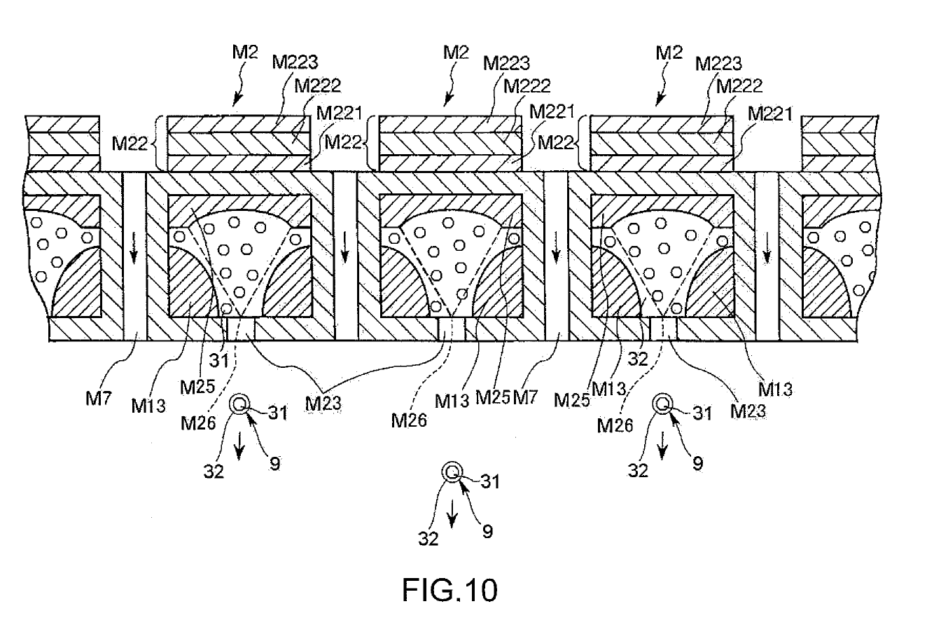

Moreover, as shown in FIG. 8 to FIG. 10, a diaphragm member M13 having a shape converging toward the discharging unit M23 may be disposed between the acoustic lens M25 and the discharging unit M23. This can assist the convergence of the pressure pulse (vibrational energy) generated by the piezoelectric element M22, and the pressure pulse generated by the piezoelectric element M22 can be more efficiently used.

While it has been described in the above-described embodiments that the constituent components of the toner are contained in the dispersoid as solid components, at least a portion of the constituent components of the toner may be contained in the dispersion medium.

Furthermore, while it has been described in the above-described embodiments that the dispersion (aqueous suspension) is intermittently discharged from the head unit by the piezoelectric pulse, other methods may also be used for the method of discharging (method of jetting) the dispersion. For example, as the method of discharging (jetting) the dispersion, in addition to those methods such as a spray drying method, a so-called bubble jet (“Bubble Jet” is registered trade mark) method or the like, a “method of jetting a dispersion to liquid droplets using a nozzle which operates by pressing a dispersion onto a flat and smooth surface using a gas stream, stretching the dispersion to a thin layer stream, detaching the thin layer stream from the flat and smooth surface, and jetting the thin layer stream as fine liquid droplets (a method described in Japanese Patent Application No. 2002-321889)” may also be used. The spray drying method is a method of obtaining liquid droplets by jetting (spraying) a liquid (dispersion) using a high pressure gas. As the method to which the so-called bubble jet (“Bubble Jet” is registered trade mark) method is applied, the method described in Japanese Patent Application No. 2002-169348 or the like may be mentioned. That is, as a method of discharging (jetting) a dispersion, a “method of intermittently discharging a dispersion from the head unit by means of volumetric change of a gas” can be applied.

The formation of the dry microparticles may not be performed by discharging a dispersion (aqueous suspension). For example, by filtering an aqueous suspension, microparticles corresponding to the dispersoid may be separated by filtration, and taken as the dry microparticles.

While obtaining dry microparticles having a size and shape corresponding to each of the dispersoids in an aqueous suspension has been described in the above-described embodiment, the dry microparticles may be, for example, aggregates formed by aggregation (adhesion) of microparticles which correspond to a plurality of dispersoids in the aqueous suspension.

Also, while it has been described that preparation of an aqueous emulsion is performed using a pulverization product of a kneading product in the above-described embodiment, the pulverization process of the kneading product may be omitted.

The method of preparing an aqueous emulsion or an aqueous suspension is not limited to the methods as described above. For example, an aqueous suspension may be obtained by first obtaining an aqueous emulsion having the dispersoid in the liquid phase by heating a dispersion with a solid state dispersoid dispersed therein, and cooling the aqueous emulsion.

While it has been described in the above-described embodiments that an aqueous suspension is obtained first using an aqueous emulsion, and then dry microparticles are prepared using the aqueous suspension, a constitution of obtaining dry microparticles directly from an aqueous emulsion without involving an aqueous suspension may also be used. For example, dry microparticles may be obtained by discharging an aqueous emulsion in the form of liquid droplets, and removing the dispersion medium together with the solvent in the dispersion medium from the liquid droplets.

While a constitution in which an encapsulated oxidative polymerization promoter is dispersed in an insulating liquid has been described in the above-described embodiments, the oxidative polymerization promoter may not be encapsulated. Also, the oxidative polymerization promoter (in particular, encapsulated oxidative polymerization promoter) may be, for example, contained in the toner particles, or may be adhered on the surfaces of the toner particles. In the case where the oxidative polymerization promoter is adhered on the surfaces of the toner particles, the unsaturated fatty acid component can be more assuredly cured during fixing.

The fatty acid monoesters and fatty acid triglycerides used in the invention may be chemically synthesized ones (artificially synthesized).

The image forming device to which the liquid developer according to embodiments of the invention is not limited to those having the above-described configuration, and may have different configurations. The materials composing the respective units of the image forming device are not limited to those described above.

In the second embodiment of the method of preparation described above, it has been described that associated particles are obtained by obtaining an aqueous dispersion, and adding an electrolyte to the aqueous emulsion, but the present invention is not limited thereto. For example, associated particles may be prepared using an emulsion polymerization association method in which a colorant, a monomer, a surfactant and a polymerization initiator are dispersed in an aqueous liquid, an aqueous dispersion is prepared by emulsion polymerization, and an electrolyte is added to the aqueous dispersion to induce association, or alternatively, associated particles may also be obtained by, for example, spray drying the obtained aqueous dispersion. Also, for example, a liquid developer may also be obtained by pulverizing a toner material prepared by melt kneading a pigment, a resin material and the like, in an insulating liquid.

### EXAMPLES

### 1. Preparation of Liquid Developer

### Example 1

### Preparation of Dry Microparticles

First, 80 parts by weight of a polyester resin (glass transition temperature: 45° C., softening point: 95° C.) as a binding resin, and 20 parts by weight of a cyan pigment (Dainichiseika Color and Chemicals Mfg. Co., Ltd., Pigment Blue 15:3) as a colorant were provided.

These components were mixed using a 20L type Henschel mixer to obtain a raw material for toner preparation.

Next, this raw material (mixture) was kneaded using a twin-screw kneading extruder as depicted in FIG. 1.

The total length of the processing unit of the twin-screw kneading extruder was 160 cm.

The temperature of the raw material in the processing unit was set to be 105 to 115° C.

The speed of rotation of the screws was set to 120 rpm, and the rate of introduction of the raw material was set to 20 kg/hr.

The time required by the raw material to pass through the processing unit, which time is desired under such conditions, is about 4 minutes.

In addition, the kneading described above was performed by operating a vacuum pump connected to the processing unit via a deaerating vent, while deaerating the inside of the processing unit.

The raw material (mixture) kneaded in the processing unit was extruded through a head unit to the outside of the twin-screw kneading extruder. The temperature of the kneading product inside the head unit was adjusted to 130° C.

The kneading product thus extruded from the extrusion orifice of the twin-screw kneading extruder was cooled using a cooler as illustrated in FIG. 1. The temperature of the kneading product immediately after the cooling process was about 45° C.

The cooling rate of the kneading product was 9° C./sec. The time required from the end of the kneading process to the end of the cooling process was 10 seconds.

The kneading product cooled as described above was subjected to coarse pulverization to obtain a powder having an average particle size of 1.5 mm. A hammer mill was used for the coarse pulverization of the kneading product.

Next, 100 parts by weight of the coarse pulverization product of the kneading product was added to 250 parts by weight of toluene, and the resultant was treated for 1 hour using an ultrasonic homogenizer (output power: 400 μA), to obtain a solution in which the polyester resin of the kneading product was dissolved. Also, the pigment was uniformly microdispersed in such solution.

Meanwhile, an aqueous liquid prepared by uniformly mixing 1 part by weight of sodium dodecylbenzenesulfonate as a dispersant, and 700 parts by weight of ion-exchanged water were was provided.

The aqueous liquid was agitated, while the speed of rotation was adjusted using a homomixer (Tokushu Kika Kogyo Co., Ltd.).

The solution (toluene solution of the kneading product) was added dropwise to the aqueous liquid which had been agitated. Thus, an aqueous emulsion in which a dispersoid having an average particle size of 3 μm is uniformly dispersed could be obtained.

Thereafter, under the conditions such as at a temperature of 100° C. and a pressure of 80 kPa, toluene in the aqueous emulsion was removed, the resultant was cooled to room temperature, and then a predetermined amount of water was added to adjust the concentration, thereby to obtain an aqueous suspension having solid microparticles dispersed therein. The obtained aqueous suspension did not substantially have any toluene remaining. The solid component (dispersoid) concentration in the resulting aqueous suspension was 28.8% by weight. Also the average particle size of the dispersoid (solid microparticles) dispersed in the suspension was 1.4 μm. In addition, the measurement of the average particle size of the dispersoid was performed using a laser diffraction/scattering particle size distribution measuring apparatus (Horiba Seisakusho Co., Ltd. LA-920).

The suspension thus obtained was introduced into the aqueous suspension supplying unit of a dry microparticle producing apparatus having the configuration illustrated in FIG. 2 and FIG. 3. The aqueous suspension in the aqueous suspension supplying unit was supplied to the head unit by a metering pump while agitating with an agitator, to discharge (jet) from the discharging unit to the dispersion medium removing unit. The discharging unit was made to have a circular shape with a diameter of 25 μm. For the head unit, one subjected to hydrophobization treatment by a fluororesin (polytetrafluoroethylene) coating was used in the vicinity of the discharging unit. In addition, the temperature of the aqueous suspension inside the aqueous suspension supplying unit was adjusted to be 25° C.

The discharge of the aqueous suspension was performed in a state that the temperature of the dispersion in the head unit was adjusted to 25° C., the frequency of the piezoelectric body to 10 kHz, the initial speed of the dispersion discharged from the discharging unit to 3 m/sec, and the amount of discharge of one droplet of the aqueous suspension discharged from the head unit to 4 pl (particle size: 20.8 μm). The discharge of the aqueous suspension was performed such that the discharge timing of the aqueous suspension was different in at least adjacent head units among a plurality of head units.

Furthermore, upon discharging the aqueous suspension, an air having a temperature of 25° C., a humidity of 27% RH and a flow rate of 3 m/sec was jetted out vertically downwards from a gas jet orifice. Also, the temperature inside the housing was set to be 45° C. The pressure inside the housing was about 1.5 kPa. The length of the dispersion medium removing unit was about 1.0 m.

A voltage was applied to the housing of the dispersion medium removing unit so that the potential on the inner surface side was −200 V, thus to prevent adhesion of the aqueous suspension (dry microparticles) to the inner wall.

The dispersion medium was removed from the discharged aqueous suspension inside the dispersion medium removing unit, so that a plurality of dry microparticles (toner particles) were formed to have shapes and sizes corresponding to the respective dispersoids.

The dry microparticles formed in the dispersion medium removing unit were recovered from a cyclone to obtain the dry microparticles.

### Encapsulation of Oxidative Polymerization Promoter

Meanwhile, an encapsulated oxidative polymerization promoter was prepared as follows.

First, 10 g of zinc octoate as an oxidative polymerization promoter was dissolved in 15 mL of acetone, and the resulting solution was adsorbed to a porous hydrophilic silica gel to obtain a core material.

Next, 10 g of the obtained core material and 20 g of polyethylene glycol (PEG) were mixed with heating to obtain a mixture.

Next, this mixture was added to 400 mL of Solvent AF6 manufactured by Nippon Mitsubishi Oil Corp. and dispersed sufficiently in a homomixer, and then the dispersion was gradually cooled to deposit PEG.

Thereafter, the solvent was removed by filtration to obtain an encapsulated oxidative polymerization promoter.

### Preparation of Insulating Liquid

Meanwhile, an insulating liquid containing a fatty acid monoester and a fatty acid triglyceride was obtained as follows.

A first liquid containing a fatty acid triglyceride was prepared in the following manner.

First, 130 parts by volume of unpurified rapeseed oil was introduced into a flask, and then 100 parts by volume of boiling water was poured into the flask, which was then stopped.

Next, the flask was shaken to mix the unpurified rapeseed oil and boiling water.

Next, the flask was left to stand until the liquid mixture in the flask underwent separation to three layers.

After confirming complete separation, the flask was transferred to a freezer and was left to stand for 24 hours.

Thereafter, unfrozen components were transferred to another flask.

These unfrozen components were repeatedly subjected to the operation described above, and the resulting unfrozen components were removed to obtain crude oil and fat.

Next, 100 parts by volume of the crude oil and fat obtained as described above, and 35 parts by volume of activated white clay mainly composed of hydrated aluminum silicate were mixed and agitated in a flask.

Then, the resulting mixture was stored under pressure (0.18 MPa) for 48 hours to completely precipitate the activated white clay.

Thereafter, the precipitate was removed, and a first liquid mainly containing the fatty acid triglyceride was obtained. In addition, the first liquid (purified rapeseed oil) was composed mainly of fatty acid triglycerides mainly having unsaturated fatty acid components such as oleic acid, linolic acid, α-linoleic acid and the like, and saturated fatty acid components such as palmitic acid, stearic acid and the like. Furthermore, the content of the fatty acid triglycerides contained in the resulting first liquid was 99.9% by weight or greater. The proportion of the saturated fatty acid contained in the resulting fatty acid triglyceride with respect to the total fatty acid components composing the fatty acid triglyceride was 7.5% by mole.

Meanwhile, a second liquid containing a fatty acid monoester was prepared in the following manner.

First, purified rapeseed oil was prepared as described above.

Next, the purified rapeseed oil was reacted with excess isobutanol in the presence of sulfuric acid as a catalyst to perform a transesterification reaction. Then, the excess isobutanol and glycerin generated from the reaction were removed, and thus a liquid composed mainly of fatty acid monoesters was obtained. Furthermore, this liquid was purified to obtain a second liquid having a content of the fatty acid monoesters of 99.9% by weight or greater was obtained. The fatty acid monoesters thus obtained were mainly composed of fatty acid monoesters having unsaturated fatty acid monoester such as isobutyl oleate, isobutyl linolate, isobutyl α-linoleate and the like, and saturated fatty acid monoesters such as isobutyl palmitate, isobutyl stearate and the like.

The first liquid and the second liquid thus obtained were mixed to obtain a liquid mixture containing fatty acid monoesters and fatty acid triglycerides. Thereafter, 500 parts by weight of the liquid mixture and 5 parts by weight of ascorbic acid stearate acid ester as an antioxidant (thermal decomposition temperature: 300° C. or higher) were mixed to obtain an insulating liquid. Moreover, during mixing the first liquid and the second liquid, the content of the fatty acid monoesters was adjusted to 34.0% by weight, and the content of the fatty acid triglycerides to 65.0% by weight, based on the whole insulating liquid. The iodine value of the obtained insulating liquid was 100. Also, the electrical resistance of the obtained insulating liquid at room temperature (20° C.) was 6.4×10¹⁴ Ωcm.

### Dispersion of Dry Microparticles and Oxidative Polymerization Promoter

505 parts by weight of the insulating liquid obtained as described above, 1 part by weight of a surfactant (dodecyltrimethylammonium chloride), 1.25 parts by weight of the encapsulated oxidative polymerization promoter (1 part by weight in terms of the oxidative polymerization promoter), and 75 parts by weight of the dry microparticles were mixed with stirring for 10 minutes in a homomixer (Tokushu Kika Kogyo Co., Ltd.) to obtain a liquid developer. The viscosity of the liquid developer thus obtained was 160 mPa·s.

### Examples 2 to 5

Liquid developers were prepared in the same manner as in Example 1 above, except that the polyester resins having the glass transition temperature and softening temperature as indicated in Table 1 were used as the resin material composing the toner particles.

### Example 6

A liquid developer was prepared in the same manner as in Example 1 above, except that a styrene-acrylic acid ester copolymer having a glass transition temperature of 20° C. and a softening temperature of 81° C. was used as the resin material composing the toner particles.

### Examples 7 and 8

Liquid developers were prepared in the same manner as in Example 1 above, except that the contents of the fatty acid monoesters and the fatty acid triglycerides in the insulating liquid were adjusted as indicated in Table 1.

### Example 9

A liquid developer was prepared in the same manner as in Example 1 above, except that a liquid having a fatty acid monoester as the main component was obtained by using methanol in place of isobutanol to perform a transesterification reaction with purified rapeseed oil in the preparation of the second liquid. In addition, the fatty acid monoester contained in the second liquid according to the present Example was a fatty acid monoester mainly having unsaturated fatty monoesters such as methyl oleate, methyl linolate, methyl α-linoleate and the like, and saturated fatty acid monoesters such as methyl palmitate, methyl stearate and the like.

### Example 10

In the preparation of an insulating liquid, a first liquid was prepared by the same method as that of Example 1 above, using soybean oil in place of rapeseed oil as the oil and fat, and a second liquid was obtained from a liquid generated by a transesterification reaction by adding methanol to purified soybean oil. A liquid developer was prepared, using these first liquid and second liquid, in the same manner as in Example 1 except that the contents of the fatty acid monoester and the fatty acid triglyceride were adjusted as indicated in Table 1.

### Example 11

In the preparation of an insulating liquid, a first liquid was prepared by the same method as that of Example 1 above, using dehydrated castor oil in place of rapeseed oil as the oil and fat, and a second liquid was obtained from a liquid generated by a transesterification reaction by adding methanol to purified dehydrated castor oil. A liquid developer was prepared, using these first liquid and second liquid, in the same manner as in Example 1 above except that the contents of the fatty acid monoester and the fatty acid triglyceride were adjusted as indicated in Table 1.

### Example 12

In the preparation of an insulating liquid, a first liquid was prepared by the same method as that of Example 1 above, using tung oil in place of rapeseed oil as the oil and fat, and a second liquid was obtained from a liquid generated by a transesterification reaction by adding methanol to purified tung oil. A liquid developer was prepared, using these first liquid and second liquid, in the same manner as in Example 1 above except that the contents of the fatty acid monoester and the fatty acid triglyceride were adjusted as indicated in Table 1.

### Example 13

In the preparation of an insulating liquid, a first liquid was prepared by the same method as that of Example 1 above, using linseed oil in place of rapeseed oil as the oil and fat, and a second liquid was obtained from a liquid generated by a transesterification reaction by adding methanol to purified linseed oil. A liquid developer was prepared, using these first liquid and second liquid, in the same manner as in Example 1 above except that the contents of the fatty acid monoester and the fatty acid triglyceride were adjusted as indicated in Table 1.

### Example 14

A liquid developer was prepared in the same manner as in Example 1 above, except that the same fatty acid monoester as that used in Example 11 above was used as the fatty acid monoester. That is, the fatty acid monoester that was used in the present Example was different from that prepared from the liquid obtained by subjecting the fatty acid triglyceride of the present Example to a transesterification reaction.

### Example 15

A second liquid composed of the same fatty acid monoester as that used in Example 1 above as the fatty acid monoester, and dry microparticles (toner particles) were mixed with stirring for 20 minutes in a homomixer. Then, the other components which constitute a liquid developer were added thereto, and the resultant was further mixed with stirring for 10 minutes in the homomixer, to obtain a liquid developer as indicated in Table 1.

### Example 16

A second liquid composed of the same fatty acid monoester as that used in Example 9 above as the fatty acid monoester, and dry microparticles (toner particles) were mixed with stirring for 20 minutes in a homomixer. Then, the other components which constitute a liquid developer were added thereto, and the resultant was further mixed with stirring for 10 minutes in the homomixer, to obtain a liquid developer as indicated in Table 1.

### Example 17

A first liquid composed of the same fatty acid triglyceride as that used in Example 10 above as the fatty acid triglyceride, and dry microparticles (toner particles) were mixed with stirring for 10 minutes in a homomixer. Then, the other components which constitute a liquid developer were added thereto, and the resultant was further mixed with stirring for 10 minutes in the homomixer, to obtain a liquid developer as indicated in Table 1.

### Example 18

A first liquid composed of the same fatty acid triglyceride as that used in Example 11 above as the fatty acid triglyceride, and dry microparticles (toner particles) were mixed with stirring for 10 minutes in a homomixer. Then, the other components which constitute a liquid developer were added thereto, and the resultant was further mixed with stirring for 10 minutes in the homomixer, to obtain a liquid developer as indicated in Table 1.

### Example 19

A first liquid composed of the same fatty acid triglyceride as that used in Example 12 above as the fatty acid triglyceride, and dry microparticles (toner particles) were mixed with stirring for 10 minutes in a homomixer. Then, the other components which constitute a liquid developer were added thereto, and the resultant was further mixed with stirring for 10 minutes in the homomixer, to obtain a liquid developer as indicated in Table 1.

### Example 20

A first liquid composed of the same fatty acid triglyceride as that used in Example 13 above as the fatty acid triglyceride, and dry microparticles (toner particles) were mixed with stirring for 10 minutes in a homomixer. Then, the other components which constitute a liquid developer were added thereto, and the resultant was further mixed with stirring for 10 minutes in the homomixer, to obtain a liquid developer as indicated in Table 1.

### Examples 21 to 26

Liquid developers were prepared in the same manner as in Example 1 above, except that polyester resins having the glass transition temperatures and softening temperatures as indicated in Table 1 were used as the resin material composing the toner particles, and the contents of the fatty acid monoesters and fatty acid triglycerides in the insulating liquid were adjusted as indicated in Table 1.

### Comparative Example 1

An insulating liquid composed only of the first liquid prepared in Example 1 above was used. That is, according to the present Example, an insulating liquid which did not contain the second liquid containing a fatty acid monoester as the main component, and an antioxidant, was used.

### Comparative Example 2

A liquid developer was prepared in the same manner as in Example 1 above, except that a polyester resin having a glass transition temperature of 80° C. and a softening temperature of 143° C. was used as the resin material composing the toner particles.

### Comparative Example 3

A liquid developer was prepared in the same manner as in Example 1 above, except that Isopar G was used as the insulating liquid.

With regard to the respective Examples and the respective Comparative Examples in the above, the constitution of the liquid developers, and the evaluation results for viscosity and electrical resistance are indicated in Table 1. In addition, the evaluation of viscosity in Table 1 was performed at a measuring temperature of 25° C., using an oscillatory viscometer (CBC Co., Ltd., VM-100A) according to JIS Z8809. Also, the Table 1 also indicates the values of X/Y, wherein X [wt %] represents the content of the fatty acid monoester component in the insulating liquid, and Y [wt %] represents the content of the fatty acid triglyceride component in the insulating liquid. Furthermore, in the table, PEs stands for polyester resin, st-ac stands for styrene-acrylic acid ester copolymer, OL stands for oleic acid, LN stands for linolic acid, LL stands for α-linoleic acid, ES stands for eleostearic acid, i-BuOH stands for isobutanol, and MeOH stands for methanol.

In addition, the viscosity and electrical resistance of the insulating liquid in Table 1 are indicated according to the following criteria of four grades:

### Viscosity

### A: 150 mPa·s or greater and 800 mPa·s or less (very good)

### B: 100 mPa·s or greater and 900 mPa·s or less (excluding 150 mPa·s or greater and 800 mPa·s or less) (good)

### C: 50 mPa·s or greater and 1000 mPa·s or less (excluding 100 mPa·s or greater and 900 mPa·s or less) (medium)

### D: less than 50 mP·s, or greater than 1000 mPa·s (bad)

### Electrical Resistance

### A: 1×10¹³ Ωcm or greater (very good)

### B: 1×10¹¹ Ωcm or greater and less than 1×10¹³ Ωcm (good)

### C: 1×10⁹ Ωcm or greater and less than 1×10¹¹ Ωcm (bad)

### D: less than 1×10⁹ Ωcm (very bad)

TABLE 1

| | Liquid Developer | | | | | | |
|---|---|---|---|---|---|---|---|
| | | | | Insulating Liquid | | | |
| | | | | Fatty acid monoester (second liquid) | | | |
| | | | | | Unsaturated | | |
| | Resin material | | | | fatty acid | | |
| | | Glass | | | component | | Content In |
| | | Transition | Softening | Oil or fat Used | (Increasing | Alcohol Species | Insulating |
| | | Temp. | Temp | as Raw | order in content | used | Liquid: X |
| | Type | [° C.] | [° C.] | material | from left) | Transesterification | [wt %] |
| Ex. 1 | PEs | 45 | 95 | Rapeseed oil | OL, LN, LL | i-BuOH | 34 |
| Ex. 2 | PEs | 30 | 87 | Rapeseed oil | OL, LN, LL | i-BuOH | 34 |
| Ex. 3 | PEs | 25 | 85 | Rapeseed oil | OL, LN, LL | i-BuOH | 34 |
| Ex. 4 | PEs | 60 | 126 | Rapeseed oil | OL, LN, LL | i-BuOH | 34 |
| Ex. 5 | PEs | 70 | 135 | Rapeseed oil | OL, LN, LL | i-BuOH | 34 |
| Ex. 6 | st-ac | 20 | 81 | Rapeseed oil | OL, LN, LL | i-BuOH | 34 |
| Ex. 7 | PEs | 45 | 95 | Rapeseed oil | OL, LN, LL | i-BuOH | 19 |
| Ex. 8 | PEs | 45 | 95 | Rapeseed oil | OL, LN, LL | i-BuOH | 54 |
| Ex. 9 | PEs | 45 | 95 | Rapeseed oil | OL, LN, LL | MeOH | 34 |
| Ex. 10 | PEs | 45 | 95 | Soybean oil | LN, OL, LL | i-BuOH | 34 |
| Ex. 11 | PEs | 45 | 95 | Dehydrated | LN, OL, LL | i-BuOH | 34 |
| | | | | castor oil | | | |
| Ex. 12 | PEs | 45 | 95 | Tung oil | ES, OL | i-BuOH | 34 |
| Ex. 13 | PEs | 45 | 95 | Linseed oil | LL, LN, OL | i-BuOH | 34 |
| Ex. 14 | PEs | 45 | 95 | Dehydrated | LN, OL, LL | i-BuOH | 34 |
| | | | | castor oil | | | |
| Ex. 15 | PEs | 45 | 95 | Rapeseed oil | OL, LN, LL | i-BuOH | 34 |
| Ex. 16 | PEs | 45 | 95 | Rapeseed oil | OL, LN, LL | MeOH | 34 |
| Ex. 17 | PEs | 45 | 95 | Soybean oil | LN, OL, LL | i-BuOH | 34 |
| Ex. 18 | PEs | 45 | 95 | Dehydrated | LN, OL, LL | i-BuOH | 34 |
| | | | | castor oil | | | |
| Ex. 19 | PEs | 45 | 95 | Tung oil | ES, OL | i-BuOH | 34 |
| Ex. 20 | PEs | 45 | 95 | Linseed oil | LL, LN, OL | i-BuOH | 34 |
| Ex. 21 | PEs | 30 | 87 | Rapeseed oil | OL, LN, LL | i-BuOH | 39 |
| Ex. 22 | PEs | 25 | 85 | Rapeseed oil | OL, LN, LL | i-BuOH | 29 |
| Ex. 23 | PEs | 60 | 126 | Rapeseed oil | OL, LN, LL | i-BuOH | 19 |
| Ex. 24 | PEs | 70 | 135 | Rapeseed oil | OL, LN, LL | i-BuOH | 9 |
| Ex. 25 | PEs | 45 | 95 | Rapeseed oil | OL, LN, LL | i-BuOH | 50 |
| Ex. 26 | PEs | 45 | 95 | Rapeseed oil | OL, LN, LL | i-BuOH | 1 |
| Comp. Ex. 1 | PEs | 45 | 95 | — | — | — | 0 |
| Comp. Ex. 2 | PEs | 80 | 143 | Rapeseed oil | OL, LN, LL | i-BuOH | 34 |
| Comp. Ex. 3 | PEs | 45 | 95 | — | — | — | — |

| | Liquid Developer | | | | | | | |
|---|---|---|---|---|---|---|---|---|
| | Insulating Liquid | | | | | | | |
| | Fatty acid triglyceride (first liquid) | | | | | | | |
| | | Unsaturated | | | | | | |
| | | Fatty acid | Content | | | | | |
| | | component | Of | | | | | |
| | | (Increasing | Saturated | Content In | | | | |
| | Oil or fat Used | Order in | Fatty | Insulating | | | | Electrical |
| | as Raw | Content | acid | Liquid: Y | | Iodine | Viscosity | resistance |
| | material | from Left) | [mol %] | [wt %] | X/Y | value | [mPa · S] | [Ωcm] |
| Ex. 1 | Rapeseed oil | OL, LN, LL | 7.5 | 65 | 0.52 | 100 | A | A |
| Ex. 2 | Rapeseed oil | OL, LN, LL | 7.5 | 65 | 0.52 | 100 | A | A |
| Ex. 3 | Rapeseed oil | OL, LN, LL | 7.5 | 65 | 0.52 | 100 | A | A |
| Ex. 4 | Rapeseed oil | OL, LN, LL | 7.5 | 65 | 0.52 | 100 | A | A |
| Ex. 5 | Rapeseed oil | OL, LN, LL | 7.5 | 65 | 0.52 | 100 | A | A |
| Ex. 6 | Rapeseed oil | OL, LN, LL | 7.5 | 65 | 0.52 | 100 | A | A |
| Ex. 7 | Rapeseed oil | OL, LN, LL | 7.5 | 80 | 0.24 | 100 | B | A |
| Ex. 8 | Rapeseed oil | OL, LN, LL | 7.5 | 45 | 1.20 | 100 | B | A |
| Ex. 9 | Rapeseed oil | OL, LN, LL | 7.5 | 65 | 0.52 | 100 | A | A |
| Ex. 10 | Soybean oil | LN, OL, LL | 14.0 | 65 | 0.52 | 120 | A | A |
| Ex. 11 | Dehydrated | LN, OL, LL | 2.0 | 65 | 0.52 | 140 | A | A |
| | castor oil | | | | | | | |
| Ex. 12 | Tung oil | ES, OL | 4.0 | 65 | 0.52 | 160 | A | A |
| Ex. 13 | Linseed oil | LL, LN, OL | 8.0 | 65 | 0.52 | 130 | A | A |
| Ex. 14 | Rapeseed oil | OL, LN, LL | 7.5 | 65 | 0.52 | 114 | A | A |
| Ex. 15 | Rapeseed oil | OL, LN, LL | 7.5 | 65 | 0.52 | 100 | A | A |
| Ex. 16 | Rapeseed oil | OL, LN, LL | 7.5 | 65 | 0.52 | 100 | A | A |
| Ex. 17 | Soybean oil | LN, OL, LL | 14.0 | 65 | 0.52 | 120 | A | A |
| Ex. 18 | Dehydrated | LN, OL, LL | 2.0 | 65 | 0.52 | 140 | A | A |
| | castor oil | | | | | | | |
| Ex. 19 | Tung oil | ES, OL | 4.0 | 65 | 0.52 | 160 | A | A |
| Ex. 20 | Linseed oil | LL, LN, OL | 8.0 | 65 | 0.52 | 130 | A | A |
| Ex. 21 | Rapeseed oil | OL, LN, LL | 7.5 | 60 | 0.65 | 100 | A | A |
| Ex. 22 | Rapeseed oil | OL, LN, LL | 7.5 | 70 | 0.41 | 100 | A | A |
| Ex. 23 | Rapeseed oil | OL, LN, LL | 7.5 | 80 | 0.23 | 100 | B | A |
| Ex. 24 | Rapeseed oil | OL, LN, LL | 7.5 | 90 | 0.10 | 100 | B | A |
| Ex. 25 | Rapeseed oil | OL, LN, LL | 7.5 | 50 | 1.00 | 100 | A | A |
| Ex. 26 | Rapeseed oil | OL, LN, LL | 7.5 | 98 | 0.01 | 100 | B | A |
| Comp. Ex. 1 | Rapeseed oil | OL, LN, LL | 7.5 | 99 | — | 100 | D | A |
| Comp. Ex. 2 | Rapeseed oil | OL, LN, LL | 7.5 | 65 | 0.52 | 100 | A | A |
| Comp. Ex. 3 | — | — | — | — | — | — | C | A |

### 2. Evaluation

With respect to each of the liquid developers obtained as described above, evaluation of the intensity of fixation, adaptability to high speed image formation, storage property and long-term stability was performed.

### 2.1. Intensity of Fixation

Using the image forming device as illustrated in FIG. 4, images of a predetermined pattern were formed on recording paper (Seiko Epson Corp., high quality paper LPCPPA4) with the respective liquid developers of the Examples and the Comparative Examples described above. Thereafter, thermal fixation of the images formed on the recording paper was performed in an oven. This thermal fixation was performed under the conditions of 100° C. for 1 minute.

Then, after confirming non-offset regions, an eraser (Lion Office Products Corp., sand erase “LION 261-11”) was rubbed twice against the fixed images on the recording paper under a pressing load of 1.0 kgf, and the residual ratios of the image concentration were measured by “X-Rite Model 404” manufactured by X-Rite Inc., to evaluate the fixed images according to the following criteria of five grades:

### A: image concentration residual ratio being 95% or greater (very good)

### B: image concentration residual ratio being 90% or greater and less than 95% (good)

### C: image concentration residual ratio being 80% or greater and less than 90% (medium)

### D: image concentration residual ratio being 70% or greater and less than 80% (bad)

### E: image concentration residual ratio being less than 70% (very bad)

### 2.2. Evaluation of Image Formation at High Speed

With regard to the images formed by an electrophotographic image forming device of liquid developing type as illustrated in FIG. 4 under the conditions of a set temperature for heat fixing roller of 100° C. and a printing speed of 50 sheets/min, the extent of image defects such as thin scratches or the like were evaluated by naked eyes, and the image concentrations of the formed images were respectively evaluated according to the following criteria of four grades: Image defects such as thin scratches or the like

### A: No image defects such as thin scratches or the like are recognized in the formed image

### B: Virtually no image defects such as thin scratches or the like are recognized in the formed image

### C: A few image defects such as thin scratches or the like are recognized in the formed image

### D: Obvious image defects such as thin scratches are recognized in the formed image

### Image Concentration

### A: image concentration of 1.5 or greater (very good)

### B: image concentration of 1.0 or greater and less than 1.5 (good)

### C: image concentration of 0.5 or greater and less than 1.0 (bad)

### D: image concentration of less than 0.5 (very bad).

### 2.3. Storage Property

The respective liquid developers obtained in the Examples and the Comparative Examples described above were left to stand for 6 months in an environment at a temperature of 20 to 28° C. Thereafter, the appearance of the toner in the liquid developers was confirmed by naked eyes, and was evaluated according to the following criteria of five grades:

### A: No floating and coagulation settling of toner particles are recognized

### B: Virtually no floating and coagulation settling of toner particles are recognized

### C: Slight floating or coagulation settling of toner particles is recognized, but within the scope of causing no problem with the liquid developer

### D: Obvious floating or coagulation settling of toner particles is recognized

### E: Marked floating and coagulation settling of toner particles are recognized.

### 2.4. Long-Term Stability

The respective liquid developers obtained in the Examples and the Comparative Examples described above were left to stand for 6 months in an environment at a relative humidity of 70%. Thereafter, the appearance of the liquid developer was observed and evaluated according to the following criteria of five grades:

### A: No thickening/discoloration of the liquid developer is recognized

### B: Virtually no thickening/discoloration of the liquid developer is recognized

### C: Slight thickening/discoloration of the liquid developer is recognized, but within the scope of causing no problem with the liquid developer

### D: Obvious thickening/discoloration of the liquid developer is recognized

### E: Marked thickening/discoloration of the liquid developer is recognized.

These results are presented in Table 2 together with the average degree of circularity R, standard deviation of the degree of circularity, average particle size based on particle number, and standard deviation of the particle size of the toner particles. In addition, the measurement of the degree of circularity was performed using a flow type particle image analyzer (To a Medical Electronics Co., Ltd., FPIA-2000). However, the degree of circularity R was taken as what is represented by the following Formula (I):

R=L₀/L₁ (I)

provided that L₁ [μm] represents the circumferential length of a projected image of the toner particles to be measured, and L₀ [μm] represents the circumferential length of a perfect circle having the same area as the area of the projected image of the particles to be measured.

TABLE 2

| | Evaluation | | | | |
|---|---|---|---|---|---|
| | | Adaptability to high | | | |
| | | speed image formation | | | |
| | | Image | | | |
| | | defects | | | |
| | Intensity | such | | | Long- |
| | of | as thin | Image | Storage | term |
| | fixation | scratches | concentration | property | stability |
| Ex. 1 | B | A | A | B | A |
| Ex. 2 | B | A | A | B | A |
| Ex. 3 | B | A | A | B | A |
| Ex. 4 | B | A | A | B | A |
| Ex. 5 | B | A | A | B | A |
| Ex. 6 | B | B | B | C | B |
| Ex. 7 | C | B | A | B | B |
| Ex. 8 | A | B | B | B | B |
| Ex. 9 | B | A | A | B | A |
| Ex. 10 | B | A | A | B | A |
| Ex. 11 | A | A | A | B | C |
| Ex. 12 | A | A | A | B | C |
| Ex. 13 | A | A | A | B | C |
| Ex. 14 | A | A | A | B | B |
| Ex. 15 | B | A | A | A | A |
| Ex. 16 | B | A | A | A | A |
| Ex. 17 | B | A | A | A | A |
| Ex. 18 | A | A | A | A | C |
| Ex. 19 | A | A | A | A | C |
| Ex. 20 | A | A | A | A | C |
| Ex. 21 | B | A | A | B | A |
| Ex. 22 | B | A | A | B | A |
| Ex. 23 | C | A | A | B | A |
| Ex. 24 | C | A | A | B | A |
| Ex. 25 | B | A | A | B | A |
| Ex. 26 | C | B | B | B | A |
| Comp. Ex. 1 | D | D | B | D | E |
| Comp. Ex. 2 | E | D | D | B | B |
| Comp. Ex. 3 | E | C | C | E | C |

As is obvious from Table 2, the liquid developer according to the invention had excellent low temperature fixability as well as excellent intensity of fixation. The liquid developer according to the invention also had excellent adaptability to high speed image formation. Moreover, as shown in Table 2, the liquid developer also good storage property and long-term stability.

Furthermore, evaluation of the intensity of fixation was performed as described above, after changing the fixing temperature in the evaluation of the intensity of fixation to 95° C., 90° C., 85° C. and 80° C., and the same results were obtained. From this, it is clear that the liquid developer according to the invention was appropriate for low temperature fixation.

With regard to the evaluation of image formation at a high speed, the transport speed of the recording medium of the fixing apparatus was increased from 50 sheets/min to 60 sheets/min, 70 sheets/min and 80 sheets/min. Evaluation of the intensity of fixation was performed as described above, and the same results were obtained. From this, it is clear that the liquid developer according to the invention is appropriate for high speed printing.

Also, the liquid developers obtained in Examples 15 to 20 had particularly excellent storage property.

To the contrast, satisfactory results could not be obtained with the liquid developers of the Comparative Examples 1 to 3.

Furthermore, preparation and evaluation of liquid developers were performed as described above, except that Pigment Red 122, Pigment Yellow 180 and carbon black (Degussa Corp., Printex L) were used in place of the cyan pigment as the colorant, and the same results as those described above were obtained.

Also, preparation and evaluation of liquid developers were performed as described above, except that the structure in the vicinity of the dry microparticle producing apparatus was changed from that of the configuration as illustrated in FIG. 3 to that of the configurations as shown in FIG. 7 to FIG. 10, and the same results as described above were obtained. In the dry microparticle producing apparatuses having head units as illustrated in FIG. 7 to FIG. 10, even when the diameter of the discharging unit was made smaller, and the concentration of the aqueous suspension relatively higher, discharging could be conducted favorably, and the same results as described above were obtained. Further, since an aqueous suspension of high concentration was used, the time taken for drying could be shortened, thus improving the productivity.

### 3. Preparation of Liquid Developer

### Example 27

### Preparation of Dry Microparticles

First, 80 parts by weight of a polyester resin (glass transition temperature: ? ° C., softening temperature: 99° C.) as the binding resin and 20 parts by weight of a cyan pigment (Dainichiseika Colour and Chemicals Mfg. Co., Ltd., Pigment Blue 15:3) as the colorant were prepared.

These components were mixed using a 20L type Henschel mixer to obtain a raw material for toner preparation.

Next, this raw material (mixture) was kneaded using a twin-screw kneading extruder as illustrated in FIG. 1.

The total length of the processing unit of the twin-screw kneading extruder was 160 cm.

The temperature of the raw material in the processing unit was set to be 105 to 115° C.

The speed of rotation of the screw was set to 120 rpm, and the rate of introduction of the raw material was set to 20 kg/hr.

The time required for the raw material to pass through the processing unit, which time is needed under such conditions, was about 4 minutes.

In addition, the kneading as described was performed by operating a vacuum pump connected to the processing unit via a deaerating vent, while deaerating the inside of the processing unit.

The raw material kneaded in the processing unit (kneading product) was extruded through the head unit to the outside of the twin-screw kneading extruder. The temperature of the kneading product inside the head unit was adjusted to be 130° C.

The kneading product thus extruded from the extrusion orifice of the twin-screw kneading extruder was cooled using a cooler as illustrated in FIG. 1. The temperature of the kneading product immediately after the cooling process was about 45° C.

The cooling rate of the kneading product was 9° C./sec. Also, the time required from the end of the kneading product to the end of the cooling process was 10 seconds.

The kneading product cooled as described was subjected to coarse pulverization to obtain a powder having an average particle size of 1.5 mm. The coarse pulverization of the kneading product was performed using a hammer mill.

Next, 100 parts by weight of the coarse pulverization product of the kneading product was added to 250 parts by weight of toluene, and the resultant was treated for 1 hour using a homogenizer (output power: 400 μA), to obtain a solution in which the polyester resin of the kneading product was dissolved. Also, the pigment was uniformly microdispersed in such solution.

Meanwhile, an aqueous liquid prepared by uniformly mixing 1 part by weight of sodium dodecylbenzenesulfonate as a dispersant, and 700 parts by weight of ion-exchanged water were was provided.

The aqueous liquid described above was agitated, while the speed of rotation was adjusted using a homomixer (Tokushu Kika Kogyo Co., Ltd.).

The solution (toluene solution of the kneading product) was added dropwise to the aqueous liquid which had been agitated. Thus, an aqueous emulsion in which a dispersoid having an average particle size of 3 μm is uniformly dispersed could be obtained.

Thereafter, under the conditions such as at a temperature of 100° C. and a pressure of 80 kPa, toluene in the aqueous emulsion was removed, the resultant was cooled to room temperature, and then a predetermined amount of water was added to adjust the concentration, thereby to obtain an aqueous suspension having solid microparticles dispersed therein. The obtained aqueous suspension did not substantially have any toluene remaining. The solid component (dispersoid) concentration in the resulting aqueous suspension was 28.8% by weight. Also the average particle size of the dispersoid (solid microparticles) dispersed in the suspension was 1.4 μm. In addition, the measurement of the average particle size of the dispersoid was performed using a laser diffraction/scattering particle size distribution measuring apparatus (Horiba Seisakusho Co., Ltd., LA-920).

The suspension thus obtained was introduced into the aqueous suspension supplying unit of a dry microparticle producing apparatus having the configuration illustrated in FIG. 2 and FIG. 3. The aqueous suspension in the aqueous suspension supplying unit was supplied to the head unit by a metering pump while agitating with an agitator, to discharge (jet) from the discharging unit to the dispersion medium removing unit. The discharging unit was made to have a circular shape with a diameter of 25 μm. For the head unit, one subjected to hydrophobization treatment by a fluororesin (polytetrafluoroethylene) coating was used in the vicinity of the discharging unit. In addition, the temperature of the aqueous suspension inside the aqueous suspension supplying unit was adjusted to be 25° C.

The discharge of the aqueous suspension was performed in a state that the temperature of the dispersion in the head unit was adjusted to 25° C., the frequency of the piezoelectric body to 10 kHz, the initial speed of the dispersion discharged from the discharging unit to 3 m/sec, and the amount of discharge of one droplet of the aqueous suspension discharged from the head unit to 4 pl (particle size: 20.8 μm). The discharge of the aqueous suspension was performed such that the discharge timing of the aqueous suspension was different in at least adjacent head units among a plurality of head units.

Furthermore, upon discharging the aqueous suspension, an air having a temperature of 25° C., a humidity of 27% RH and a flow rate of 3 m/sec was jetted out vertically downwards from a gas jet orifice. Also, the temperature inside the housing was set to be 45° C. The pressure inside the housing was about 1.5 kPa. The length of the dispersion medium removing unit (length in the transport direction) was about 1.0 m.

A voltage was applied to the housing of the dispersion medium removing unit so that the potential on the inner surface side was −200 V, thus to prevent adhesion of the aqueous suspension (dry microparticles) to the inner wall.

The dispersion medium was removed from the discharged aqueous suspension inside the dispersion medium removing unit, so that a plurality of dry microparticles (toner particles) were formed to have shapes and sizes corresponding to the respective dispersoids.

The dry microparticles formed in the dispersion medium removing unit were recovered from a cyclone to obtain the dry microparticles.

### Encapsulation of Oxidative Polymerization Promoter

Meanwhile, an encapsulated oxidative polymerization promoter was prepared as follows.

First, 10 g of zinc octoate as an oxidative polymerization promoter was dissolved in 15 mL of acetone, and the resulting solution was adsorbed to a porous hydrophilic silica gel to obtain a core material.

Next, 10 g of the obtained core material and 20 g of polyethylene glycol (PEG) were mixed with heating to obtain a mixture.

Next, this mixture was added to 400 mL of Solvent AF6 manufactured by Nippon Mitsubishi Oil Corp. and dispersed sufficiently in a homomixer, and then the dispersion was gradually cooled to deposit PEG.

Thereafter, the solvent was removed by filtration to obtain an encapsulated oxidative polymerization promoter.

### Preparation of Insulating Liquid

Meanwhile, an insulating liquid containing a fatty acid monoester and a fatty acid triglyceride was obtained as follows.

First, preparation of a liquid containing a fatty acid triglyceride will be described.

As described above, the fatty acid triglyceride is contained in large amounts in naturally occurring oils and fats, and can be removed of the impurities contained in unpurified oils and fats, by mixing the unpurified oils and fats with boiling water, separating the liquid d mixture completely into three layers, and then removing frozen components in a freezer (hereinafter, this process may be also referred to as “purification of oils and fats”). According to the present Example (including all the Examples and Comparative Examples to be described later), the impurities contained in the oils and fats were removed more assuredly by repeating the purification of the oils and fats several times.

According to the present Example, rapeseed oil was used as the oil and fat. The rapeseed oil purified using the above-described method mainly has unsaturated fatty acid components such as oleic acid, linolic acid, α-linoleic acid and the like, and saturated fatty acid components such as palmitic acid, stearic acid and the like. The rapeseed oil was composed mainly of fatty acid triglycerides (hereinafter, may also referred to as “first liquid”). The content of the fatty acid triglyceride contained in the first liquid thus obtained was 99.9% by weight or greater.

Next, preparation of a liquid containing a fatty acid monoester will be described.

A liquid composed mainly of fatty acid monoesters was obtained by performing a transesterification reaction between purified rapeseed oil and isobutanol, and removing the glycerin generated from this reaction. Also, a liquid having a content of the fatty acid monoesters of 99.9% by weight or greater was obtained by purifying the liquid. The fatty acid monoesters thus obtained were mainly composed of fatty acid monoesters having unsaturated fatty acid monoester such as isobutyl oleate, isobutyl linolate, isobutyl α-linoleate and the like, and saturated fatty acid monoesters such as isobutyl palmitate, isobutyl stearate and the like (hereinafter, may also be referred to as “second liquid”).

The first liquid and the second liquid thus obtained were mixed to obtain a liquid mixture containing fatty acid monoesters and fatty acid triglycerides. Thereafter, 500 parts by weight of the liquid mixture and 5 parts by weight of ascorbic acid stearate acid ester as an antioxidant (thermal decomposition temperature: 300° C. or higher) were mixed to obtain an insulating liquid. Moreover, during mixing the first liquid and the second liquid, the content of the fatty acid triglycerides was adjusted to 65% by weight, based on the whole insulating liquid. The value of X/Y was 0.52, wherein Y [wt %] represented the content of the fatty acid triglyceride component in the obtained insulating liquid, and X [wt %] similarly represented the content of the fatty acid monoester component. Also, the electrical resistance of the obtained insulating liquid at room temperature (20° C.) was 6.8×10¹⁴ Ωcm.

### Dispersion of Dry Microparticles and Oxidative Polymerization Promoter

505 parts by weight of the insulating liquid obtained as described above, 1 part by weight of a surfactant (dodecyltrimethylammonium chloride), 1.25 parts by weight of an encapsulated oxidative polymerization promoter (1 part by weight in terms of the oxidative polymerization promoter), and 75 parts by weight of the dry microparticles were mixed with stirring for 10 minutes with a homomixer (Tokushu Kika Kogyo Co., Ltd.), to obtain a liquid developer. The viscosity of the liquid developer thus obtained was 160 mPa·s.

### Examples 28 and 29

Liquid developers were prepared in the same manner as in Example 27 above, except that the contents of the fatty acid triglycerides and the fatty acid monoesters in the insulating liquid were adjusted, and the content of the fatty acid triglycerides was adjusted as indicated in Table 3.

### Example 30

A liquid developer was prepared in the same manner as in Example 27 above, except that during preparing the second liquid according to the above Example 27, methanol was used in place of isobutanol to induce a transesterification reaction with purified rapeseed oil, thus to obtain a liquid containing fatty acid monoesters as the main component. In addition, the fatty acid monoesters contained in the second liquid according to the present Example 2 were fatty acid monoesters mainly having unsaturated fatty acid monoesters such as methyl oleate, methyl linolate, methyl α-linoleate and the like, and saturated fatty acid monoesters such as methyl palmitate, methyl stearate and the like.

### Example 31

During the preparation of an insulating liquid, a first liquid was prepared by the same method as described in Example 1 above, using soybean oil was used in place of rapeseed oil as the oil and fat, and the second liquid was obtained from a liquid generated from a transesterification reaction by adding methanol to purified soybean oil. A liquid developer was prepared in the same manner as in Example 27 above, except that these first liquid and second liquid were used to adjust the contents of the fatty acid triglyceride as indicated in Table 3.

### Examples 32 and 33

A liquid developer was prepared in the same manner as in Example 31 above, except that the contents of the fatty acid monoesters and fatty acid triglycerides in the insulating liquid were adjusted, and the content of the fatty acid triglycerides was adjusted as indicated in Table 3.

### Example 34

A liquid developer was prepared in the same manner as in Example 32 above, except that an epoxy resin (glass transition temperature: ?° C., softening temperature 128° C.) was used in place of the polyester resin (glass transition temperature: ?° C., softening temperature 99° C.) as the binding resin.

### Example 35

A liquid developer was prepared in the same manner as in Example 28 above, except that the same fatty acid monoesters as those used in Example 34 above as the fatty acid monoester. That is, the fatty acid monoester used in the present Example were different from those that are prepared from a liquid obtained from a transesterification reaction of the fatty acid triglycerides of the present Example.

### Example 36

A first liquid composed of the same fatty acid triglycerides as those used in Example 27 above as the fatty acid triglyceride, and dry microparticles (toner particles) were mixed with stirring for 20 minutes with a homomixer. Then, the other components which constitute a liquid developer were added thereto, and the resultant was further mixed with stirring for 10 minutes in the homomixer, to obtain a liquid developer as indicated in Table 3.

### Example 37

A first liquid composed of the same fatty acid triglycerides as those used in Example 31 above as the fatty acid triglyceride, and dry microparticles (toner particles) were mixed with stirring for 20 minutes with a homomixer. Then, the other components which constitute a liquid developer were added thereto, and the resultant was further mixed with stirring for 10 minutes in the homomixer, to obtain a liquid developer as indicated in Table 3.

### Example 38

A second liquid composed of the same fatty acid monoesters as those used in Example 29 above as the fatty acid monoester, and dry microparticles (toner particles) were mixed with stirring for 10 minutes with a homomixer. Then, the other components which constitute a liquid developer were added thereto, and the resultant was further mixed with stirring for 10 minutes in the homomixer, to obtain a liquid developer as indicated in Table 3.

### Comparative Example 4

As the insulating liquid, one composed only of the first liquid prepared in Example 27 above was used. That is, in the present embodiment, one which did not contain the second liquid containing fatty acid monoesters as the main component, and an antioxidant in the insulating liquid was used.

### Comparative Example 5

A liquid developer was prepared in the same manner as in Example 27 above, except that Isopar G was used as the insulating liquid.

With regard to the respective Examples and respective comparative Examples in the above, the constitution of the liquid developers, and the evaluation results for viscosity and electrical resistance are indicated in Table 3. In addition, the evaluation of viscosity in the Table 3 was performed at a measuring temperature of 25° C., using an oscillatory viscometer (CBC Co., Ltd., VM-100A) according to JIS Z8809. Also, the Table 3 also indicates the values of X/Y, wherein X [wt %] represents the content of the fatty acid triglyceride component in the insulating liquid, and Y [wt %] represents the content of the fatty acid monoester component in the insulating liquid. Furthermore, in the table, PEs stands for polyester resin, EP stands for epoxy resin, OL stands for oleic acid, LN stands for linolic acid, LL stands for α-linoleic acid, i-BuOH stands for isobutanol, and MeOH stands for methanol.

In addition, the viscosity and electrical resistance of the insulating liquid are indicated according to the following criteria of four grades:

### Viscosity

### A: 150 mPa·s or greater and 900 mPa·s or less (very good)

### B: 100 mPa·s or greater and 1000 mPa·s or less (excluding 150 mPa·s or greater and 900 mPa·s or less) (good)

### C: 50 mPa·s or greater and 1200 mPa·s or less (excluding 100 mPa·s or greater and 1000 mPa·s or less) (medium)

### D: less than 50 mPa·s, or greater than 1200 mPa·s (bad)

### Electrical Resistance

### A: 1×10¹³ Ωcm or greater (very good)

### B: 1×10¹¹ Ωcm or greater and less than 1×10¹³ Ωcm (good)

### C: 1×10⁹ Ωcm or greater and less than 1×10¹¹ Ωcm (bad)

### D: less than 1×10⁹ Ωcm (very bad)

TABLE 3

| | Liquid developer | | | | | | | |
|---|---|---|---|---|---|---|---|---|
| | | | | Insulating liquid | | | | |
| | Resin material | | | Fatty acid triglyceride (1^{st} liquid) | | | Fatty acid monoester (2^{nd} liquid) | |
| | | Glass | | | Unsaturated fatty | Content In | | Unsaturated fatty |
| | | Transition | Softening | Oil and fat | acid component | Insulating | Oil and fat | acid component |
| | | Temp. | Temp. | Used as Raw | (Increasing order in | Liquid: Y | Used as Raw | (Increasing order in |
| | Type | [° C.] | [° C.] | material | content from left) | [wt %] | material | content from Left) |
| Ex. 27 | PEs | | 99 | Rapeseed oil | OL, LN, LL | 65.0 | Rapeseed oil | OL, LN, LL |
| Ex. 28 | PEs | | 99 | Rapeseed oil | OL, LN, LL | 60.0 | Rapeseed oil | OL, LN, LL |
| Ex. 29 | PEs | | 99 | Rapeseed oil | OL, LN, LL | 80.0 | Rapeseed oil | OL, LN, LL |
| Ex. 30 | PEs | | 99 | Rapeseed oil | OL, LN, LL | 65.0 | Rapeseed oil | OL, LN, LL |
| Ex. 31 | PEs | | 99 | Soybean oil | LN, OL, LL | 70.0 | Soybean oil | LN, OL, LL |
| Ex. 32 | PEs | | 99 | Soybean oil | LN, OL, LL | 65.0 | Soybean oil | LN, OL, LL |
| Ex. 33 | PEs | | 99 | Soybean oil | LN, OL, LL | 75.0 | Soybean oil | LN, OL, LL |
| Ex. 34 | EP | | 128 | Soybean oil | LN, OL, LL | 65.0 | Soybean oil | LN, OL, LL |
| Ex. 35 | PEs | | 99 | Rapeseed oil | OL, LN, LL | 60.0 | Soybean oil | LN, OL, LL |
| Ex. 36 | PEs | | 99 | Rapeseed oil | OL, LN, LL | 65.0 | Rapeseed oil | OL, LN, LL |
| Ex. 37 | PEs | | 99 | Soybean oil | LN, OL, LL | 70.0 | Soybean oil | LN, OL, LL |
| Ex. 38 | PEs | | 99 | Rapeseed oil | OL, LN, LL | 55.0 | Rapeseed oil | OL, LN, LL |
| Comp. Ex. 4 | PEs | | 99 | Rapeseed oil | OL, LN, LL | 100 | — | — |
| Comp. Ex. 5 | PEs | | 99 | — | — | — | — | — |

| | Liquid developer | | | | |
|---|---|---|---|---|---|
| | Insulating liquid | | | | |
| | Fatty acid monoester (2^{nd} liquid) | | | | |
| | | Content In | | | |
| | | Insulating | | | Electrical |
| | Alcohol Species used | Liquid: X | | Viscosity | resistance |
| | Transesterification | [wt %] | X/Y | [mPa · S] | [Ωcm] |
| Ex. 27 | i-BuOH | 34.0 | 0.52 | A | A |
| Ex. 28 | i-BuOH | 39.0 | 0.65 | A | A |
| Ex. 29 | i-BuOH | 19.0 | 0.24 | A | A |
| Ex. 30 | MeOH | 34.0 | 0.52 | A | A |
| Ex. 31 | MeOH | 29.0 | 0.41 | A | A |
| Ex. 32 | MeOH | 34.0 | 0.52 | A | A |
| Ex. 33 | MeOH | 24.0 | 0.32 | A | A |
| Ex. 34 | MeOH | 34.0 | 0.52 | A | A |
| Ex. 35 | MeOH | 39.0 | 0.65 | A | A |
| Ex. 36 | i-BuOH | 34.0 | 0.52 | A | A |
| Ex. 37 | MeOH | 29.0 | 0.41 | A | A |
| Ex. 38 | i-BuOH | 44.0 | 0.80 | B | A |
| Comp. Ex. 4 | — | 0 | 0 | B | A |
| Comp. Ex. 5 | — | 0 | — | C | A |

### 4. Evaluation

With respect to each of the liquid developers obtained as described above, evaluation of the intensity of fixation, adaptability to high speed image formation, storage property and long-term stability was performed.

### 4.1. Intensity of Fixation

Using the image forming device as illustrated in FIG. 4, images of a predetermined pattern were formed on recording paper (Seiko Epson Corp., high quality paper LPCPPA4) with the respective liquid developers of the Examples and the Comparative Examples described above. Thereafter, thermal fixation of the images formed on the recording paper was performed in an oven. This thermal fixation was performed under the conditions of 100° C. for 1 minute.

Then, after confirming non-offset regions, an eraser (Lion Office Products Corp., sand erase “LION 261-11”) was rubbed twice against the fixed images on the recording paper under a pressing load of 1.0 kgf, and the residual ratios of the image concentration were measured by “X-Rite Model 404” manufactured by X-Rite Inc., to evaluate the fixed images according to the following criteria of four grades:

### A: image concentration residual ratio being 90% or greater (very good)

### B: image concentration residual ratio being 80% or greater and less than 90% (good)

### C: image concentration residual ratio being 70% or greater and less than 80% (bad)

### D: image concentration residual ratio being less than 70% (very bad)

### 4.2. Evaluation of Image

With regard to the images formed by an electrophotographic image forming device of liquid developing type as illustrated in FIG. 4 under the conditions of a set temperature for heat fixing roller of 160° C. and a printing speed of 50 sheets/min, the extent of image defects such as thin scratches or the like were evaluated by naked eyes, and the image concentrations of the formed images were respectively evaluated according to the following criteria of four grades: Image defects such as thin scratches or the like

### A: No image defects such as thin scratches or the like are recognized in the formed image

### B: Virtually no image defects such as thin scratches or the like are recognized in the formed image

### C: A few image defects such as thin scratches or the like are recognized in the formed image

### D: Obvious image defects such as thin scratches are recognized in the formed image

### Image Concentration

### A: image concentration of 1.5 or greater (very good)

### B: image concentration of 1.0 or greater and less than 1.5 (good)

### C: image concentration of 0.5 or greater and less than 1.0 (bad)

### D: image concentration of less than 0.5 (very bad).

### 4.3. Storage Property

The respective liquid developers obtained in the Examples and the Comparative Examples described above were left to stand for 6 months in an environment at a temperature of 40 to 45° C. Thereafter, the appearance of the toner in the liquid developers was confirmed by naked eyes, and was evaluated according to the following criteria of four grades:

### A: No floating and coagulation settling of toner particles are recognized

### B: Virtually no floating and coagulation settling of toner particles are recognized

### C: Slight floating or coagulation settling of toner particles is recognized

### D: Obvious floating or coagulation settling of toner particles is recognized.

### 4.4. Long-Term Stability

The respective liquid developers obtained in the Examples and the Comparative Examples described above were left to stand for 6 months in an environment at 35° C. and at a relative humidity of 70%. Thereafter, the appearance of the liquid developer was observed and evaluated according to the following criteria of four grades:

### A: No thickening/discoloration of the liquid developer is recognized.

### B: Virtually no thickening/discoloration of the liquid developer is recognized.

### C: Slight thickening/discoloration of the liquid developer is recognized, but within the scope of causing no problem with the liquid developer.

### D: Obvious thickening/discoloration of the liquid developer is recognized.

### 4.5. Effect of Liquid Developer on Image Forming Device Members (Members in Contact with Insulating Liquid)

Part of the members of an image forming device as illustrated in FIG. 4 were left to stand in a state of being immersed in the respective liquid developers obtained in the Examples and Comparative Examples described above, in an environment at a temperature of 20 to 28° C. for 6 months. Thereafter, the respective surfaces of the members were confirmed by naked eyes and evaluated according to the following criteria of four grades.

In the evaluation, a developing roller composed of nitrile-butadiene rubber was used as the image forming device member:

### A: No swelling or erosion is recognized in the vicinity of the member surface.

### B: Virtually no swelling or erosion is recognized in the vicinity of the member surface.

### C: Slight swelling or erosion is recognized in the vicinity of the member surface.

### D: Obvious swelling or erosion is recognized in the vicinity of the member surface.

These results are presented in Table 4 together with the average degree of circularity R, standard deviation of the degree of circularity, average particle size based on particle number, and standard deviation of the particle size of the toner particles. In addition, the measurement of the degree of circularity was performed using a flow type particle image analyzer (To a Medical Electronics Co., Ltd., FPIA-2000). However, the degree of circularity R was taken as what is represented by the following Formula (I):

R=L₀/L₁ (I)

provided that L₁ [μm] represents the circumferential length of a projected image of the toner particles to be measured, and L₀ [μm] represents the circumferential length of a perfect circle having the same area as the area of the projected image of the particles to be measured.

TABLE 4

| | | | | | Evaluation | | | | | |
|---|---|---|---|---|---|---|---|---|---|---|
| | | | | | | Image evaluation | | | | |
| | | Standard | Average | Standard | | Image | | | | Immersion |
| | Average | deviation of | particle | deviation of | Intensity | defects | | | | evaluation |
| | Degree Of | degree of | size | particle size | of | such as thin | Image | Storage | Long-term | of image forming |
| | circularity R | circularity | [μm] | [μm] | fixation | scratches etc. | concentration | property | stability | device member |
| Ex. 27 | 0.97 | 0.01 | 1.4 | 0.21 | A | A | A | A | A | A |
| Ex. 28 | 0.96 | 0.01 | 1.4 | 0.21 | A | A | A | A | A | A |
| Ex. 29 | 0.97 | 0.01 | 1.4 | 0.21 | B | A | B | B | B | A |
| Ex. 30 | 0.97 | 0.01 | 1.4 | 0.21 | A | A | A | A | A | A |
| Ex. 31 | 0.97 | 0.01 | 1.4 | 0.21 | A | A | A | A | A | A |
| Ex. 32 | 0.97 | 0.01 | 1.4 | 0.21 | A | A | A | A | A | A |
| Ex. 33 | 0.97 | 0.01 | 1.4 | 0.21 | A | B | B | A | A | A |
| Ex. 34 | 0.97 | 0.01 | 1.4 | 0.21 | B | B | B | B | B | A |
| Ex. 35 | 0.97 | 0.01 | 1.4 | 0.21 | A | A | A | B | B | A |
| Ex. 36 | 0.97 | 0.01 | 1.4 | 0.21 | A | A | A | A | A | A |
| Ex. 37 | 0.97 | 0.01 | 1.4 | 0.21 | A | A | A | A | A | A |
| Ex. 38 | 0.97 | 0.01 | 1.4 | 0.21 | A | B | A | A | A | B |
| Comp. Ex. 4 | 0.97 | 0.01 | 1.4 | 0.21 | D | D | B | D | D | B |
| Comp. Ex. 5 | 0.97 | 0.01 | 1.4 | 0.21 | D | C | C | D | B | C |

As is obvious from Table 4, the liquid developer according to the invention had excellent intensity of fixation, storage property and long-term stability. Also, in the Table 4, among the Examples with excellent results for evaluation of images (resolution, image concentration), Example 36 and Example 37 resulted in images obtained by the image forming device, which were particularly clear. Moreover, particularly excellent storage property was recognized in these Examples such that, when evaluating the storage property of the liquid developers, an evaluation at a low temperature (5 to 10° C.) was performed but no coagulation settling was recognized even after 6 months of standing. Also, in Example 38, the intensity of fixation was particularly excellent. Furthermore, an evaluation of the liquid contacting property of image forming device members was performed, and as a result, the member immersed in the liquid developer according to the invention was not recognized to have swelling or the like even after 6 months of standing, with no deterioration of the member such as weakening of the strength due to erosion, or the like being not recognized. Therefore, the liquid developer according to the invention performs stabilized image formation for a long time, and thus is considered to be favorably adaptable. To the contrast, the liquid developers of Comparative Examples 4 and 5 did not give satisfactory results.

Furthermore, as is obvious from Table 4, all of the liquid developers according to the invention had toner particles of large degrees of circularity and small widths of particle size distribution. The differences in the shape of the toner particles (standard deviation of the degree of circularity) were also small.

Also, liquid developers were prepared and evaluated as described above, except that Pigment Red 122, Pigment Yellow 180 and carbon black (Degussa Corp., Printex L) were used instead of the cyan pigment as the colorant, and the same results as described above were obtained.

Liquid developers were prepared and evaluated as described above, except that the structure in the vicinity of the head unit of the dry microparticle producing apparatus was changed from that of the configuration as illustrated in FIG. 3 to that of the configurations as illustrated in FIG. 7 to FIG. 10, and the same results as described were obtained. Also, in the dry microparticle producing apparatus having head units as illustrated in FIG. 7 to FIG. 10, even when the diameter of the discharging unit was made smaller, and the concentration of the aqueous suspension relatively higher, discharging could be conducted favorably, and the same results as described above were obtained. Further, since an aqueous suspension of high concentration was used, the time taken for drying could be shortened, thus improving the productivity.

### 5. Preparation of Liquid Developer

### Example 39

### Preparation of Liquid Composing Insulating Liquid

A liquid containing a fatty acid methyl ester to be used as the insulating liquid was prepared as follows.

First, crude soybean oil was purified as follows to obtain purified soybean oil.

First, crude soybean oil was subjected to crude purification by a low temperature crystallization method using methanol, diethyl ether, petroleum ether, acetone or the like as the solvent.

Next, 300 parts by volume of the roughly purified crude soybean oil (first roughly purified oil) was introduced into a flask, and then 100 parts by volume of boiling water was poured into the flask, which was then stopped.

Next, the flask was shaken to mix the roughly purified soybean oil (first roughly purified oil) and boiling water.

Next, the flask was left to stand until the liquid mixture in the flask underwent separation to three layers.

After confirming complete separation, the flask was transferred to a freezer and was left to stand for 24 hours.

Thereafter, unfrozen components were transferred to another flask.

These unfrozen components were repeatedly subjected to the operation described above, and the resulting unfrozen components were removed to obtain crude oil and fat (second roughly purified oil).

Next, 100 parts by volume of the crude oil and fat (second roughly purified oil) obtained as described above, and ±parts by volume of activated white clay mainly composed of hydrated aluminum silicate were mixed and agitated in a flask.

Then, the resulting mixture was stored under pressure (0.18 MPa) for 48 hours to completely precipitate the activated white clay.

Thereafter, the precipitate was removed, and purified soybean oil (hereinafter, simply referred to as soybean oil) was obtained. In addition, the soybean oil mainly contained fatty acid triglycerides having linolic acid as the main component, and the content of the unsaturated fatty acid triglycerides contained in the soybean oil was 98% by weight. The linolic acid component occupied 53% by mole of the total fatty acid components.

Next, a portion of this soybean oil was subjected to a transesterification reaction with methanol, and glycerin generated by this reaction was removed to obtain a liquid composed mainly of fatty acid monoesters. In addition, by purifying this liquid, a soybean oil fatty acid methyl having a content of the fatty acid monoester of 99.9% by weight or greater was obtained. The fatty acid monoester thus obtained was mainly composed of unsaturated fatty acid monoesters such as methyl oleate, methyl linolate, methyl α-linoleate and the like, and saturated fatty acid monoesters such as methyl palmitate, methyl stearate and the like, while the content of the fatty acid monoester of the unsaturated fatty acid therein was 84%.

### Preparation of Colorant Master Solution

First a mixture (weight ratio 50:50) of a polyester resin (softening temperature: 125° C., glass transition temperature: 60.5° C., and acid number: 7.7) and a cyan pigment (Dainichiseika Color & Chemicals Mfg. Co., Ltd., Pigment Blue 15:3) as a colorant was provided. These components were mixed using a 20L type Henschel mixer to obtain a raw material for toner preparation.

Next, this raw material (mixture) was kneaded using a twin-screw kneading extruder. The kneading product extruded through the extrusion orifice of the twin-screw kneading extruder was cooled.

The kneading product thus cooled was subjected to coarse pulverization to obtain a powder having an average particle size of 1.0 mm or less. The coarse pulverization of the kneading product was performed using a hammer mill.

Methyl ethyl ketone was added so that the content of the solid components in the resulting powder of the kneading product became 30% by weight, and the resultant was subjected to wet dispersion with an Aiger motor mill (Aiger US, Inc., M-1000), thus to prepare a colorant master solution.

### Preparation of Resin Solution

200 parts by weight of methyl ethyl ketone and 73 parts by weight of the above-described polyester resin were added to 33 parts by weight of the colorant master solution, and the resultant was mixed with an Aiger motor mill (Aiger US, Inc., M-1000) to prepare a resin solution. In addition, the pigment was uniformly microdispersed in this solution.

### Preparation of Aqueous Emulsion

In a 2-L cylindrical separable flask having a Maxblend stirring blade, 500 parts by weight of the resin solution and 45.5 parts by weight of methyl ethyl ketone were introduced, and the content of the solid components in the resin solution was adjusted to 55%.

Then, 41.7 parts by weight of 1 Normal aqueous ammonia (molar equivalent ratio with respect to the total amount of the carboxyl group carried by the polyester resin is 1.1) was added to the resin solution in the flask, and was sufficiently stirred by a Three One Motor (Shinto Scientific Co., Ltd.), with the speed of rotation of the stirring blade set at 210 rpm (peripheral speed of the stirring blade: 0.71 m/s). Thereafter, while maintaining the stirring, 133 parts by weight of deionized water was added. The temperature of the solution inside the flask was adjusted to 25° C., and stirring was continued. 133 parts by weight of deionized water was added dropwise to the resin solution to induce phase inversion emulsification, thus to obtain an aqueous emulsion in which a dispersoid containing the resin material was dispersed.

### Preparation of Associated Particles by Association

Next, while continuing the stirring in the flask, 285 parts by weight of deionized water was added so that the total amount of 1 Normal aqueous ammonia and water in the aqueous emulsion became 593 parts by weight. Subsequently, 2.6 parts by weight of Emal O (Kao Corp.), an anionic emulsifier, was diluted in 30 parts of deionized water, and the resultant was added to the aqueous emulsion.

Thereafter, while maintaining the temperature of the aqueous emulsion at 25° C., 300 parts by weight of a 3.5% aqueous solution of ammonium sulfate was added dropwise at a speed of rotation of the stirring of 150 rpm (peripheral speed of the stirring blade: 0.54 m/s), and the particle size of the association product of the dispersoid was adjusted to 3.5 μm. After the dropwise addition, stirring was continued until the particle size of the association product of the dispersoid increased to 5.0 μm, and the association operation was terminated.

The resulting association product dispersion was dried by distilling off the organic solvent under reduced pressure, to obtain associated particles.

In addition, the average particle sizes of the respective particles in the Examples and Comparative Examples were volume-based average particle sizes, and the average particle size and particle size distribution of these particles were measured by a Mastersizer 2000 particle analyzer (Malvern Instruments, Ltd.).

### Preparation of Liquid Developer

40 parts by weight of the associated particles thus obtained, 60 parts by weight of soybean oil fatty acid methyl, 100 parts by weight of Cosmo White P-60 (Idemitsu Kosan Co., Ltd., viscosity: about 15 mPa·s) as an aliphatic hydrocarbon liquid, 1 part by weight of a polyamine aliphatic polycondensation product (Lubrizol Japan, Ltd., trade name “Solsperse 11200”), and 0.5 parts by weight of aluminum stearate (Nippon Oils and Fats Corp.) were introduced into a ceramic pot (internal capacity 600 ml), and zirconium oxide balls (ball diameter: 1 mm) were further introduced into the ceramic pot to a volumetric filling ratio of 30%. Disintegration was performed for 200 hours with a bench pot mill at a speed of rotation of 220 rpm (1/min), and the dispersion in the pot was separated from the zirconium oxide balls to obtain a liquid developer.

In the resulting liquid developer, the average particle size of the toner particles was 1.5 μm, and the standard deviation of the particle size among the toner particles was 0.49 μm. The viscosity of the liquid developer as measured according to JIS Z8809 using an oscillatory viscometer at 25° C. was 288 mPa·s. The electrical resistance of the liquid developer was 1.06×10¹³ Ωcm.

### Example 40

A liquid developer was prepared in the same manner as in Example 39 above, except that a silicone oil KF96 (Shin-Etsu Silicones Co., Ltd., viscosity: 100 mPa·s) was used instead of the Cosmo White P-60 as the insulating liquid, and a polyester resin (softening point: 116° C., glass transition temperature: 61° C., acid number: 9.0) was used as the resin material.

### Example 41

Rapeseed oil fatty acid methyl having a content of fatty acid monoester of 99.9% by weight or more was prepared in the same manner as in Example 39 above, using rapeseed oil instead of soybean oil as the plant oil. The fatty acid monoester thus obtained was composed mainly of unsaturated fatty acid monoesters such as mainly methyl oleate, methyl linolate and the like, and saturated fatty acid monoesters such as methyl palmitate, methyl stearate and the like, and the content of the fatty acid monoester of the unsaturated fatty acid therein was 83%.

Hereinafter, a liquid developer was prepared in the same manner as in Example 39 above, except that a polyester resin (softening temperature: 98° C., glass transition temperature: 43° C.) was used as the resin material, and rapeseed oil fatty acid methyl was used instead of soybean oil fatty acid methyl.

### Examples 42 to 53

Liquid developers were prepared in the same manner as in Example 39, except that the resin material and the insulating liquid were changed to the compositions indicated in Table 5.

### Comparative Example 6

Preparation of a colorant master was attempted using a polyester resin (softening temperature: 75° C., glass transition temperature: 12° C.) as the resin material under the same conditions as those in Example 1, using a twin-screw kneading extruder. The resulting colorant master was not found to have the pigment and resin material uniformly dispersed. Thus, the same materials were used and kneaded using an open-roll type kneading machine (Kneadex, Mitsui Mining Co., Ltd.), to obtain a colorant master.

Hereinafter, a liquid developer was prepared in the same manner as in Example 39, except that the insulating liquid was changed to the composition indicated in Table 5.

### Comparative Examples 7 to 9

Liquid developers were prepared in the same manner as in Example 39, except that the resin material and the insulating liquid were changed to the compositions indicated in Table 5.

With regard to the respective Examples and respective Comparative Examples in the above, the compositions of the liquid developers, and the evaluation results for viscosity and electrical resistance are presented in Table 5. In addition, the evaluation of the viscosities in Table 5 was performed under the conditions of a measuring temperature of 25° C. using an oscillatory viscometer (CBC Co., Ltd., VM-100A) according to JIS Z8809. Also, the Table 5 also indicates the values of X/Z, wherein X [wt %] represents the content of the fatty acid monoester component in the insulating liquid, and Z [wt %] represents the content of the silicone oil and/or hydrocarbon-based liquid in the insulating liquid. Furthermore, in the table, PEs stands for polyester resin, and st-ac stands for styrene-acrylic acid ester copolymer. In addition, the methyl laurate, methyl caprylate, methyl caprate and methyl myristate used were products of Lion Corp. Cosmo white P-70 was a product of Cosmo Oil Lubricants Co., Ltd., Dyna Freshia W-8 was a product of Idemitsu Kosan Co., Ltd., and Isopar H and Isopar G were products of Exxon Mobil Corp.

The viscosity and electrical resistance of the insulating liquids in Table 5 were indicated according to the following criteria of four grades:

### Viscosity

### A: 150 mPa·s or greater and 800 mPa·s or less (very good)

### B: 100 mPa·s or greater and 900 mPa·s or less (excluding 150 mPa·s or greater and 800 mPa·s or less) (good)

### C: 50 mPa·s or greater and 1000 mPa·s or less (excluding 100 mPa·s or greater and 900 mPa·s or less) (medium)

### D: less than 50 mPa·s, or greater than 1000 mPa·s (bad)

### Electrical Resistance

### A: 1×10¹³ Ωcm or greater (very good)

### B: 1×10¹¹ Ωcm or greater and less than 1×10¹³ Ωcm (good)

### C: 1×10⁹ Ωcm or greater and less than 1×10¹¹ Ωcm (bad)

### D: less than 1×10⁹ Ωcm (very bad).

TABLE 5

| | Liquid developer | | | | | | | | | |
|---|---|---|---|---|---|---|---|---|---|---|
| | | | | Insulating liquid | | | | | | |
| | | | | | | Silicone oil and/or | | | | |
| | Resin material | | | Fatty acid monoester | | Aliphatic hydrocarbon | | | | |
| | | Glass | | | Content | | Content | | | |
| | | Transition | Softening | | In Insulating | | In Insulating | | | Electrical |
| | | Temp. | Temp. | | Liquid: X | | Liquid: Z | | Viscosity | resistance |
| | Type | [° C.] | [° C.] | Type | [wt %] | Type | [wt %] | X/Z | [mPa · S] | [Ωcm] |
| Ex. 39 | PEs | 60 | 125 | Soybean oil fatty acid | 37.2 | Cosmo White P-60 | 61.9 | 0.60 | A | A |
| | | | | methyl | | | | | | |
| Ex. 40 | PEs | 61 | 116 | Soybean oil fatty acid | 37.2 | KF96 | 61.9 | 0.60 | A | A |
| | | | | methyl | | | | | | |
| Ex. 41 | PEs | 43 | 98 | Rapeseed oil fatty acid | 37.2 | Cosmo White P-60 | 61.9 | 0.60 | A | A |
| | | | | methyl | | | | | | |
| Ex. 42 | PEs | 43 | 98 | Methyl laurate | 37.2 | Cosmo White P-60 | 61.9 | 0.60 | A | A |
| Ex. 43 | PEs | 25 | 84 | Methyl laurate | 29.0 | Dyna Freshia W-8 | 70.1 | 0.41 | A | A |
| Ex. 44 | PEs | 30 | 88 | Methyl laurate | 39.0 | Cosmo White P-60 | 60.1 | 0.65 | A | A |
| Ex. 45 | PEs | 60 | 127 | Methyl laurate | 19.0 | Cosmo White P-60 | 80.1 | 0.24 | B | A |
| Ex. 46 | PEs | 70 | 134 | Methyl caprylate | 9.0 | Cosmo White P-60 | 90.1 | 0.10 | B | A |
| Ex. 47 | PEs | 43 | 98 | Methyl laurate | 49.0 | Cosmo White P-60 | 50.1 | 0.98 | A | A |
| Ex. 48 | PEs | 43 | 98 | Methyl laurate | 55.0 | Cosmo White P-60 | 44.1 | 1.25 | C | B |
| Ex. 49 | st-ac | 20 | 83 | Methyl myristate | 37.2 | KF96 | 61.9 | 0.60 | A | A |
| Ex. 50 | PEs | 43 | 98 | Methyl laurate | 37.2 | Cosmo White P-70 | 61.9 | 0.60 | A | A |
| Ex. 51 | PEs | 43 | 98 | Methyl caprylate | 37.2 | Isopar H | 61.9 | 0.60 | A | A |
| Ex. 52 | PEs | 43 | 98 | Methyl caprylate | 37.2 | Isopar G | 61.9 | 0.60 | A | A |
| Ex. 53 | PEs | 43 | 98 | Methyl laurate | 37.2 | Dyna Freshia W-8 | 31.0 | 0.60 | A | A |
| | | | | | | KF96 | 31.0 | | | |
| Comp. Ex. 6 | PEs | 12 | 75 | Methyl laurate | 37.2 | Cosmo White P-60 | 61.9 | 0.60 | A | A |
| Comp. Ex. 7 | PEs | 79 | 143 | Methyl laurate | 37.2 | Cosino White P-60 | 61.9 | 0.60 | A | A |
| Comp. Ex. 8 | PEs | 43 | 98 | — | 0.0 | Cosmo White P-60 | 99.0 | — | C | A |
| Comp. Ex. 9 | PEs | 43 | 98 | — | — | KF96 | 99.0 | — | C | A |

### 6. Evaluation

With respect to each of the liquid developers obtained as described above, evaluation of the intensity of fixation, adaptability to high speed image formation, storage property and long-term stability was performed.

### 6.1. Intensity of Fixation

Using the image forming device as illustrated in FIG. 4, images of a predetermined pattern were formed on recording paper (Seiko Epson Corp., high quality paper LPCPPA4) with the respective liquid developers of the Examples and the Comparative Examples described above. Thereafter, thermal fixation of the images formed on the recording paper was performed in an oven. This thermal fixation was performed under the conditions of 110° C. for 1 minute.

Then, after confirming non-offset regions, an eraser (Lion Office Products Corp., sand erase “LION 261-11”) was rubbed twice against the fixed images on the recording paper under a pressing load of 1.0 kgf, and the residual ratios of the image concentration were measured by “X-Rite Model 404” manufactured by X-Rite Inc., to evaluate the fixed images according to the following criteria of five grades:

### A: image concentration residual ratio being 95% or greater (very good)

### B: image concentration residual ratio being 90% or greater and less than 95% (good)

### C: image concentration residual ratio being 80% or greater and less than 90% (medium)

### D: image concentration residual ratio being 70% or greater and less than 80% (bad)

### E: image concentration residual ratio being less than 70% (very bad)

### 6.2. Evaluation of Image Formation at High Speed

With regard to the images formed by an electrophotographic image forming device of liquid developing type as illustrated in FIG. 4 under the conditions of a set temperature for heat fixing roller of 110° C. and a printing speed of 60 sheets/min, the extent of image defects such as thin scratches or the like were evaluated by naked eyes, and the image concentrations of the formed images were respectively evaluated according to the following criteria of four grades: Image defects such as thin scratches or the like

### A: No image defects such as thin scratches or the like are recognized in the formed image

### B: Virtually no image defects such as thin scratches or the like are recognized in the formed image

### C: A few image defects such as thin scratches or the like are recognized in the formed image

### D: Obvious image defects such as thin scratches are recognized in the formed image

### Image Concentration

### A: image concentration of 1.5 or greater (very good)

### B: image concentration of 1.0 or greater and less than 1.5 (good)

### C: image concentration of 0.5 or greater and less than 1.0 (bad)

### D: image concentration of less than 0.5 (very bad).

### 6.3. Storage Property

The respective liquid developers obtained in the Examples and the Comparative Examples described above were left to stand for 8 months in an environment at a temperature of 20 to 28° C. Thereafter, the appearance of the toner in the liquid developers was confirmed by naked eyes, and was evaluated according to the following criteria of five grades:

### A: No floating and coagulation settling of toner particles are recognized

### B: Virtually no floating and coagulation settling of toner particles are recognized

### C: Slight floating or coagulation settling of toner particles is recognized, but within the scope of causing no problem with the liquid developer

### D: Obvious floating or coagulation settling of toner particles is recognized

### E: Marked floating and coagulation settling of toner particles are recognized.

### 6.4. Long-Term Stability

The respective liquid developers obtained in the Examples and the Comparative Examples described above were left to stand for 10 months in an environment at 35° C. and at a relative humidity of 70%. Thereafter, the appearance of the liquid developer was observed and evaluated according to the following criteria of five grades:

### A: No thickening/discoloration of the liquid developer is recognized

### B: Virtually no thickening/discoloration of the liquid developer is recognized

### C: Slight thickening/discoloration of the liquid developer is recognized, but within the scope of causing no problem with the liquid developer

### D: Obvious thickening/discoloration of the liquid developer is recognized

### E: Marked thickening/discoloration of the liquid developer is recognized.

These results are presented in Table 6 together with the average particle size based on particle number, and standard deviation of the particle size of the toner particles.

TABLE 6

| | | | Evaluation | | | | |
|---|---|---|---|---|---|---|---|
| | Toner particle | | | Adaptability to High speed | | | |
| | | Standard | | Image formation | | | |
| | Average | Deviation Of | | Image defects | | | |
| | Particle size | Particle size | Intensity Of | Such as Thin | Image | Storage | Long-term |
| | [μm] | [μm] | fixation | scratches Etc. | concentration | property | stability |
| Ex. 39 | 1.5 | 0.49 | B | A | A | A | B |
| Ex. 40 | 1.4 | 0.50 | A | A | A | A | B |
| Ex. 41 | 1.5 | 0.50 | A | A | A | A | B |
| Ex. 42 | 1.6 | 0.49 | B | A | A | A | A |
| Ex. 43 | 1.4 | 0.51 | B | A | A | A | B |
| Ex. 44 | 1.5 | 0.50 | B | A | A | A | A |
| Ex. 45 | 1.4 | 0.47 | C | B | A | A | A |
| Ex. 46 | 1.4 | 0.49 | C | B | A | A | A |
| Ex. 47 | 1.5 | 0.50 | B | A | A | A | A |
| Ex. 48 | 1.4 | 0.50 | B | B | B | A | B |
| Ex. 49 | 1.4 | 0.49 | A | A | A | A | B |
| Ex. 50 | 1.5 | 0.51 | B | A | A | A | A |
| Ex. 51 | 1.5 | 0.48 | B | A | A | A | A |
| Ex. 52 | 1.6 | 0.50 | B | A | A | A | A |
| Ex. 53 | 1.5 | 0.41 | A | A | A | A | A |
| Comp. Ex. 6 | 1.4 | 0.52 | A | D | D | D | E |
| Comp. Ex. 7 | 1.4 | 0.54 | E | D | D | A | B |
| Comp. Ex. 8 | 1.4 | 0.50 | E | A | A | A | A |
| Comp. Ex. 9 | 1.5 | 0.49 | E | A | A | A | A |

As is clear from Table 6, the liquid developer according to the invention had excellent low temperature fixability as well as excellent intensity of fixation. The liquid developer according to the invention also had excellent adaptability to high speed image formation. Moreover, as indicated in Table 6, the storage property and the long-term stability were also excellent.

Furthermore, evaluation of the intensity of fixation was performed as described above, after changing the fixing temperature in the evaluation of the intensity of fixation to 100° C., 95° C., 90° C., 85° C. and 80° C., and the same results were obtained. From this, it is clear that the liquid developer according to the invention was appropriate for low temperature fixation.

With regard to the evaluation of image formation at a high speed, the transport speed of the recording medium of the fixing apparatus was increased from 60 sheets/min to 70 sheets/min and 80 sheets/min. Evaluation of the intensity of fixation was performed as described above, and the same results were obtained. From this, it is clear that the liquid developer according to the invention is appropriate for high speed printing.

To the contrast, satisfactory results could not be obtained with the liquid developers of the Comparative Examples 6 to 9.

Furthermore, the liquid developers of Examples 39, 40 and Comparative Example 6 were stored under sealing for 12 hours in an environment at 55° C. The liquid developers of Examples 1 and 2 did not show aggregation of the toner particles. To the contrast, the liquid developer of Comparative Example 6 underwent an occurrence of aggregation of the toner particles, and the aggregates could not be redispersed even with stirring.

Furthermore, preparation and evaluation of liquid developers were performed as described above, except that Pigment Red 122, Pigment Yellow 180 and carbon black (Degussa Corp., Printex L) were used in place of the cyan pigment as the colorant, and the same results as those described above were obtained.

What is claimed is:

1. A liquid developer comprising:
an insulating liquid; and
toner particles composed mainly of a resin material that are dispersed in the insulating liquid,
wherein the insulating liquid contains a fatty acid monoester, and the resin material has a glass transition temperature Tg of 15 to 70° C. and a softening temperature Tf of 80 to 140° C.

2. The liquid developer according to claim 1, wherein the fatty acid monoester contains unsaturated fatty acids as the fatty acid component.

3. The liquid developer according to claim 1, wherein the fatty acid monoester includes a monoester between an unsaturated fatty acid having 16 to 22 carbon atoms and an alcohol having 1 to 4 carbon atoms.

4. The liquid developer according to claim 1, wherein the fatty acid monoester contains saturated fatty acids as the fatty acid component.

5. The liquid developer according to claim 1, wherein the fatty acid monoester includes a monoester between a saturated fatty acid having 8 to 16 carbon atoms and an alcohol having 1 to 4 carbon atoms.

6. The liquid developer according to claim 1, wherein the resin material is a polyester resin.

7. The liquid developer according to claim 1, having a viscosity of 50 to 1000 mPa·s, as measured according to JIS Z8809 at 25° C. using an oscillatory viscometer.

8. The liquid developer according to claim 1, wherein the insulating liquid contains a fatty acid triglyceride, and contains unsaturated fatty acids as the fatty acid component.

9. The liquid developer according to claim 8, which satisfies the relationship of 0.01≦X/Y≦1.0, wherein X [w %] represents the content of the fatty acid monoester in the insulating liquid, and Y [wt %] represents the content of the fatty acid triglyceride.

10. The liquid developer according to claim 8, wherein the fatty acid monoester is generated by a transesterification reaction between the fatty acid triglyceride and a monoalcohol having 1 to 4 carbon atoms.

11. The liquid developer according to claim 1, wherein the insulating liquid contains a silicone oil and/or an aliphatic hydrocarbon.

12. The liquid developer according to claim 11, which satisfies the relationship of 0.1≦X/Z≦1.0, wherein X [w %] represents the content of the fatty acid monoester in the insulating liquid, and Z [wt %] represents the content of the aliphatic hydrocarbon and the silicone oil.

13. An image forming device comprising:
a liquid developer storing unit that stores a liquid developer;
a developer unit that develops an image using the liquid developer supplied from the liquid developer storing unit;
a transferring unit that transfers the image formed in the developing unit onto a recording medium to form a transferred image; and
a fixing unit that fixes the transferred image formed on the recording medium onto the recording medium,
wherein the liquid developer includes an insulating liquid and toner particles composed mainly of a resin material that are dispersed in the insulating liquid, the insulating liquid contains a fatty acid monoester, and the resin material has a glass transition temperature Tg of 15 to 70° C. and a softening temperature Tf of 80 to 140° C.
